(19) United States
(12) Patent Application Publication
(10) Pub. No.: US 2005/0283589 A1
(43) Pub. Date: Dec. 22, 2005

(54) Data processor

(75) Inventor: Masahito Matsuo, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 11/152,723

(22) Filed: Jun. 15, 2005

(30) Foreign Application Priority Data
Jun. 16, 2004 (JP) 2004-177890

(51) Int. Cl. G06F 9/30

(52) U.S. Cl. 712/217

(57) ABSTRACT

An input pointer update circuit updates an input pointer in response to the value of an RBC latch, the input pointer of a BIP latch and input pointer update information from an instruction decoding unit (first decoder) when the value of an RM latch is “1”. An output pointer update circuit updates an output pointer in response to the value of the RBC latch, the output pointer of a BOP latch and output pointer update information from the instruction decoding unit (the first decoder or a second decoder). A register mapping circuit maps a logical register number to a physical register number on the basis of output information from the input pointer update circuit, the output pointer update circuit etc.

### BACKGROUND OF THE INVENTION

1. Field of the Invention

The present invention relates to a data processor having a buffer register buffering data loaded from a memory.

2. Description of the Background Art

A multimedial processor efficiently processing digital signals has recently been actively developed. Such a processor extremely frequently performs repetitive operation/transfer processing on data loaded from a product-sum operation memory or the like. For example, U.S. Pat. No. 5,901,301 discloses a processor employing the VLIW (very long instruction word) technique.

In order to speed up the repetition processing in such a processor, optimization (software pipelining) must be performed by developing loop processing with software to some extent in consideration of pipeline processing of load latency, the lifetimes of data stored in registers etc.

Software pipelining requires a large number of registers as data buffers. A processor of a simple structure having no multiple data memory access paths operating in parallel with each other must load different array data on two positions in a data memory in order to perform product-sum operation of coefficients and data, to require a larger number of registers as buffers.

When multistage pipeline processing is performed in order to improve the operating frequency, the load latency is increased to increase the number of registers necessary for holding data. Also when the SIMD (single instruction multiple data stream) technique is employed for improving the performance, the quantity of simultaneously handled data is increased to require a larger number of registers.

While the number of registers must be increased in order to speed up the repetition processing, it is impossible to allocate a large number of instructions to a short instruction length if the number of registers is simply increased since a large number of bits are allotted to a register number specifying field in instruction bit allocation. It is difficult to improve the performance with a small number of executable instructions. Further, the basic instruction length is increased if a large number of instructions are allocated, to reduce the code efficiency and increase the program size.

When high-speed product-sum operation processing or the like is implemented by software pipelining, it is possible to write no short program with a simple loop due to different write register numbers in loading or different reference register numbers in operation, but the program size is increased.

For example, the data processor disclosed in U.S. Pat. No. 5,901,301 must perform at least six product-sum operations in a single loop to require code sizes for six instructions when performing a single product-sum operation in one clock cycle. In this case, the data processor requires 12 data holding registers.

When the number of data processed in one loop is increased, the overhead of the code size for fractions not processible in the loop or the processing cycle number may be increased. Particularly when a repeat count dynamically changes or the same subroutine is invoked with an arbitrary repeat count, the overhead for condition-determining the repeat count or the processing cycle number is increased. Further, codes responsive to the condition determination of the repeat count and the repeat count are required to increase the program size for implementing the processing.

In addition, processing for saving (pushing) and returning (popping) register values is required before and after repetition processing frequently referring to product-sum operation load data or the like due to employment of a large number of registers, to increase the code size as well as the processing cycle number as a result of overheads for the saving and return operations.

When software is installed in a ROM, the packaged instruction ROM size is increased if the program size is increased, to increase the cost for the hardware.

If the processing cycle number is increased, high performance cannot be obtained but the operating frequency necessary for implementing functions to be packaged is increased while power consumption is also increased.

Further, simple repetition processing leads to a complicated program due to high-speed processing, to result in a large program development load and a high possibility of bug contamination.

In a conventional data processor having the aforementioned structure, a loop must be developed in a relatively large unit with a large number of registers in order to implement a program for repetition processing such as digital signal processing with software, and hence the code size is increased to increase the product cost or the processing cycle number is so increased that high performance cannot be obtained but power consumption is increased. Further, the program is so complicated that software development efficiency is reduced to increase the possibility of bug contamination.

### SUMMARY OF THE INVENTION

Objects of the present invention are to implement a high-performance low-cost data processor having excellent code efficiency by handling a large number of registers with a short instruction length thereby packaging a large number of instructions with the short instruction length, to implement a high-performance low-cost data processor having excellent code efficiency by implementing repetition processing with a short code size and reducing various overheads, to improve program development efficiency for repetition processing and to implement a high-performance low-cost data processor having excellent code efficiency by reducing saving and returning of register values before and after repetition processing and overheads of return processing.

According to the present invention, a data processor for processing data stored in a specific logical register specified as operand storage location of an instruction comprises a decoding unit, a plurality of variable physical registers and logical register specifying means.

The decoding unit analyzes the instruction, the plurality of variable physical registers are associable with the specific logical register, and the logical register specifying means is capable of sequentially specifying the variable physical registers in a specified physical register group constituted of at least two registers among the plurality of variable physical registers on a first-in, first-out (FIFO) method as the specific logical register.

According to the present invention, it is possible to shorten a basic instruction length by handling a large number of physical registers with a small number of specific logical registers. Consequently, a high-performance low-cost data processor having excellent code efficiency can be obtained by packaging a large number of instructions with the short basic instruction length.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an explanatory diagram showing general-purpose registers;

FIG. 2 is an explanatory diagram showing accumulators;

FIG. 3 is an explanatory diagram showing control registers;

FIG. 4 is an explanatory diagram showing other control registers;

FIG. 5 is an explanatory diagram showing the structure of a PSW stored in a control register CR0;

FIG. 6 is an explanatory diagram showing the structure of an RBC stored in a control register CR4;

FIG. 7 is an explanatory diagram showing the structure of an RBP stored in a control register CR5;

FIG. 8 is an explanatory diagram showing a logical register structure in a general-purpose register mode;

FIG. 9 is an explanatory diagram showing a first logical register structure in a ring buffer mode;

FIG. 10 is an explanatory diagram showing a second logical register structure in the ring buffer mode;

FIG. 11 is an explanatory diagram showing a third logical register structure in the ring buffer mode;

FIG. 12 is an explanatory diagram showing the instruction format of this data processor;

FIG. 13 is an explanatory diagram showing the formats of an FM bit and execution sequence specification in detail;

FIG. 14 is an explanatory diagram showing exemplary bit allocation of a typical instruction;

FIG. 15 is an explanatory diagram showing exemplary bit allocation of another typical instruction;

FIG. 16 is an explanatory diagram showing exemplary bit allocation of still another typical instruction;

FIG. 17 is an explanatory diagram showing exemplary bit allocation of a further typical instruction;

FIG. 18 is a block diagram showing the functional block structure of the data processor according to this embodiment;

FIG. 19 is a block diagram showing the internal structure of a register file in detail;

FIG. 20 is a block diagram showing the internal structure of a first operation unit in detail;

FIG. 21 is a block diagram showing the internal structure of a PC unit in detail;

FIG. 22 is a block diagram showing the internal structure of a second operation unit in detail;

FIG. 23 is an explanatory diagram showing pipeline processing;

FIG. 24 is an explanatory diagram showing exemplary load operand interference;

FIG. 25 is an explanatory diagram showing exemplary operation hardware interference;

FIG. 26 is a block diagram showing the structures of parts related to ring buffer control in a control unit;

FIG. 27 is an explanatory diagram showing the association between register names specified by instruction mnemonics and 4-bit logical register numbers specified by operation codes;

FIG. 28 is an explanatory diagram showing the association between register names as register sets and 5-bit physical register numbers;

FIG. 29 is an explanatory diagram showing an exemplary program 1 in an assembler performing product-sum operation;

FIG. 30 is an explanatory diagram showing allocation of instruction codes of a loading instruction LD2;

FIG. 31 is an explanatory diagram showing allocation of instruction codes of a product-sum operation instruction MAC;

FIG. 32 is an explanatory diagram showing pipeline processing in block repetition processing in the exemplary program 1 in detail;

FIG. 33 is an explanatory diagram showing states of ring buffers in the pipeline processing shown in FIG. 32;

FIG. 34 is an explanatory diagram showing an exemplary program 2 in the assembler performing product-sum operation;

FIG. 35 is an explanatory diagram showing pipeline processing in block repetition processing in the exemplary program 2 in detail;

FIG. 36 is an explanatory diagram showing states of the ring buffers in the pipeline processing shown in FIG. 35;

FIG. 37 is an explanatory diagram showing an exemplary program 3 in the assembler performing product-sum operation;

FIG. 38 is an explanatory diagram showing pipeline processing in block repetition processing in the exemplary program 3 in detail;

FIG. 39 is an explanatory diagram showing states of the ring buffers in the pipeline processing shown in FIG. 38;

FIG. 40 is an explanatory diagram showing an exemplary program 4 for performing product-sum operation accompanied with multiplication of double precision;

FIG. 41 is an explanatory diagram showing pipeline processing in block repetition processing in the exemplary program 4 in detail;

FIG. 42 is an explanatory diagram showing states of the ring buffers in the pipeline processing shown in FIG. 41;

FIG. 43 is an explanatory diagram showing an exemplary program 5 for performing product-sum operation accompanied with multiplication of double precision;

FIG. 44 is an explanatory diagram showing bit allocation of a ring buffer output pointer update instruction UPDBOP;

FIG. 45 is an explanatory diagram showing pipeline processing in block repetition processing in the exemplary program 5 in detail;

FIG. 46 is an explanatory diagram showing states of the ring buffers in the pipeline processing shown in FIG. 45;

FIG. 47 is an explanatory diagram showing an exemplary program 6 for simultaneously processing two samples in single precision product-sum operation;

FIG. 48 is an explanatory diagram showing pipeline processing in block repetition processing in the exemplary program 6 in detail;

FIG. 49 is an explanatory diagram showing states of the ring buffers in the pipeline processing shown in FIG. 48;

FIG. 50 is an explanatory diagram showing an exemplary program 7 for performing memory-to-memory transfer;

FIG. 51 is an explanatory diagram showing pipeline processing in repetition processing in the exemplary program 7 in detail;

FIG. 52 is an explanatory diagram showing states of the ring buffers in the pipeline processing shown in FIG. 51;

FIG. 53 is an explanatory diagram showing an exemplary program 8 for shifting array data;

FIG. 54 is an explanatory diagram showing pipeline processing in repetition processing in the exemplary program 8 in detail;

FIG. 55 is an explanatory diagram showing states of the ring buffers in the pipeline processing shown in FIG. 54;

FIG. 56 is an explanatory diagram showing an exemplary program 9 for differential square-sum calculation;

FIG. 57 is an explanatory diagram showing pipeline processing in repetition processing in the exemplary program 9 in detail;

FIG. 58 is an explanatory diagram showing states of the ring buffers in the pipeline processing shown in FIG. 57;

FIG. 59 is an explanatory diagram showing an exemplary program 10 for repeating linear function processing in relation to 16-bit integer array data;

FIG. 60 is an explanatory diagram showing pipeline processing in repetition processing in the exemplary program 10 in detail;

FIG. 61 is an explanatory diagram showing states of the ring buffers in the pipeline processing shown in FIG. 60; and

FIG. 62 is an explanatory diagram showing another exemplary structure of a ring buffer control register.

### DESCRIPTION OF THE PREFERRED EMBODIMENTS

A data processor according to an embodiment of the present invention is now described. The data processor according to the embodiment is a 16-bit processor processing addresses and data each having a length of 16 bits. This data processor adopts big endian in relation to the bit order and the byte order, and the most significant bit (MSB) corresponds to the bit 0.

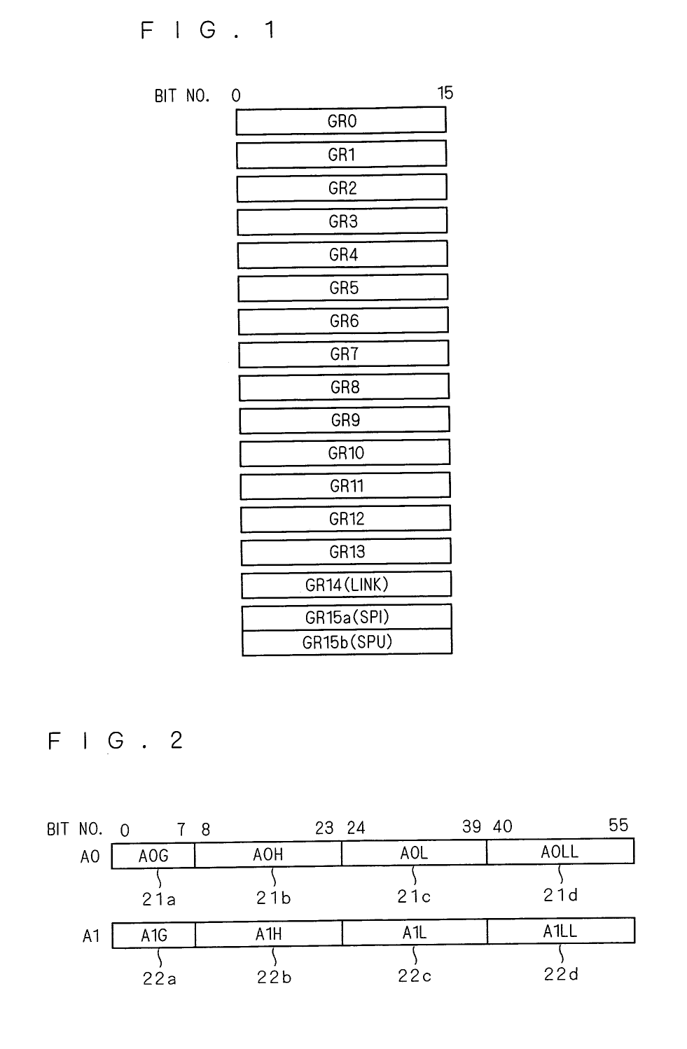

FIGS. 1 to 4 are explanatory diagrams showing register sets of this data processor. FIG. 1 shows 16 general-purpose registers GR0 to GR15b storing data and address values respectively. The general-purpose register GR14 is allocated as a link (LINK) register for storing a return address in a subroutine jump. The general-purpose registers GR15a and GR15b are stack pointers (SP), storing an interruption stack pointer (SPI) and a user stack pointer (SPU) respectively, which are switched through a processor status word (PSW) described later. The interruption and user stack pointers (SPI and SPU) are hereinafter generically referred to as stack pointers (SP). Unless otherwise stated, a 4-bit register specifying field specifies the number of each register serving as an operand. This data processor comprises an instruction for processing two registers such as the general-purpose registers GR0 and GR1, for example, as a pair. In this case, the data processor specifies an even-numbered register. The data processor covertly specifies an odd-numbered register next to the specified register as the counterpart.

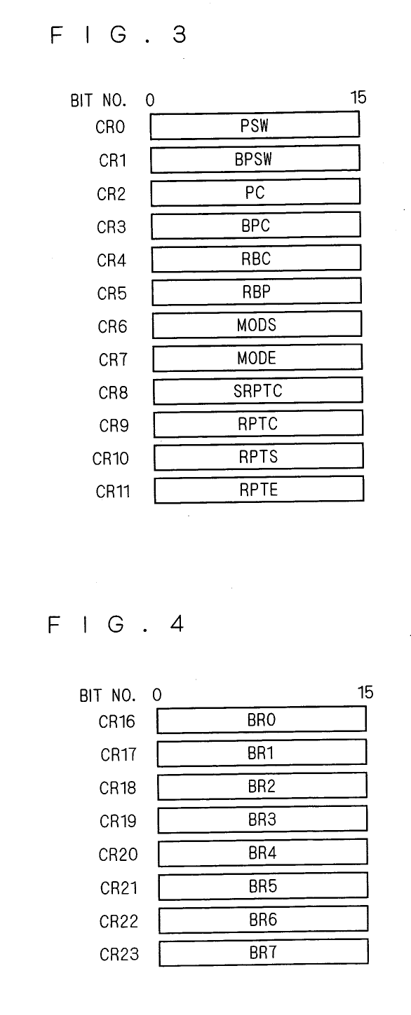

FIG. 2 shows 56-bit accumulators A0 and A1. The accumulators A0 and A1 are expedientially labeled as A0H21b, A1H22b, A0L21c, A1L22c, A0LL21d and A1LL22d every 16 bits. The data processor also comprises 8-bit guard bits A0G21a and A1G22a holding bits overflowing the high-order position of a product-sum operation result.

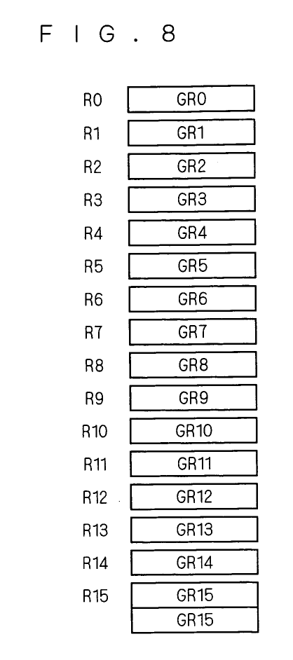

FIG. 3 is an explanatory diagram showing 16-bit control registers CR0 to CR11. The number of each of the control registers CR0 to CR11 is also shown in four bits in general, similarly to the general-purpose registers GR. The control register CR0 stores a processor status word (PSW) consisting of bits specifying operating modes of the data processor and flags indicating results of operations. FIG. 5 is an explanatory diagram showing the structure of the PSW stored in the control register CR0.

An SM bit 61 (bit 0) indicates a stack mode. When the SM bit 61 is “0” indicating an interruption mode, the data processor employs the stack pointer SPI as the general-purpose register GR15a. When the SM bit 61 is “1” indicating a user mode, on the other hand, the data processor employs the stack pointer SPU as the general-purpose register GR15b.

An IE bit 62 (bit 4) specifies interruption enabling such that the data processor masks interruption (ignores the interruption regardless of assertion) when the IE bit 62 is “0” while accepting the interruption when the IE bit 62 is “1”.

This data processor has a block repetition function for implementing zero-overhead loop processing and a single step repetition function. An RP bit 63 (bit 5) indicates a block repetition state such that the data processor is not in block repetition when the RP bit 63 is “0” while the same is in block repetition when the RP bit 63 is “1”. An SRP bit 64 (bit 6) indicates a single step repetition state such that the data processor is not in single step repetition when the SRP bit 64 is “0” while the same is in single step repetition when the SRP bit 64 is “1”.

The data processor also has a modulo addressing function for accessing a circular buffer. An Md bit 65 (bit 7) specifies modulo enabling such that the data processor disables modulo addressing when the MD bit 65 is “0” while enabling modulo addressing when the MD bit 65 is “1”.

An FX bit 66 (bit 8) specifies the data format for any accumulator such that the data processor stores a multiplication result in the corresponding accumulator in an integer format when the FX bit 66 is “0” while shifting the multiplication result left one bit position as a fixed-point format and storing the same in the corresponding accumulator when the FX bit 66 is “1”.

An ST bit 67 (bit 9) specifies a saturation mode such that the data processor writes an operation result in a corresponding accumulator in 56 bits when the ST bit 67 is “0” while limiting the operation result to a value expressible in 48 bits (value having guard bits of only codes) and writes the same in the corresponding accumulator when the ST bit 67 is “1”. Assuming that “h′” denotes hexadecimal notation, the data processor writes h′007fffffffffff in the corresponding accumulator when the operation result is greater than h′007fffffffffff while writing h′ff800000000000 when the operation result is less than h′ff800000000000.

An RM bit 68 (bit 10) indicating (collective) operating mode information specifies a register mode. The RM bit 68 of “0” indicates a normal mode (general-purpose register mode (physical register fixation operating mode)) in which a single logical register specified by an instruction physically corresponds to a single general-purpose register (fixed physical register) while the RM bit 68 of “1” indicates a ring buffer mode (physical register variable operating mode) in which a specific logical register (partial or overall specific logical registers R0 to R4) partially forming a logical register specified by an instruction operates as a first-in first-out (FIFO) buffer. The ring buffer mode operation is described later in more detail.

An F0 flag 69 (bit 12) is an execution control flag, on which a comparison result of a comparison instruction or the like is set. An F1 flag 70 (bit 13) is also an execution control flag such that the data processor copes the value of the F0 flag 69 before updating on the F1 flag 70 when updating the F0 flag 69 by a comparison instruction or the like. A C flag 71 (bit 15) is a carry flag such that the data processor sets a carry for executing an add-subtract operation this flag.

The control register CR2 shown in FIG. 3 stores a program counter (PC) and indicates the address of a currently executed instruction. Each instruction processed by the data processor basically has a fixed length of 32 bits, and the control register CR2 (PC) holds an instruction word address with one word of 32 bits. The control register CR2 is a read-only register.

The control registers CR1 and CR3 store a backup processor status word (BPSW) and a backup program counter (BPC) respectively, for saving/holding the values of the control registers CR0 (PSW) and CR2 (PC) under execution respectively when the data processor detects exception or interruption.

The control register CR4 stores ring buffer control information (RBC) in the ring buffer mode, while the control register CR5 stores a ring buffer pointer RBP for saving/returning input/output pointers of the corresponding ring buffer when the data processor detects exception or interruption during processing in the ring buffer mode, as described later in more detail.

The control registers CR6 and CR7 for modulo addressing store a modulo start address (MODS) and a modulo end address (MODE) respectively. Both of the control registers CR6 and CR7 hold first and final data word (16-bit) addresses. The data processor sets smaller and larger addresses in the control registers CR6 (MODS) and CR7 (MODE) respectively when utilizing modulo addressing for increment, while rewriting the value held in the control register CR6 (MODS) in the register as the address update value when an incremented register value matches with the address held in the control register CR7 (MODE).

The control register CR8 holds a repeat counter (SRPTC) in a single set repetitive operation as a count indicating the repeat count. The user can read/write the value so that the data processor can accept interruption during single set repetition.

The user can read/write values of the control registers CR9 to CR11 related to block repetition so that the data processor can accept interruption during repetition. The control register CR9 holds a repeat counter (RPTC) as a count indicating the repeat count. The control register CR10 holds a repetition block start address (RPTS) as a head instruction address of a block for repetition. The control register CR11 holds a repetition block end address (RPTE) as a last instruction address of the block for repetition.

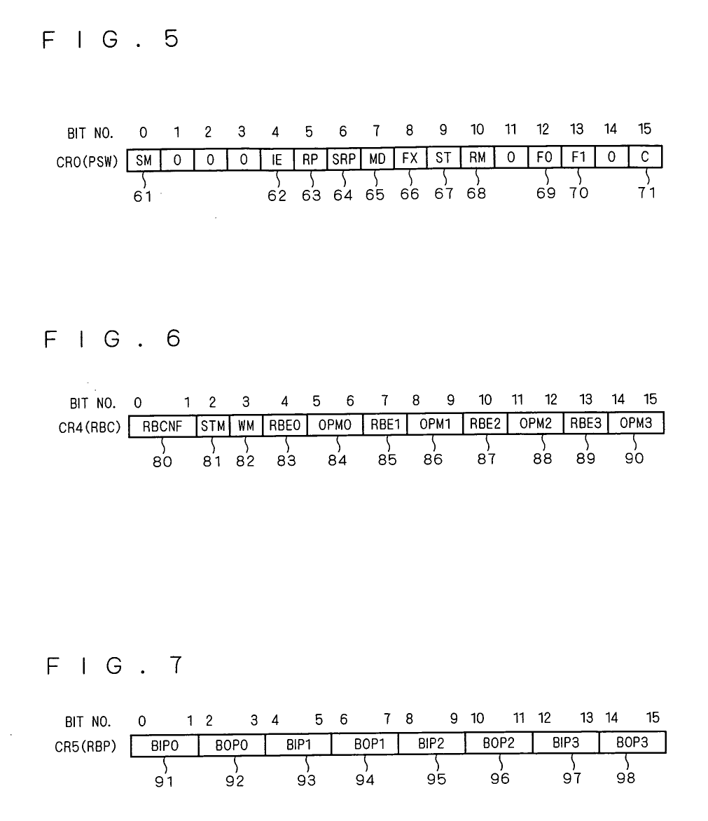

FIG. 4 is an explanatory diagram showing 16-bit control registers CR16 to CR23. The control registers CR16 to CR23 function as buffer registers BR0 to BR7 operating as FIFO buffers in the ring buffer mode. According to the embodiment, the data processor is packaged with eight registers independently of the general-purpose registers GR0 to GR15.

Allocation of registers having numbers R0 to R15 specified by instruction mnemonics is described in detail (logical registers specified by the instruction mnemonics are hereinafter referred to as registers R0 to R15). The data processor operates in the normal general-purpose register mode when “0” is specified for the RM bit 68 of the control register CR0 (PSW), while the registers partially operate as ring buffers when “1” is specified for the RM bit 68 of the control register CR0 (PSW).

Register allocation and operating specification in the ring buffer mode are described. According to this embodiment, each ring buffer is constituted of two or four physical registers, to implement a function for serving as a FIFO buffer through management by input/output pointers described later. In other words, no data are transferred in practice to implement the FIFO buffer according to this embodiment. The data processor performs input/output control with a 1-bit input/output pointer when the ring buffer is constituted of two physical registers, while the same performs input/output control with a 2-bit input/output pointer when the ring buffer is constituted of four physical registers.

The data processor updates the input pointer by +1 or +2 by executing a loading instruction for the object register. The data processor updates the input pointer by +1 when executing a loading instruction for loading single data in each ring buffer, while updating the input pointer by +2 when executing a loading instruction for simultaneously loading two data in each ring buffer. The data processor can set several update control methods by mode setting described later.

The data processor performs circulation control of each pointer for operating the corresponding register as a ring buffer. When the data processor uses a ring buffer of four entries (identified by values “0” to “3” of the input pointer), for example, the updated value of the pointer reaches “0” if incremented by one in the state of “3” while also reaching “0” when incremented by 2 in the state of “2”. Further, the updated value of the pointer reaches “1” when incremented by 2 in the state of “3”. In this case, the data processor writes the loaded value in the entries (registers) having the pointers of “3” and “0”.

FIG. 6 is an explanatory diagram showing the structure of the ring buffer control information (RBC) stored in the control register CR4. According to this embodiment, the four registers R0 to R3 function as specific logical registers operable as ring buffers among the 16 logical registers R0 to R15 specified by instruction mnemonics.

An RBCNF bit 80 forming variable physical register constitutional information is a ring buffer structure control bit (2-bit structure) specifying the structure of the ring buffers. According to this embodiment, the data processor can selectively specify three structures. The respective structures are described later in detail.

An STM bit 81 forming mode set information is a stored data selection mode bit selecting stored data in store instruction processing for storing the values of the registers operating as ring buffers. The data processor reads the stored data from the registers indicated by the output pointers of the buffer registers constituting the ring buffers (second mode specification) when the STM bit 81 is “0”, while reading the stored data from the normal general-purpose registers (first mode specification) when the STM bit 81 is “1”.

A WM bit 82 forming register selection information is a register value writing selection bit selecting registers to be subjected to writing of values in register writing other than loading following instruction execution. The data processor writes the values in the corresponding general-purpose registers (first register specification) when the WM bit 82 is “0”, while writing the values in both of the general-purpose registers and the registers indicated by the output pointers of the buffer registers constituting the ring buffers (second register specification) when the WM bit 82 is “1”. The data processor writes the values not in the registers indicated by the input pointers.

RBE0, RBE1, RBE2 and RBE3 bits 83, 85, 87 and 89 forming specific logical register responsive operating mode information are ring buffer enable control bits. The data processor can control whether to execute operations (physical register varying operations) as ring buffers or to execute operations (physical register fixing operations) as general-purpose registers every four logical registers R0 to R3 operable as ring buffers. The RBE0 to RBE3 bits 83, 85, 87 and 89 correspond to the logical registers R0, R1, R2 an R3 respectively, and indicate that the logical registers R0, R1, R2 and R3 operate as normal general-purpose registers when the same are “0” while indicating that the logical registers R0, R1, R2 and R3 operate as ring buffers when the same are “1”. In other words, the data processor can specify whether to operate registers operable as ring buffers in the structure specified by the RBCNF bit 80 as ring buffers or to operate the same as normal general-purpose registers in response to the program also in the ring buffer mode (the RM bit 68 of the control register CR0 (PSW) is “1”).

OPM0 to OPM3 bits 84, 86, 88 and 90 forming output pointer update mode information are ring buffer output pointer update mode bits (2-bit structure). According to this embodiment, the data processor can specify four types of pointer update methods for the four logical registers R0 to R3 operable as ring buffers. The OPM0 to OPM3 bits 84, 86, 88 and 90 specify the pointer update methods for the logical registers R0 to R4 respectively. The OPM0 to OPM3 bits 84, 86, 88 and 90 are hereinafter generically referred to as OPMi bits, in order to simplify the description.

When any OPMi bit is “00”, the data processor updates the output pointer specified by an instruction by +1 only when explicitly specifying updating of the output pointer by executing an output pointer update instruction for the corresponding ring buffer. The output pointer update instruction is described later in more detail.

When the OPMi bit is “01”, the data processor refers to a register value by executing an instruction thereby automatically updating the pointer of the register referred to by +1.

When the OPMi bit is “10”, the data processor automatically updates the output pointer of a register operating as a ring buffer in execution of a last instruction of a repetition block in block repetition processing.

When the OPMi bit is “11”, the data processor automatically updates the output pointer of a register operating as a ring buffer in execution of a branch instruction.

Also when the OPMi bit is “01”, “10” or “11”, the data processor updates the pointer in response to an output pointer update instruction.

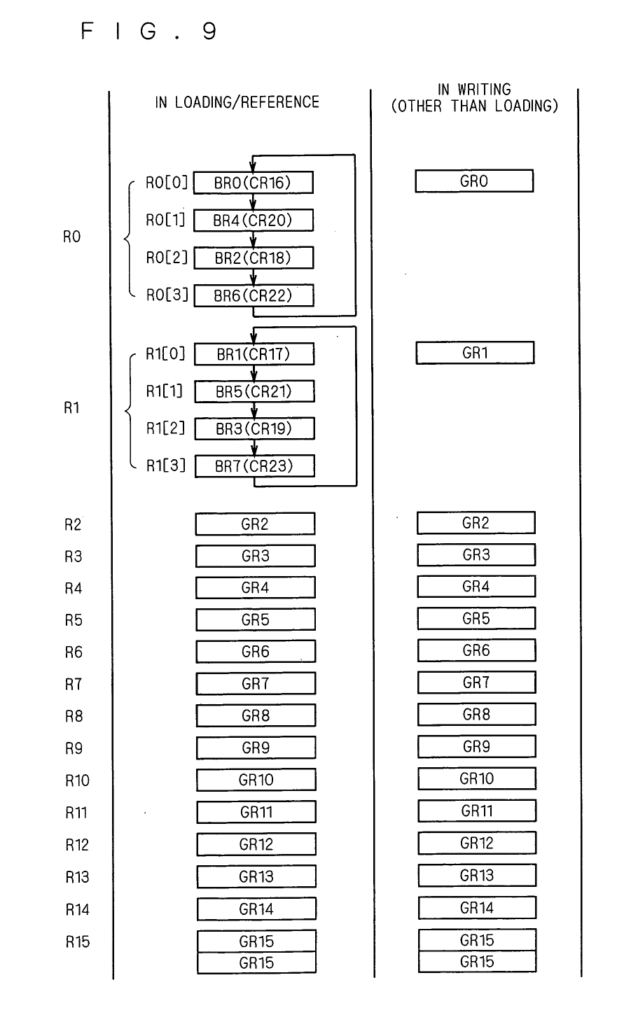

FIG. 7 is an explanatory diagram showing the structure of the ring buffer pointer (RBP) stored in the control register CR5. BIP0 to BIP3 bits 91, 93, 95 and 97 are bits (2-bit structure) indicating input pointers of the ring buffers corresponding to the logical registers R0 to R3 respectively, and BOP0 to BOP3 bits 92, 94, 96 and 98 are bits (2-bit structure) indicating output pointers of the ring buffers corresponding to the logical registers R0 to R3 respectively. The data processor can refer to and update these bits 91 to 98 for saving/return in exception or interruption. Otherwise the data processor may not refer to or update these bits. While each of the bits 91 to 98 is constituted of two bits, each pointer value can take only “0” or “1” when the corresponding ring buffer is constituted of two physical registers.

FIG. 8 is an explanatory diagram showing a logical register structure in the general-purpose register mode. In the general-purpose register mode, the logical register numbers R0 to R15 specified by instruction mnemonics are in one-to-one correspondence to the general-purpose registers GR0 to GR15 respectively, as shown in FIG. 8. Thus, single fixed physical registers (the general-purpose registers GR0 to GR3) are mapped also to the specific logical registers R0 to R3 associable with a plurality of variable physical registers (the buffer registers BR0 to BR7 etc.).

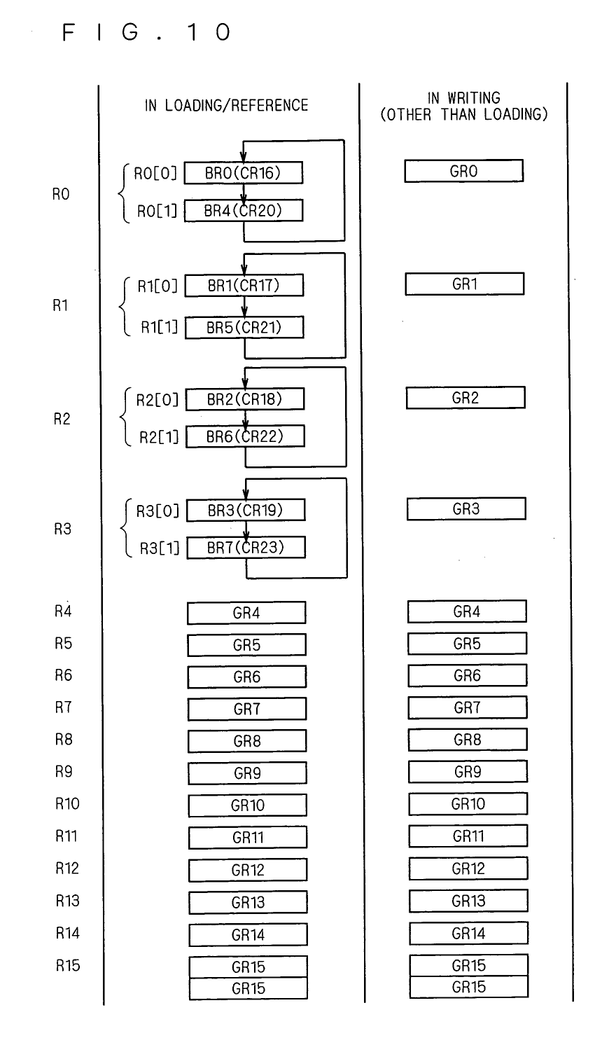

In the ring buffer mode, the data processor can select three buffer structures in response to the RBCNF bit 80. FIG. 9 is an explanatory diagram showing a first logical register structure in the ring buffer mode.

Referring to FIG. 9, the RBCNF bit 80 is “00”, the STM bit 81 is “0”, the WM bit 82 is “0” and the RBE0 and RBE1 bits 83 and 85 are “1” respectively in the RBC stored in the control register CR4. The values in marks [ ] denote those of pointers. Each of the logical registers R0 and R1 has a ring buffer structure of four entries. Therefore, the upper limit of input and output pointers is “3”.

As shown in FIG. 9, the data processor decides a specified physical register group with the four buffer registers BR0, BR4, BR2 and BR6 serving as variable physical registers mapped to the logical register R0 in loading/reference. In relation to this specified physical register group, the data processor employs a loop structure of sequentially specifying the physical registers BR0, BR4, BR2 and BR6 in this order on the FIFO method and returning specification to the buffer register BR0 after specifying the buffer register BR6. In writing (data updating other than a loading instruction), on the other hand, the data processor maps the general-purpose register GR0 forming a fixed physical register to the logical register R0.

Similarly, the data processor decides another specific physical register group with the four buffer registers BR1, BR5, BR3 and BR7 serving as variable physical registers mapped to the logical register R1 in loading/reference. In writing, on the other hand, the data processor maps the general-purpose register GR1 serving as a single fixed physical register to the logical register R1.

The data processor regularly maps the general-purpose registers GR2 to GR15 to the logical registers R2 to R15 respectively.

The data processor manages each input/output pointer as a 2-bit pointer. In this case, the data processor must not set the RBE2 and RBE3 bits 87 and 79 to “1” since the logical registers R2 and R3 are inoperable in the ring buffer mode.

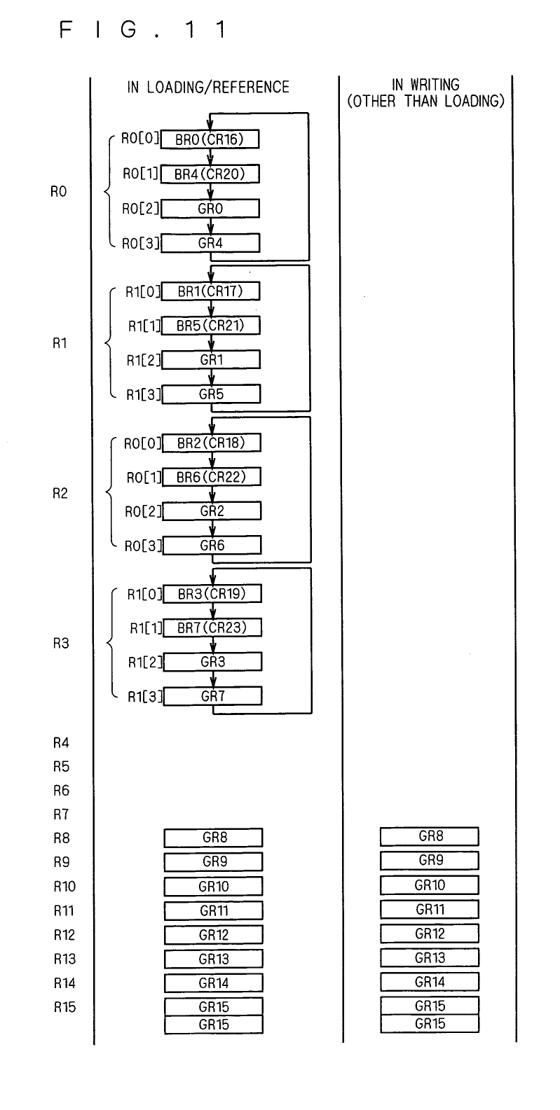

FIG. 10 is an explanatory diagram showing a second logical register structure in the ring buffer mode.

Referring to FIG. 10, the RBCNF bit 80 is “01”, the STM bit 81 is “0, the WM bit 82 is “0” and the RBE0 to RBE3 bits 83, 85, 87 and 89 are “1” respectively in the RBC.

As shown in FIG. 10, each of the logical registers R0 to R3 has a ring buffer structure of two entries as a specific logical register. The data processor manages each input/output pointer as a 1-bit pointer. In other words, the upper limit of the input and output pointers is “1”.

As shown in FIG. 10, the data processor decides a specified physical register group with the two buffer registers BR0 and BR4 serving as variable physical registers mapped to the logical register R0 in loading/reference. In relation to this specified physical register group, the data processor employs a loop structure of sequentially specifying the logical registers BR0 and BR4 in this order on the FIFO method and returning specification to the buffer register BR0 after specifying the buffer register BR4. In writing, on the other hand, the data processor maps the general-purpose register GR0 serving as a single fixed physical register mapped to the logical register R0.

Similarly, the data processor decides another specific physical register group with the two buffer registers BR1 and BR5 serving as variable physical registers mapped to the logical register R1 in loading/reference, and maps the general-purpose register GR1 serving as a single fixed physical register to the logical register R1 in writing.

Similarly, the data processor decides still another specific physical register group with the two buffer registers BR2 and BR6 serving as variable physical registers mapped to the logical register R2 in loading/reference, and maps the general-purpose register GR2 serving as a single fixed physical register to the logical register R1 in writing.

Similarly, the data processor decides a further specific physical register group with the two buffer registers BR3 and BR7 serving as variable physical registers mapped to the logical register R3 in loading/reference, and maps the general-purpose register GR3 serving as a single fixed physical register to the logical register R3 in writing.

The data processor regularly maps the general-purpose registers GR4 to GR15 to the logical registers R4 to R15 respectively.

FIG. 11 is an explanatory diagram showing a third logical register structure in the ring buffer mode.

Referring to FIG. 11, the RBCNF bit 80 is “10”, the STM bit 81 is “0”, the WM bit 82 is “0” and the RBE0 to RBE3 bits 83, 85, 87 and 89 are “1” respectively.

As shown in FIG. 11, each of the logical registers R0 and R3 forms a ring buffer of four entries as a specific logical register. Therefore, the upper limit of input and output pointers is “3”.

As shown in FIG. 11, the data processor decides a specified physical register group with the buffer registers BR0 and BR4 and the general-purpose registers GR0 and GR4 serving as four variable physical registers mapped to the logical register R0 in loading/reference. In relation to this specified physical register group, the data processor employs a loop structure of sequentially specifying the registers BR0, BR4, GR0 and GR4 in this order on the FIFO method and returning specification to the buffer register BR0 after specifying the general-purpose register GR4. In writing, on the other hand, no physical register corresponds to the logical register R0.

Similarly, the data processor decides another specific physical register group with the buffer registers BR1 and BR5 and the general-purpose registers GR1 and GR5 serving as four variable physical registers mapped to the logical register R1 in loading/reference.

Similarly, the data processor decides still another specific physical register group with the buffer registers BR2 and BR6 and the general-purpose registers GR2 and GR6 serving as four variable physical registers mapped to the logical register R2 in loading/reference.

Similarly, the data processor decides a further specific physical register group with the buffer registers BR3 and BR7 and the general-purpose registers GR3 and GR7 serving as four variable physical registers mapped to the logical register R3 in loading/reference.

The data processor regularly maps the general-purpose registers GR8 to GR15 to the logical registers R8 to R15 respectively.

The data processor manages each input/output pointer as a 2-bit pointer. While the data processor requires 16 registers for forming the ring buffers in this case, the data processor according to this embodiment, packaged with only eight buffer registers in order to reduce the quantity of hardware, also uses the eight general-purpose registers GR0 to GR7 as the components for the buffer registers. When the data processor operates in this mode, the logical registers R4 to R7 are unusable, and the values of the logical registers R0 to R7 after operation in the ring buffer mode are unguaranteed. If the values of the general-purpose registers GR0 to GR7 must be held before and after processing in this mode, the data processor must save/return the register values. The data processor must perform no program writing on the logical registers R0 to R7 during processing in this mode.

The data processor does not update but holds original values with a loading instruction for the logical registers R0 and R1 if the RBCNF bit 80 is “00”, while the same does not update but holds the original values with a loading instruction for the logical registers R0 to R3 if the RBCNF bit 80 is “01”. When performing no writing other than loading on the logical registers R0 and R1 (R2 and R3) with an instruction, therefore, the data processor may not save/return the values of the logical registers R0 and R1 (R2 and R3) before and after processing. Exemplary processing in the ring buffer mode is described later in detail.

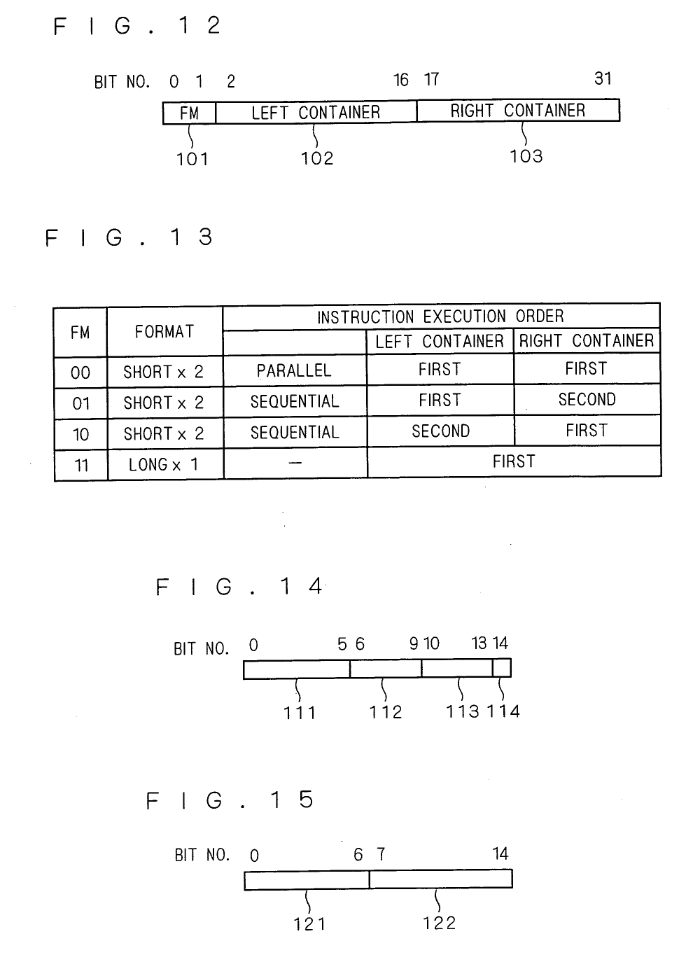

The data processor processes a two-way VLIW (very long instruction word) instruction set. FIG. 12 is an explanatory diagram showing the instruction format of the data processor. As shown in FIG. 12, the basic instruction length is fixed to 32 bits, and leveled on a 32 bit boundary. Each 32-bit instruction code is constituted of a 2-bit format specifying bit (FM bit) 101, a 15-bit left container 102 and a 15-bit right container 103. The left and right containers 102 and 103, each capable of storing a short-format subinstruction of 15 bits, can store a long-format subinstruction of 30 bits together. The short- and long-format subinstructions are hereinafter referred to as short and long instructions respectively for simplifying the description.

FIG. 13 is an explanatory diagram showing the formats of the FM bit 101 and execution sequence specification in detail. The FM bit 101 specifies the formats of instructions and execution sequence of two short instructions. Referring to FIG. 13, “first” and “second” denote precedently and subsequently executed instructions respectively in the instruction execution sequence. The containers 102 and 103 hold a long instruction of 30 bits together when the FM bit 101 is “11”, while otherwise holding short instructions respectively. In the latter case, the FM bit 101 also specifies the execution sequence. When the FM bit 101 is “00”, the data processor parallelly executes the two short instructions. When the FM bit 101 is “01”, the data processor first executes the short instruction held in the left container 102, and thereafter executes that held in the right container 103. When the FM bit FM is “10”, the data processor first executes the short instruction held in the right container 103 and thereafter executes that held in the left container 102. Thus, the data processor can also encode sequentially executed two short instructions as a single 32-bit instruction, for improving code efficiency.

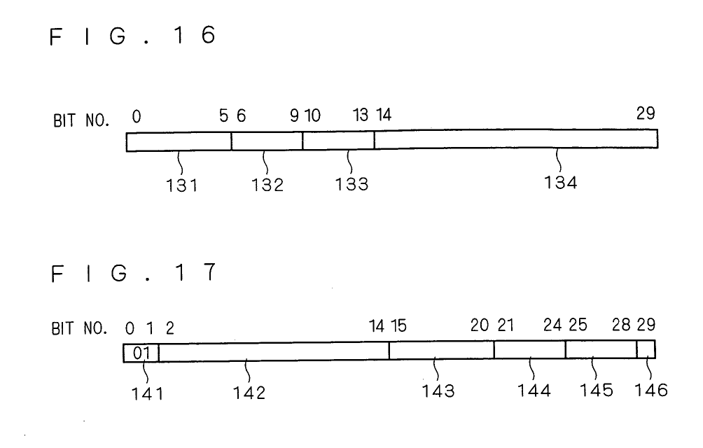

FIGS. 14 to 17 are explanatory diagrams showing exemplary bit allocation of typical instructions. FIG. 14 shows bit allocation of a short instruction having two operands with operation code fields 111 and 114. The field 114 may alternatively specify an accumulator number. The fields 112 and 113 specify locations of data referred to or updated as operands with register numbers or accumulator numbers. The field 113 may alternatively specify a small 4-bit immediate value.

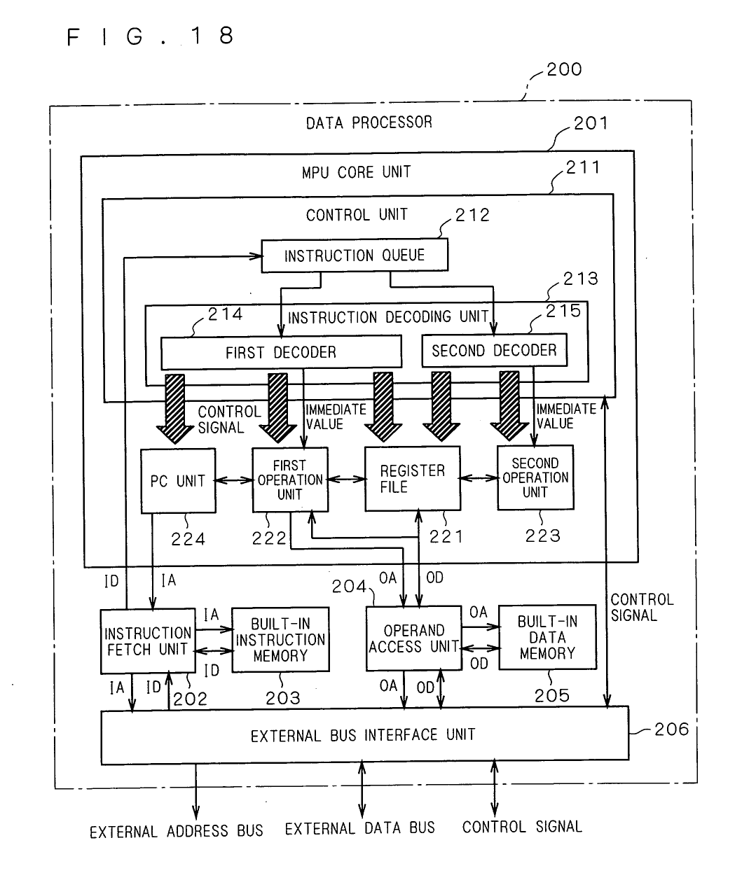

FIG. 15 shows bit allocation of a short-format branch instruction with an operation code field 121 and an 8-bit branch displacement field 122. The data processor specifies branch displacement by offsetting an instruction word (32 bits) similarly to a PC value.

FIG. 16 shows the format of a three-operand instruction or a loading/store instruction having 16-bit displacement or immediate value, which consists of an operation code field 131, fields 132 and 133 specifying register numbers or the like similarly to those of the short format and an extended data field 132 specifying the 16-bit displacement or immediate value.

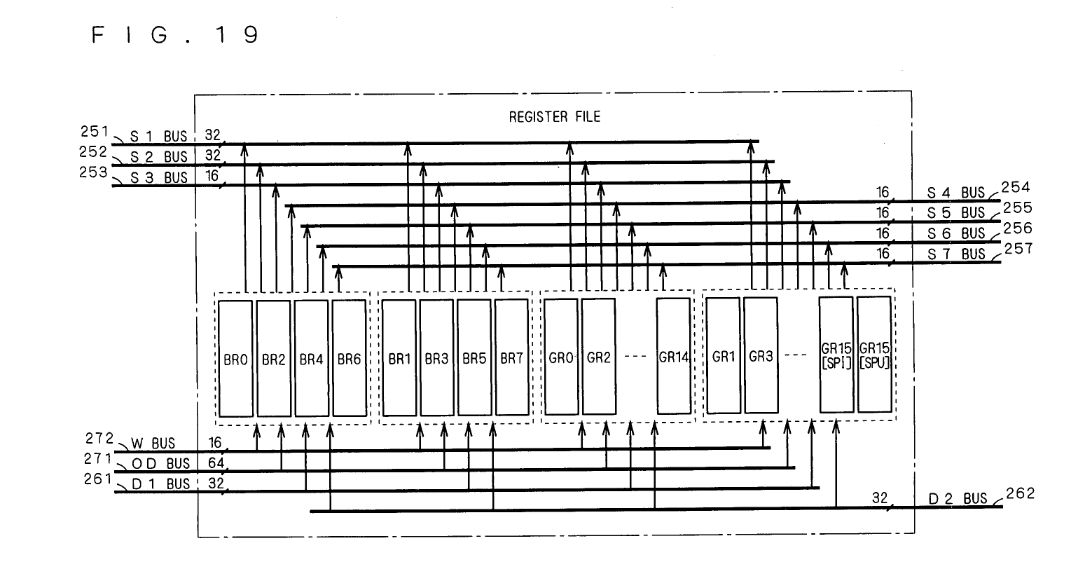

FIG. 17 shows the format of a long-format instruction having an operation code in a right container 103, with a 2-bit field 141 of “01”, operation code fields 143 and 146 and fields 144 and 145 specifying register numbers or the like. The data processor uses a further field 142, which is a reserved field, for specifying an operation code or a register number if necessary.

In addition to the above, the data processor may include bit allocation of specific instructions such as an instruction such as NOP (no operation) having operation codes of 15 bits, a one-operand instruction and the like.

Each subinstruction of this data processor is a RISC-like instruction set. The data processor accesses memory data only through a loading/store instruction, and operates operands and immediate operands in registers/accumulators through operation instructions. Operand data are addressed in five modes, i.e., a register indirect mode, a post-incremental register indirect mode, a post-decremental register indirect mode, a push mode and a register relative indirect mode. “Rsrc”, Rsrc+”, “Rsrc−”, “−SP” and “(disp16, Rsrc)” denote the respective mnemonics. “Rsrc” denotes a register number specifying each base address, and “disp16” denotes each 16-bit displacement value. Each operand is denoted by a byte address.

Each loading/store instruction other than those in the register relative indirect mode has the instruction mode shown in FIG. 14. The field 113 specifies a base register number, and the field 112 specifies the number of a register to be subjected to writing of a value loaded from a memory or a register holding a stored value. In the register indirect mode, the value of a register specified as the base register forms an operand address. In the post-incremental register indirect mode, the value of a register specified as the base register forms an operand address, and the value of this base register is post-incremented by the size (byte number) of the operand and rewritten. In the post-decremental register indirect mode, the value of a register specified as the base register forms an operand address, and the value of this base register is post-decremented by the size (byte number) of the operand and rewritten. The push mode is usable only for a store instruction with the base register formed by the register R15, so that a value obtained by decrementing a stack pointer (SP) value by the size (byte number) of an operand forms an operand address and the decremented value is rewritten in the stack pointer SP.

Each loading/store instruction in the register relative indirect mode has the instruction format shown in FIG. 16. The field 133 specifies a base register number, and the field 132 specifies the number of a register subjected to writing of a value loaded from the memory or a register holding a stored value. The field 134 specifies a value of displacement of an operand storage location from a base address. In the register relative indirect mode, a value obtained by adding a 16-bit displacement value to the value of the register specified as the base register forms an operand address.

In the post-incremental register indirect mode and the post-decremental register indirect mode, the data processor can use a modulo addressing mode by setting the MD bit 65 in the control register CR0 (PSW) to “1”.

In a jump instruction, the data processor specifies a jump destination address in a register indirect mode for specifying the jump destination address with a register value or a PC relative indirect mode for specifying the same by branch displacement of the jump instruction from the PC. The PC relative indirect mode has two types of formats, i.e. a short format for specifying the branch displacement in eight bits and a long format specifying the same in 16 bits. The data processor also comprises a block repetition function for starting a repetition function of implementing loop processing with no overhead.

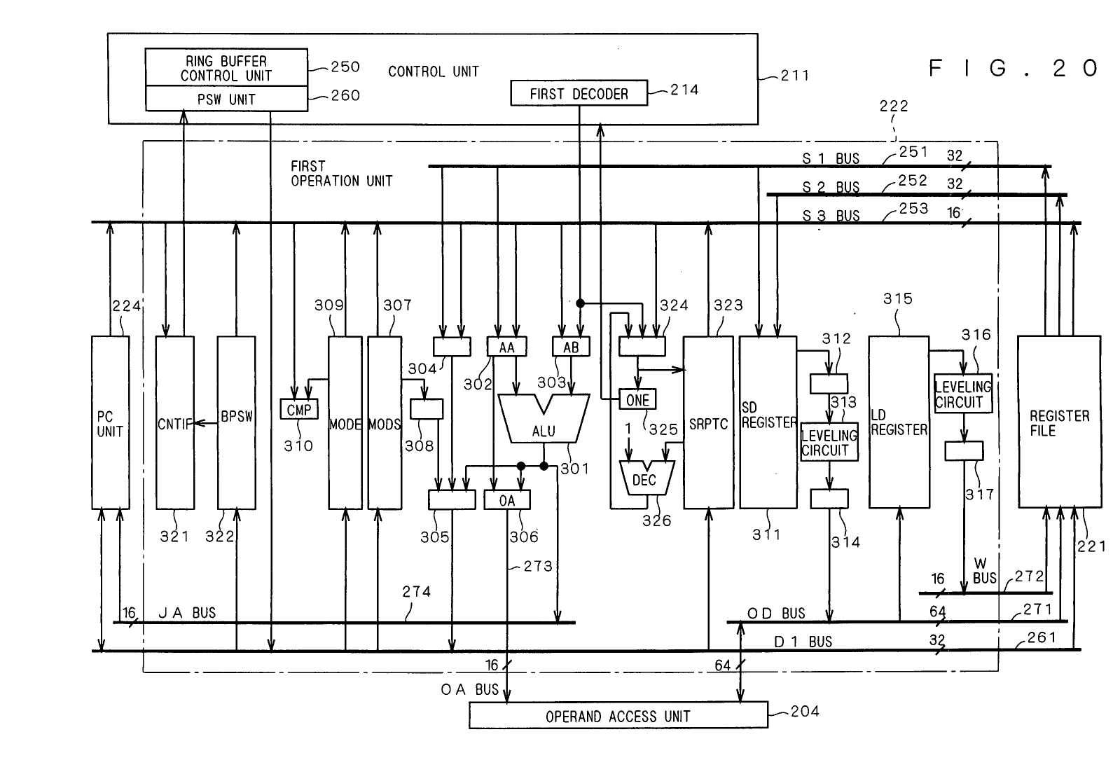

FIG. 18 is a block diagram showing the functional block structure of the data processor 200 according to this embodiment. The data processor 200 is formed by an MPU core unit 201, an instruction fetch unit 202 accessing instruction data in response to a request from the MPU core unit 201, a built-in instruction memory 203, an operand access unit 204 accessing operand data in response to a request from the MPU core unit 201, a built-in data memory 205 and an external bus interface unit 206 adjusting requests from the instruction fetch unit 202 and the operand access unit 204 for accessing a memory outside the data processor 200.

The MPU core unit 201 consists of a control unit 211, a register file 221, a first operation unit 222, a second operation unit 223 and a PC unit 224.

The instruction fetch unit 202 receives an instruction address IA from the PC unit 224, and outputs the same to the built-in instruction memory 203 or the external bus interface unit 206. The instruction fetch unit 202 further transmits/receives instruction data ID to/from the built-in instruction memory 203, receives the instruction data ID from the external bus interface unit 206, and outputs the instruction data ID to an instruction queue 212.

The operand access unit 204 receives an operand address OA from the first operation unit 222, and outputs the same to the built-in data memory 205 and the external bus interface unit 206. The operand access unit 204 further transmits/receives operand data OD to/from the respective ones of the register file 221, the first operation unit 222, the built-in data memory 205 and the external bus interface unit 206.

The control unit 211 controls all operations of the MPU core unit 201 such as pipeline processing, execution of instructions, interface with the instruction fetch unit 202 and the operand access unit 204 etc.

The instruction queue 212 in the control unit 211, consisting of a two-entry 32-bit instruction buffer, effective bits, input/output pointers etc., is controlled on a FIFO (first-in, first-out) basis. The instruction queue 212 temporarily holds instruction data fetched by the instruction fetch unit 202 and transmits the same to an instruction decoding unit 213.

The instruction decoding unit 213 mainly includes two decoders, for decoding an instruction code received from the instruction queue 212. First and second decoders 214 and 215 decode instructions executed in the first and second operation units 222 and 223 respectively. In a first cycle for decoding a 32-bit instruction, the first and second decoders 214 and 215 necessarily analyze instruction codes of the left and right containers 102 and 103 respectively, while both decoders 214 and 215 analyze the FM bit 101 and data of bits 0 and 1 of the left container 102. In order to slice extension data, data of the right container 103 is transmitted to the first decoder 214, which in turn does not analyze the same. Therefore, an initially executed instruction must be set on a position corresponding to a functional unit executing the same. In a case of sequentially executing two short instructions, a predecoder (not shown) decodes the subsequently executed instruction during decoding of the precedently executed instruction and determines in which decoder the instruction is to be decoded. After decoding of the precedent instruction, the selected decoder fetches and analyzes an instruction code of the subsequently executed instruction. If the subsequently executed instruction is processible in both decoders, the first decoder 214 decodes the same.

FIG. 19 is a block diagram showing the internal structure of the register file 221 in detail. As shown in FIG. 19, the register file 221 consists of registers physically holding general-purpose register values stored in the general-purpose registers GR0 to GR15 and buffer register values of the buffer registers BR0 to BR7, and is coupled to the first and second operating units 222 and 223, the PC unit 224 and the operand access unit 204 through a plurality of buses, i.e., S1 to S7 buses 251 to 257, an OD bus 271, a W bus 272 and D1 and D2 buses 261 and 262.

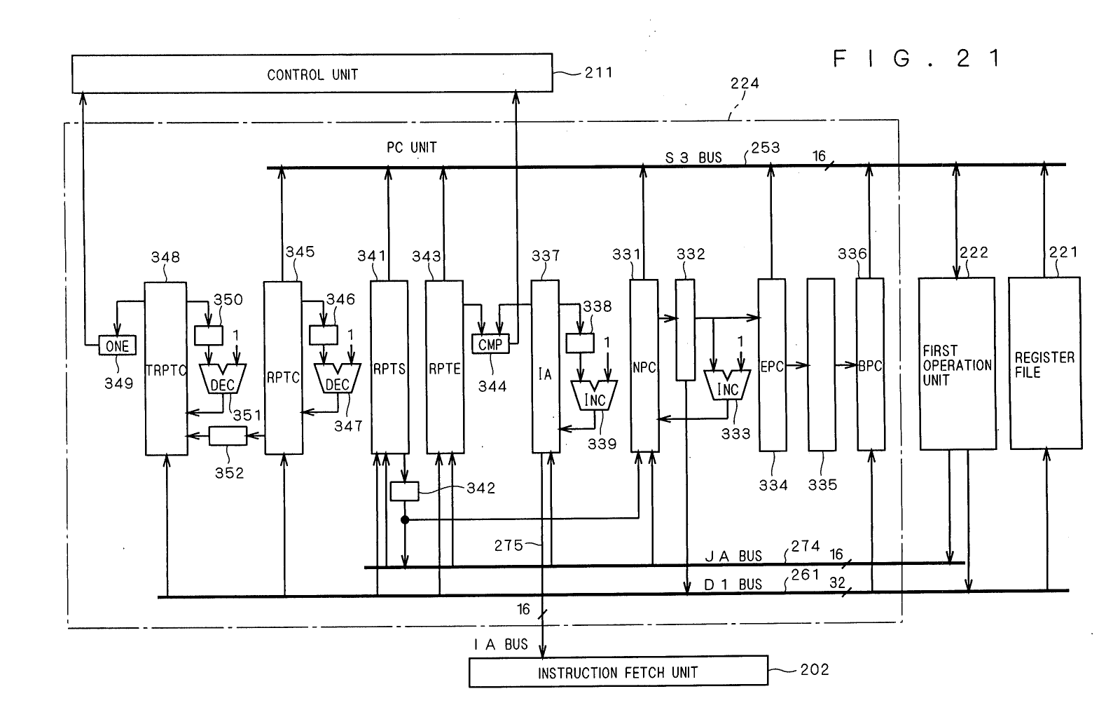

FIG. 20 is a block diagram showing the internal structure of the first operation unit 222 in detail. As shown in FIG. 20, the first operation unit 222 is coupled with the register file 221 through the S1, S2 and S3 buses 251, 252 and 253 respectively, for reading data stored in corresponding registers from the register file 221 through the three buses 251 to 253 and transferring data forming read operands and stored data to a functional unit etc. Each of the S1 and S2 buses 251 and 252 is a 32-bit bus, which can parallelly transfer two words of a register pair. The S3 bus 253 is a 16-bit bus.

The first operation unit 222 is coupled to the register file 221 through the D1 bus 261 of a 32-bit width and the W bus 272 of a 16-bit width, and transfers operation results and transfer data to the register file 221 through the D1 bus 261 while transferring loaded byte data thereto through the W bus 272. The first operation unit 222 can also parallelly transfer two words of a register pair through the D1 bus 261 of the 32-bit width. Further, the first operation unit 222 and the register file 221 are coupled to the operand access unit 204 through the OD bus 271 of 64 bits, and can transfer 1-byte, 1-word, 2-word or 4-word data.

An ALU 301 has input latches formed by AA and AB latches 302 and 303. The AA larch 302 fetches a register value read through the S1 bus 251 or the S3 bus 253. The AA latch 302 also has a zero clearance function. The AB latch 303 fetches a register value read through the S3 bus 253 or a 16-bit immediate value formed as a result of decoding in the first decoder 214. The AB latch 303 also has a zero clearance function.

The ALU 301 mainly performs comparison, arithmetic logical operation, calculation/transfer of operand addresses, increment/decrement of operand address values, calculation/transfer of jump destination addresses etc. The ALU 301 rewrites an operation result or a result of address modification in a register specified by an instruction in the register file 221 through a selector 305 and the D1 bus 261. An OA latch 306, holding addresses of operands, selectively holds an address calculation result in the ALU 301 or the value of a base address held in the AA latch 302, and outputs the same to the operand access unit 204 through an OA bus 273. When calculating a jump destination address or a repetition block end address, an output of the ALU 301 is transferred to the PC unit 224 through a JA bus 274. A latch 304, holding a value transferred in transfer of a control register value or a general-purpose register value, outputs a value transferred through the S1 bus 251 or the S3 bus 253 to the selector 305. In transfer, the value of the latch 304 is written in a register specified by an instruction in the register file 221 or a control register in the first operation unit 222 or the PC unit 224.

An MODS register 307 and an MODE register 309 physically hold values of control registers corresponding to the control registers CR6 and CR7 shown in FIG. 3 respectively. A comparator 310 compares the value of the MODE register 309 with that of a base address on the S3 bus 253. The MODS register 307 is coupled to the selector 305 through a latch 308. The MODS register 307 and the MODE register 309 have output paths to the S3 bus 253 and input paths from the D1 bus 261 respectively.

A 64-bit stored data (SD) register 311 temporarily holds stored data output to either one or both of the S1 and S2 buses 251 and 252. The data held in the SD register 311 is transferred to a leveling circuit 313 through a latch 312. The leveling circuit 313 levels the stored data on a 64-bit boundary according to an operand address, and outputs the leveled stored data to the operand access unit 204 through a latch 314 and the OD bus 271.

A 16-bit load data (LD) register 315 fetches byte data loaded in the operand access unit 204 through the OD bus 271. The value of the LD register 315 is transferred to another leveling circuit 316. The leveling circuit 316 performs byte leveling and zero/code extension of byte data. Leveled and extended data is written in a specified register in the register file 221 through a latch 317 and the W bus 272. In a case of 1-word (16-bit), 2-word (32-bit) or 4-word (64-bit) loading, the loaded value is directly written in the register file 221 from the OD bus 271 without through the LD register 315.

A PSW unit 260 in the control unit 211 consists of a latch physically holding the value of the control register CR0 (PSW) shown in FIG. 3, a PSW update circuit etc., for updating the PSW value in response to an operation result or by executing an instruction. A ring buffer control unit 250 in the control unit 211 consists of a latch physically holding the value of the control register CR4 (RBC) or the control register CR5 (RBP) shown in FIG. 3, input/output pointer update circuit etc., for updating the RBC or RBP value by executing an instruction. In a case of transferring a value to the corresponding control register in the control unit 211, data output to the S3 bus 253 is transferred to the PSW unit 260 or the ring buffer control unit 250 through a CNTIF latch 321. In a case of reading the value of any control register in the control unit 211, the data processor outputs the value of the control register to be read to the D1 bus 261 from the PSW unit 260 or the ring buffer control unit 250, and writes the same in the register file 221. A BPSW register 322 physically holds the value of the control register CR1 shown in FIG. 3. In saving of a PSW value following starting of exceptional processing or the like, the value of the control register CR0 (PSW) output to the D1 bus 261 is written in the BPSW register 322. In return from the exceptional processing or the like, the value of a BPSW 168 is transferred to the PSW unit 260 directly through the CNTIF latch 321. The BPSW register 322 comprises an output path to the S3 bus 253 and an input path from the D1 bus 261.

An SRPTC latch 323 physically holds the value of the control register CR8 (SRPTC) shown in FIG. 3. When the initial value of the SRPTC latch 323 is set by single set repetition instruction execution, a latch 324 fetches a register value read through the S3 bus 253 or an immediate value formed as a result of decoding in the first decoder 214, while the SRPTC latch 323 fetches the value of the latch 324. The value of the SRPTC latch 323 is decremented through a decrementer 326 and the latch 324 every time a single instruction is completely executed during single set repetition processing. A one detection circuit (ONE) 325 detecting one posts completion of the single set repetition processing to the control unit 211 after executing a next instruction. The SRPTC latch 323 has an output path to the S3 bus 253 and an input path from the D1 bus 261.

FIG. 21 is a block diagram showing the internal structure of the PC unit 224 in detail. As shown in FIG. 21, an instruction address (IA) register 337 holds the address of a subsequently fetched instruction, and outputs the same to the instruction fetch unit 202. When continuously fetching a next instruction, an incrementer 339 increments an address value transferred from the IA register 337 through a latch 338 by one and rewrites the result in the IA register 337. When the sequence is switched by a jump or block repetition, the IA register 337 fetches a jump destination address transferred through the JA bus 274 or a repetition block start address.

An RPTS register 341, an RPTE register 343 and an RPTC register 345, which are control registers for block repetition control, physically hold values corresponding to the control registers CR10, CR11 and CR9 shown in FIG. 3 respectively. The RPTS, RPTE and RPTC registers 341, 343 an 345 have input ports from the D1 bus 261 and output ports to the S3 bus 253 for performing initialization, saving or return in block repetition if necessary.

The RPTS register 341 holds a start instruction address of a repetition block. Immediately after initialization of the RPTS register 341, a latch 342 is also updated. When returning to a head instruction of the repetition block during block repetition processing, the value of the latch 342 is transferred to the IA register 337 through the JA bus 274.

The RPTE register 343 holds the address of a last instruction of the repetition block. This final address is calculated in the first operation unit 222 in block repetition instruction processing, and fetched in the RPTE register 343 through the JA bus 274. A comparator 344 compares the values of the RPTE register 343 and the IA register 337 holding the instruction fetch address with each other, and outputs coincidence information to the control unit 211.

The RPTC register 345 and a TRPTC register 348 hold counts for managing the execution time of the repetition block. The TRPTC register 348 holds precedent update information in an instruction fetch stage in pipeline processing. The TRPTC register 348 comprising an input port from the D1 bus 261 is initialized simultaneously with initialization of the RPTC register 345. When a repetition block last instruction is fetched, the value of the TRPTC register 348 is transferred to another decrementer 351 through a latch 350, decremented and rewritten in the TRPTC register 348. Another one detection circuit (ONE) 349 detects that the value of the TRPTC register 348 is “1”, and outputs the detection result to the control unit 211. The RPTC register 345 holds a count in a master execution stage. When the repetition block last instruction is executed, the value of the RPTC register 345 is transferred to still another decrementer 347 through a latch 346, decremented and rewritten in the RPTC register 345. In order to initialize the value of the TRPTC register 348 in a case of a jump, there is a path for transferring the same to the TRPTC register 348 from the RPTC register 345 through a latch 352.

An execution stage PC (EPC) register 334 holds the PC value of a currently executed instruction, and a next instruction PC (NPC) register 331 holds the PC value of a subsequently executed instruction. When a jump takes place in an execution stage, the NPC register 331 fetches a jump destination address value on the JA bus 274. The NPC register 331 fetches a head address of a block for repetition from the latch 342 when repeating the repetition block processing. When instruction execution progresses without changing the processing sequence, the value of the NPC register 331 transferred through the latch 332 every complete execution of one instruction is incremented by another incrementer 333 and rewritten in the NPC register 331. In a case of a subroutine jump instruction, the value of the latch 332 is output to the D1 bus 261 as the return address, and written in the logical register R14 defined as a link register in the register file 221. In a case of referring to the PC of the subsequently executed instruction, the value of the NPC register 331 is output to the S3 bus 253, and transferred to the first operation unit 222. When the next instruction is executed, the value of the latch 332 is transferred to the EPC register 334. In a case of referring to the PC value of the currently executed instruction, the value of the EPC register 334 is output to the S3 bus 253, and transferred to the first operation unit 222. A BPC register 336 physically holds a value corresponding to the control register CR3 shown in FIG. 3. When exception or interruption is detected, the value of the EPC register 334 is transferred to the BPC register 336 through a latch 335. The BPC register 336 has an input port from the D1 bus 261 and an output port to the S3 bus 253, and performs saving or return if necessary.

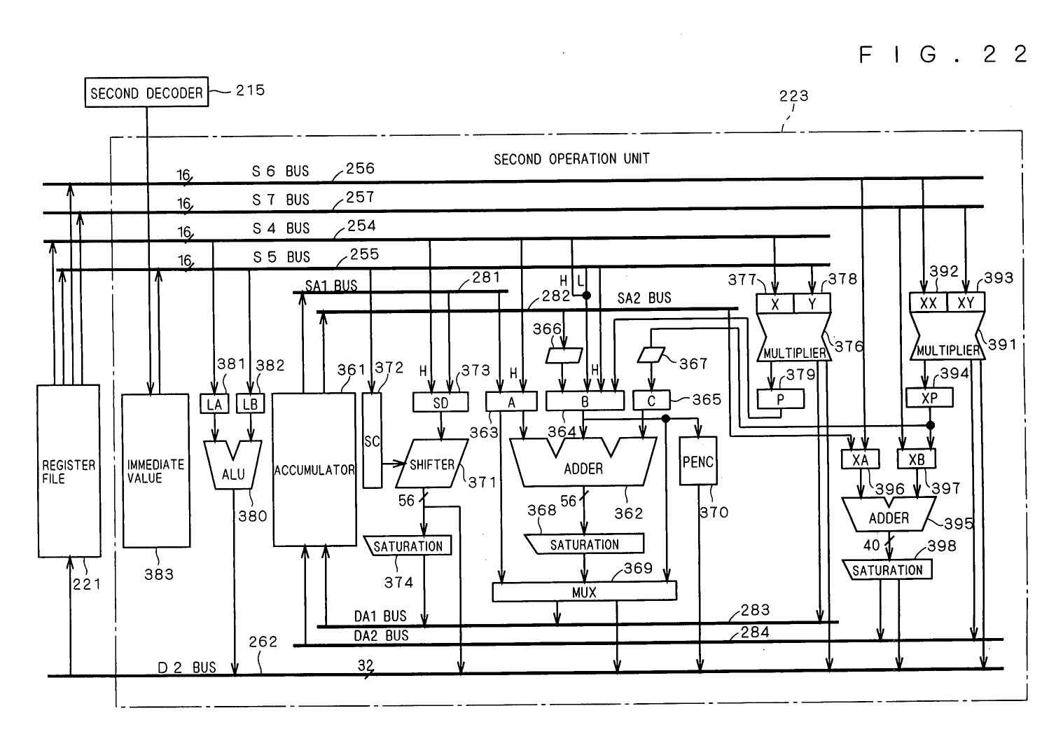

FIG. 22 is a block diagram showing the internal structure of the second operation unit 223 in detail. The second operation unit 223 is coupled with the register file 221 through S4, S5, S6 and S7 buses 254, 255, 256 and 257 each having a 16-bit width, and reads data from any register in the register file 221 through any of the four buses 254, 255, 256 and 257. The second operation unit 223 can also parallelly transfer two words of a register pair through the S4 bus 254 or the S5 bus 255. The second operation unit 223 is coupled with the register file 221 also through a D2 bus 262 having a 32-bit width, and writes an operation result in any register. The second operation unit 223 can also parallelly transfer two words of a register pair through the D2 bus 262. The second operation unit 223 comprises multipliers 376 and 391 for performing two sets of product-sum operations in order to perform SIMD operation, and adders 362 and 395.

An accumulator 361 physically holds the two 56-bit accumulators A0 and A1 shown in FIG. 2. The accumulator 361 has two reading paths to SA1 and SA2 buses 281 and 282 and two writing paths of DA1 and DA2 buses 283 and 284.

The adder 362, which is a 56-bit ternary adder, performs addition/subtraction up to 56 bits including a guard bit. The adder 362 can also add two multiplication results to an accumulator value for SIMD operation or double precision operation. 16 bits from a bit 8 to a bit 23 are used for performing 16-bit operation, while 32 bits from the bit 8 to a bit 39 are used for performing 32-bit operation.

A, B and C latches 363, 364 and 365 are 56-bit input latches of the adder 362. The A latch 363 fetches a register value from the positions of the bit 8 to the bit 23 from the S4 bus 254, or fetches an accumulator value on the SA1 bus 281. A shifter 366 fetches an accumulator value on the SA2 bus 282, performs an arithmetic shift of an arbitrary shift amount from left three bits to right two bits or right 16 bits, and outputs the result. The B latch 364 fetches 16-bit data into the positions from the bit 8 to the bit 23 from the S5 bus 255, code-extends 32-bit data on the S4 and S5 buses 254 and 255 and fetches the code-extended data in the positions of the bit 0 to the bit 39, or fetches the value of the shifter 366 or an output latch (P latch) 379 of the multiplier 376. The C latch 365 fetches the value of an output latch (XP latch) 394 of the multiplier 376 as such or by arithmetically shifting the same right 16 bit positions through a shifter 367. Each of the A, B and C latches 363, 364 and 365 also comprises a zero clearance function or a function for setting a constant value.

An output of the adder 362 is output to a saturation circuit 368. The saturation circuit 368 comprises a function of observing the guard bit and clipping the same to a maximum or minimum value expressible in upper 16 bits or upper and lower 32 bits. The saturation circuit 368 also has a function of performing outputting as such, as a matter of course. The output of the saturation circuit 368 is coupled to a multiplexer 369.

When a destination operand is an accumulator, the value of the multiplexer 369 is written in the accumulator 361 through the DA1 bus 283. When the destination operand is a register, the value of the multiplexer 369 is written in the register file 221 through the D2 bus 262. In order to execute a transfer instruction, calculation of an absolute value, a maximum value set instruction and a minimum value set instruction, the outputs of the A and B latches 363 and 364 are coupled to the multiplexer 369, so that the values of the A and B latches 363 and 364 can be transferred to the accumulator 361 and the register file 221.

A priority encoder (PENC) 370 fetches the value of the B latch 364, calculates a shift amount necessary for normalizing the number of fixed-point formats and outputs the result to the D2 bus 262 in order to rewrite the same in the register file 221.

A barrel shifter 371 is capable of arithmetic/logical shifting up to left/right 32 bits with respect to 56- or 16-bit data. As to shift data, an accumulator data on the SA1 bus 281 or a register value through the S4 bus 254 is fetched in a shift data (SD) latch 373. As to a shift amount, an immediate value or a register value is fetched in a shift amount (SC) latch 372 through the S5 bus 255. The barrel shifter 371 performs shifting specified by an operation code on data of the SD latch 373 by a shift amount specified by the SC latch 372. The shift result is output to the saturation circuit 374, saturated if necessary, and rewritten in the accumulator 361 through the DA1 bus 283 or in the register file 221 through the D2 bus 262.

An arithmetic and logic unit (ALU) 380 performs 16-bit arithmetic and logic operation, transfer etc. LA and LB latches 381 and 382, which are 16-bit input latches of the ALU 380, are connected to the S4 and S5 buses 254 and 255 respectively. An operation result in the ALU 380 is output to the D2 bus 262. In order to avoid interference of a functional unit with product-sum operation, 16-bit arithmetic and logic operation is performed not in the adder 362 but in the ALU 380 to the utmost.

X and Y latches 377 and 378, which are input registers of the multiplier 376, have functions of fetching 16-bit values of the S4 and S5 buses 254 and 255 and zero-extending or code-extending the same to 17 bits respectively. The multiplier 376 of 17 by 17 bits multiplies values stored in the X and Y latches 377 and 378 together. In a case of a product-sum operation instruction or a product-difference operation instruction, the multiplication result is fetched in a P latch 379 and transmitted to the B latch 364. In a case of a multiplication instruction, the multiplication result is rewritten in the accumulator 361 through the DA1 bus 283 or in the register file 221 through the D2 bus 262.

The multiplier 391 and the adder 395 are functional units operable independently of the multiplier 376 and the adder 362 in order to perform SIMD operation.

XX and XY latches 392 and 393, which are input registers of the multiplier 391, have functions of fetching 16-bit values of the S6 and S7 buses 256 and 257 and zero-extending or code-extending the same to 17 bits respectively. The multiplier 391 of 17 by 17 bits multiplies values stored in the XX and XY latches 392 and 393 together. In a case of a product-sum operation instruction or a product-difference operation instruction, the multiplication result is fetched in an XP latch 394 and transmitted to an XB latch 397. The output of the XP latch 394 is also connected also to the shifter 367, for a case of adding two multiplication results to the same accumulator value or a case of performing double precision operation. In a case, of a multiplication instruction, the multiplication result is rewritten in the accumulator 361 through the DA2 bus 284 or in the register file 221 through the D2 bus 252. Zero is written in LMS-side 16 bits of 56 bits in the accumulator 361.

The adder 395 performs addition/subtraction of 16 or 40 bits. XA and XB latches 396 and 397 are 40-bit input latches of the adder 395. The XA latch 396 fetches a 16-bit value on the S6 bus 256 into bits 8 to 23, or fetches the values of upper 40 bits on the SA2 bus 282. The XB latch 397 fetches values of 16 bits on the S7 bus 257 into the bits 8 to 23, or fetches the value of the XP latch 394. An addition/subtraction result is output to a saturation circuit 398, saturated if necessary and rewritten in the accumulator 361 through the DA2 bus 284 or in the register file 221 through the D2 bus 262.

An immediate latch 383 extends a 6-bit immediate value formed in the second decoder 215 to 16 bits, holds the same and transfers the same to the corresponding functional unit through the S5 bus 255. The immediate latch 383 also forms a bit mask for a bit operation instruction.

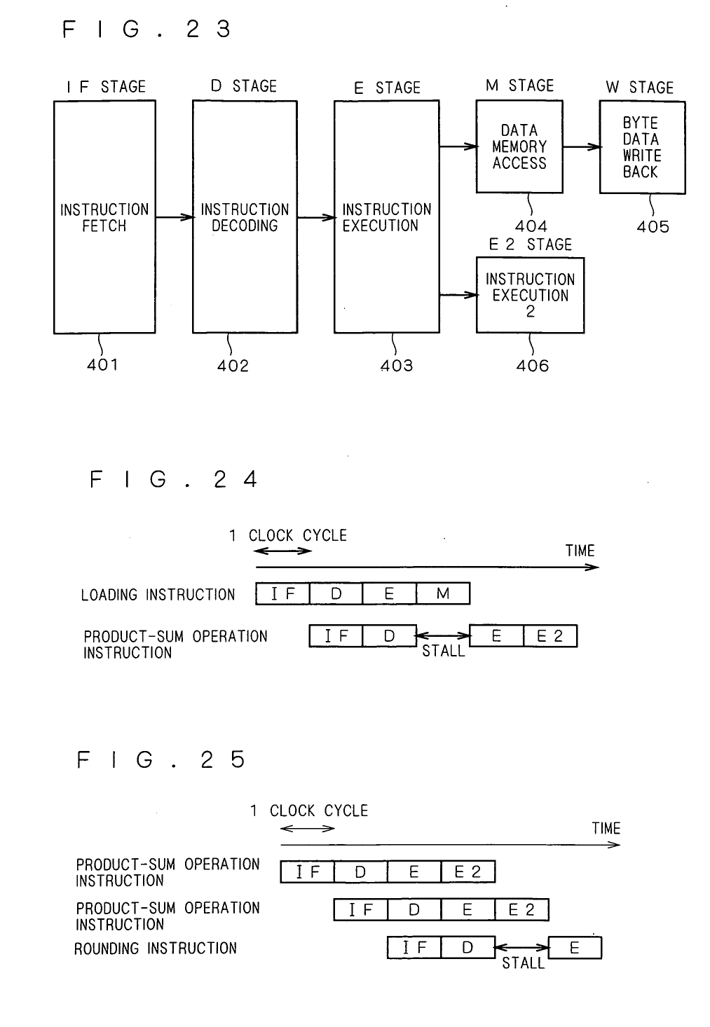

Pipeline processing in the data processor according to this embodiment is now described. FIG. 23 is an explanatory diagram showing the pipeline processing. As shown in FIG. 23, the data processor performs five-stage pipeline processing including an instruction fetch (IF) stage 401 fetching instruction data, an instruction decoding (D) stage 402 analyzing instructions, an instruction execution (E) stage 404 executing operation, a memory access (M) stage 404 accessing a data memory and a write-back (W) stage 404 writing a byte operand loaded from a memory in the corresponding register. Writing of an operation result in the E stage 403 in the corresponding register is completed in the E stage 403, and writing in the corresponding register in word (2-byte), 2-word (4-byte) or 4-word (8-byte) loading is completed in the M stage 404. In relation to product-sum/product-difference operation and double precision operation, instructions are executed in two-stage pipelines of multiplication and addition. Subsequent-stage processing is referred to as an instruction execution 2 (E2) stage 406. Continuous product-sum/product-difference operation can be executed with a throughput of once/once clock cycle.

The IF stage 401 mainly fetches instructions, manages the instruction queue 212 and performs block repetition control. This IF stage 401 controls portions performing IF stage control and instruction fetch control of the instruction fetch unit 202, the built-in instruction memory 203, the external bus interface unit 206 and the IA register 337, the latch 338, the incrementer 339, the TRPTC register 458, the latch 350, the decrementer 351, the one detection circuit 349, the comparator 344 etc. of the PC unit 224 (see FIG. 18) and the control unit 211 and control of the instruction queue 212 and the PC unit 224 (see FIG. 21). The IF stage 401 is initialized by a jump of the E stage 403.

The IA register 337 holds an instruction fetch address. When the E stage 403 causes a jump, the data processor fetches the jump destination address through the JA bus 274 and performs initialization. In a case of sequentially fetching instruction data, the incrementer 339 increments the address. In a case of returning to the head of the repetition block after last instruction processing of the repetition block during block repetition processing, the data processor performs switch control of an instruction processing sequence in the IF stage 401. In the former case, an address held in the RPTS register 341 is transferred to the IA register 337 through the latch 342 and the JA bus 274.

The value of the IA register 337 is transmitted to the instruction fetch unit 202, which in turn fetches the instruction data. When the corresponding instruction data is stored in the built-in instruction memory 203, the instruction fetch unit 202 reads an instruction code from the built-in instruction memory 203. In this case, the instruction fetch unit 202 completely fetches a 32-bit instruction in one clock cycle. If no corresponding instruction data is stored in the built-in instruction memory 203, the instruction fetch unit 202 issues an instruction fetch request to the external bus interface unit 206. The external bus interface unit 206 adjusts a request from the operand access unit 204, fetches the instruction data from an external memory when the instruction is fetchable, and transmits the same to the instruction fetch unit 202. The external bus interface unit 206 can access the external memory in two clock cycles at the minimum. The instruction fetch unit 202 transfers the fetched instruction to the instruction queue 212.

The instruction queue 212 having two entries outputs the instruction code fetched under FIFO control to the instruction decoding unit 213. Repetition block last instruction information indicating that an instruction fetch address coincides with the value of the RPTE register 343 during block repetition processing and block repetition processing end information indicating that the instruction fetch address coincides with the value of the RPTE register 343 and the value of the TRPTC register 348 before updating has been “1” during block repetition processing are held along with an instruction code corresponding to the instruction queue 212, and output to the instruction decoding unit 213 along with the corresponding instruction code. In a subsequent stage, the data processor performs instruction-independent hardware control related to block repetition processing on the basis of this information.

In the D stage 402, the data processor generates a control signal for analyzing an operation code in the instruction decoding unit 213 and executing the instruction in the first operation unit 222, the second operation unit 223 or the PC unit 224. The D stage 402 is initialized by a jump of the E stage 403. When the instruction code transmitted from the instruction queue 212 is invalid, the data processor enters an idle cycle and waits until a valid instruction code is fetched. If cannot start next processing in the E stage 403, the data processor invalidates the control signal transmitted to the functional unit or the like and waits termination of processing of a precedent instruction in the E stage 403. The data processor enters this state when an instruction currently executed in the E stage 403 is that for memory access which has not yet been completed in the M stage 404, for example.

In the D stage 402, the data processor also divides two sequentially executed instructions and performs sequence control of a 2-cycle execution instruction. In the D stage 402, the data processor further performs a load operand interference check for determining whether or not a register value referred to or updated in the E stage 403 has been completed and an interference check between the functional unit of the second operation unit 223 with the E2 stage 406 and the E stage 403, and inhibits outputting of the control signal until cancellation of interference if any interference is detected.

FIG. 24 is an explanatory diagram showing exemplary load operand interference. When there is a product-sum operation instruction for referring to an operand loaded immediately after a word, 2-word or 4-word loading instruction, execution start of the product-sum operation instruction is inhibited until loading in the corresponding register is completed. Also when memory access is terminated in one clock cycle in this case, one clock cycle stall takes place. When loading byte data, the data processor completes writing in the register file 221 in the W stage 405, whereby one cycle stall period further elongates.

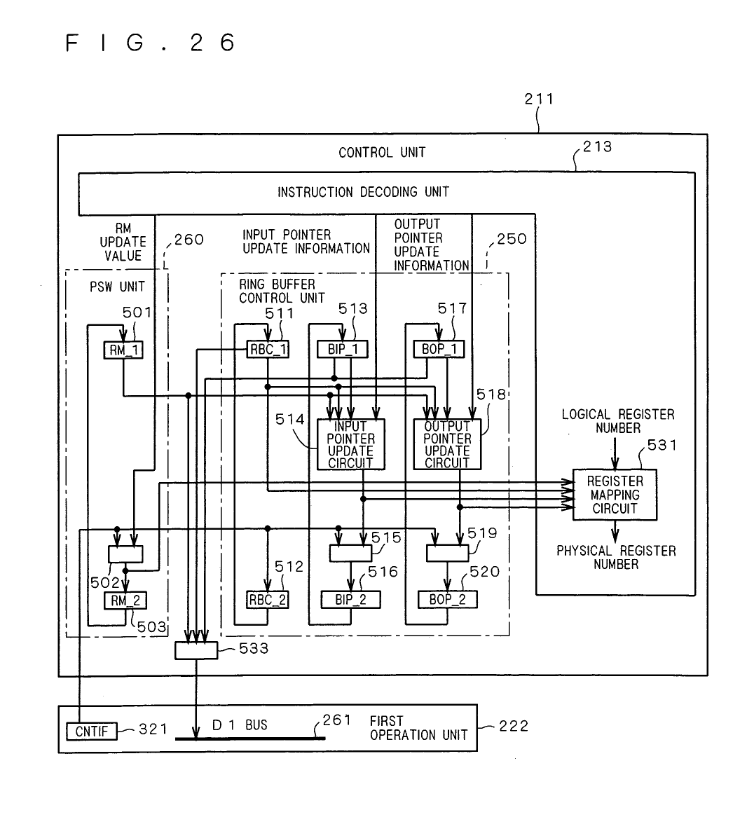

FIG. 25 is an explanatory diagram showing exemplary operation hardware interference. When there is a rounding instruction using an adder immediately after the product-sum operation instruction, for example, execution start of the rounding instruction is inhibited until the precedent product-sum operation instruction is completed. In this case, one clock cycle stall takes place. No stall takes place if the product-sum operation instruction is continuous.

The first decoder 214 generates execution control signals mainly related to all operations of the first operation unit 222, operations of the PC unit 224 other than those controlled in the IF stage 401, read control to the S1, S2 and S3 buses 251, 252 and 253 of the register file 221 and write control from the D1 bus 261. The first decoder 214 also generates control signals necessary for processing in the M and W stages 404 and 405 dependent on instructions, and transfers the same subsidiarily to the flow of the pipeline processing. The second decoder 215 generates execution control signals mainly related to execution control in the second operation unit 223, read control to the S4, S5, S6 and S7 buses 254, 255, 256 and 257 of the register file 221 and write control from the D2 bus 262.

On the basis of repetition block last instruction information and block repetition processing end information fetched from the instruction queue 212, an update control signal for the NPC register 331 related to block repetition processing independent of instructions, an update control signal for the RPTC register 345, an update control signal related to clearance of the RP bit 63 of the control register CR0 (PSW) etc. are generated.

In the D stage 402, the data processor controls single step repetition. During the single step repetition, the data processor does not update an output pointer of the instruction queue 212 but repeats processing of the same instruction by a count specified by the instruction. When it is posted that the SRPTC latch 323 reaches “1”, this indicates that the single step repetition is completed when processing of the currently decoded instruction is ended, so that the output pointer of the instruction queue 212 is updated and processing of the following instruction is started in the next cycle. The data processor also generates a decrement control signal for the SRPTC latch 323 during the single step repetition processing and a control signal related to clearance control of the SRP bit 64 of the control register CR0 (PSW) at termination of the single step repetition processing in the D stage 402.

In the E stage 403, the data processor performs almost all processing related to memory access and instruction execution such as operation, comparison, register-to-register transfer including that between the control registers, operand address calculation of loading/store instructions, calculation of jump destination addresses of jump instructions, jump processing, EIT (generic term for exception, interruption and trap) detection, a jump to a vector address of each EIT etc. excluding addition of product-sum/product-difference operation instructions.

Interruption in an interruption enable case is necessarily detected in a break of a 32-bit instruction. Also when the 32-bit instruction includes two sequentially executed short instructions, no interruption is accepted between the two short instructions.

When the data processor executes an instruction for operand access in the E stage 403 and no memory access is completed in the M stage 404, completion in the M stage 403 is retarded. The control unit 211 performs stage control.

In the E stage 403, the ALU 301 in the first operation unit 222 performs arithmetic and logic operation, comparison, transfer, addressing of memory operands including modulo control, address calculation of branch destinations etc. The value of a register specified as the operand is read on the S1, S2 and S3 buses 251, 252 and 253 so that the ALU 301 performs operation and rewrites the operation result in the register file 221 through the selector 305 and the D1 bus 261. In a case of a loading/store instruction, the operation result is transmitted to the operand access unit 204 through the OA latch 306 and the OA bus 273. In a case of a jump instruction, the jump destination address is transmitted to the PC unit 224 through the JA bus 274. Stored data is read from the register file 221 through the S1 and S2 buses 251 and 252, transferred through the SD register 311 and the latch 312 and thereafter leveled in the leveling circuit 313. The PC unit 224 manages the PC value of the currently executed instruction and generates the address of the subsequently executed instruction. Transfer between the control registers (excluding accumulators) included in the first operation unit 222 and the PC unit 224 and the register file 221 is performed through the S3 bus 253 and the D1 bus 261.

In the E stage 403, the second operation unit 223 executes all operations such as arithmetic and logic operation, comparison, transfer, shifting etc. other than addition of product sums. The value of an operand is transferred to each functional unit from the register file 221, the immediate register 383, the accumulator 361 etc. through the S4, S5, S6 and S7 buses 254, 255, 256 and 257 and the SA1 and SA2 buses 281 and 282, to be subjected to specified operation and rewritten in the accumulator 361 through the DA1 and DA2 buses 283 and 284 or in the register file 221 through the D2 bus 262.

In the E stage 403, the data processor also controls updating of the flag value in the PSW in response to the operation results in the first and second operation units 222 and 223. However, the operation results are defined in a later period of the E stage 403, and hence the PSW value is updated in the next cycle in practice. The PSW value is completely updated by data transfer in the corresponding cycle.

In the E stage 403, the data processor further performs updating of a PC value independent of the executed instruction, block repetition control and single step repetition control. The data processor transfers the value of the latch 332 to the EPC register 334 every time the same starts processing a new 32-bit instruction. The NPC register 331 holds the address of the subsequently processed instruction. When a jump takes place in the E stage 403, the jump destination address generated in the ALU 301 is written in the NPC register 331 through the JA bus 274 and initialized. When processing of instructions sequentially continues, a value incremented by one in the incrementer 333 is rewritten in the NPC register 331 every time the data processor starts processing a 32-bit instruction. When starting processing a repetition block last instruction in block repetition continuation, the data processor fetches the head address of the repetition block from the latch 342. In a cycle for ending processing the repetition block last instruction, the value of the RPTC register 345 is decremented by the decrementer 347 through the latch 346 and rewritten. When ending the block repetition processing, the data processor clears the RP bit 63 of the PSW to zero in the cycle for ending the processing of the repetition block last instruction. During single step repetition, the value of the SRPTC latch 323 of the first operation unit 222 is decremented by the decrementer 326 and rewritten through the latch 324 every time the data processor starts processing a 32-bit instruction. When ending the single step repetition processing, the data processor clears the SRP bit 64 of the PSW to zero in the cycle for ending processing the instruction.

Memory access relevant information for a loading/store instruction and load register information generated in the first decoder 214 are held under control of the E stage 403 and transmitted to the M stage 404. An operation control signal for addition/subtraction execution of double precision multiplication/product-sum/product-difference operation is held under control of the E stage 403 and transmitted to the E2 stage 406. The control unit 211 also performs stage control of the E stage 403.

In the M stage 404, the data processor accesses the operand with the address received from the first operation unit 222. When the operand is in the built-in data memory 205 or an in-chip IO (not shown), the operand access unit 204 reads or writes the operand from or in the built-in data memory 205 or the in-chip IO once a clock cycle. When the operand is not in the built-in data memory 205 or the in-chip IO, the operand access unit 204 issues a data access request to the external bus interface unit 206. The external bus interface unit 206 accesses data of the external memory and transfers the read data to the operand access unit 204 in a case of loading. The external bus interface unit 206 can access the external memory in two clock cycles at the minimum. In the case of loading, the operand access unit 204 transfers the read data through the OD bus 271. The operand access unit 204 writes the data in the LD register 315 when the same is byte data, while directly writing the data in the register file 221 when the same is word, 2-word or 4-word data. In a case of storage, the leveling circuit 313 transfers the value of leveled stored data to the operand access unit 204 through the latch 314 and the OD bus 271 so that the same is written in n object memory. The control unit 211 also performs stage control of the M stage 404.

In the W stage 405, the leveling circuit 316 levels and zero/code-extends the load operand (byte) held in the LD register 315 and thereafter transfers the same to the latch 317, so that the operand is written in the register file 221 through the W bus 272.

In the E2 stage 406, the data processor performs addition/subtraction processing of double precision multiplication/product-sum/product-difference operation in the adder 362 of the second operation unit 223 or the adder 395, and rewrites the addition/subtraction result in the accumulator 361.

This data processor performs internal control on the basis of an input clock. In the minimum case, the data processor ends the processing of each pipeline stage in a single internal clock cycle. Description of the details of clock control is omitted since the clock control is not directly related to the present invention.

Exemplary processing of each subinstruction is now described. The data processor ends processing of an operation instruction for addition/subtraction, logical operation, comparison or the like or register-to-register transfer instruction in three stages, i.e., the IF, D and E stages 401, 402 and 403. The data processor performs operation or data transfer in the E stage 403.

The data processor performs a double precision multiplication/product-sum/product-difference operation instruction in four-stage processing, since the same executes the operation in two clock cycles of the E stage 403 for multiplication and the E2 stage 406 for addition/subtraction.

The data processor ends processing of a byte loading instruction in five stages, i.e., the IF, D, E, M and W stages 401, 402, 403, 404 and 405. The data processor ends a word/2-word/4-word loading instruction or a store instruction in four stages, i.e., the IF, D, E and M stages 401, 402, 403 and 404.

In a case of unleveled access, the operand access unit 204 performs memory access divided into two accesses leveled under control of the M stage 404.

The data processor processes an instruction requiring two cycles for execution in two cycles in the first and second instruction decoders 214 and 215, outputs an execution control signal every cycle, and performs operation execution in the two cycles.

Each long instruction constitutes each 32-bit instruction, and the data processor completes execution of the 32-bit instruction by processing the long instruction. The data processor rates two parallelly executed instructions to processing of an instruction having a larger processing cycle in two short instructions. For example, the data processor requires two cycles for combination of an instruction executed in two cycles and that executed in one cycle.

In a case of two sequentially executed short instructions in combination of respective subinstructions, the data processor sequentially decodes the respective instructions and executes the same. When completing execution of two addition instructions in one cycle in the E stage 403, for example, the data processor processes each instruction in one cycle, i.e., in two cycles for the instructions in total, also in the D and E stages 402 and 403. The data processor decodes the subsequent instruction in the D stage 402 in parallel with execution of the precedent instruction in the E stage 403.

<Ring Buffer Control Relevance>

(Structure)

A ring buffer control method is now schematically illustrated. FIG. 26 is a block diagram showing the structure of a ring buffer control relevant portion of the control unit 211. FIG. 26 shows only principal signals, while omitting detailed control signals etc. for the purpose of simplification. The data processor selectively controls selectors 502, 515, 519 and 533 on the basis of the output of the instruction decoding unit 213 (more precisely, the first decoder 214).

RM (RM_{—}1, RM_{—}2) latches 501 and 503 in the PSW unit 260 physically hold the RM bit 68 of the control register CR0 (PSW). When setting the RM bit 68, the selector 502 selects the output of the instruction decoding unit 213 or the CNTIF latch 321 for updating the values of the RM_{—}1 and RM_{—}2 latches 501 and 503. This data processor comprises a ring buffer-on instruction and a ring buffer-off instruction. The data processor sets the RM bits 501 and 503 to “1” in response to the output (RM update value) of the instruction decoding unit 213 (more precisely, the first decoder 214) when executing the ring buffer-on instruction, while clearing the values of the RM latches 501 and 503 to “0” in response to the output (RM update value) of the instruction decoding unit 213 when executing the ring buffer-off instruction or detecting EIT (exception, interruption and trap) and starting EIT processing.

When performing writing in the control register CR0 (PSW) in response to a transfer instruction to the control register CR0 or returning the value of the control register CR1 (BPSW) to the control register CR0 (PSW) in return from EIT processing, the data processor sets the RM latches 501 and 503 on the basis of the output value of the CNTIF latch 321 in the first operation unit 222.

The ring buffer control unit 250 is constituted of latches 511 to 513, 516, 517 and 520, selectors 515 and 519, an input pointer update circuit 514 and an output pointer update circuit 518.

The latches 511 and 512 physically hold the value of the control register CR4 (RBC). When performing writing in the control register CR4 (RBC) in response to a transfer instruction to the control register CR4, the data processor sets the values of the RBC_{—}1 and RBC_{—}2 latches 511 and 512 on the basis of the output value of the CNTIF latch 321 in the first operation unit 222.

The latches 513 and 516 physically hold the values of the input pointers BIP0 to BIP3 (91, 93, 95 and 97) of the control register CR5 (RBP). For the purpose of simplification, FIG. 26 representatively shows a latch corresponding to one of the four pointers. In practice, structures corresponding to the BIP_{—}1 latch 513, the input pointer update circuit 514, the selector 515 and the BIP_{—}2 latch 516 are provided in correspondence to the logical registers R0 to R3 respectively.

The input pointer update circuit 514 updates the input pointer values. In other words, the input pointer update circuit 514 updates the input pointer values in response to the value of the RBC_{—}1 latch 551, the unupdated pointer values held in the BIP_{—}1 latch 513 and input pointer update information output from the instruction decoding unit 213 (more precisely, the first decoder 214). The input pointer update information includes information of the register to be loaded and ring buffer-on instruction information in addition to incremental information indicating the number for incrementing the pointers. When the register to be loaded operates in the ring buffer mode, the input pointer update circuit 514 increments the input pointer corresponding to the number of loaded data.

In each input pointer, the maximum pointer value and “0” are circular. When executing the ring buffer-on instruction, the data processor forcibly clears all input pointer values stored in the latches 513 and 516 to zero.

The selector 515 selects the output value of the CNTIF latch 321 in the first operation unit 222 when performing writing in the control register CR5 (RBP) in response to a transfer instruction for the control register CR5, while otherwise selecting the output value of the input pointer update circuit 514. The data processor sets the values of the BIP_{—}1 and BIP2 latches 513 and 516 on the basis of the output value of the selector 515 every pointer to be updated.

When the corresponding logical register corresponds to the register to be loaded operating in the ring buffer mode in this structure, the input pointer update circuit 514 can perform an input pointer update operation by updating the corresponding input pointer acquired from the BIP_{—}1 latch 513 by incrementing the same by the number indicated by the aforementioned incremental information and writing the updated input pointer in the BIP_{—}2 latch 516 through the selector 515 on the basis of the incremental information included in the input pointer update information and the value of the RBC_{—}1 latch 511.

The latches 517 and 520 physically hold the values of the output pointers BOP0 to BOP3 (92, 94, 96 and 98) of the control register CR5 (RBP). For the purpose of simplification, FIG. 26 representatively shows a latch corresponding to one of the four pointers. In practice, structures corresponding to the BOP_{—}1 latch 517, the output pointer update circuit 518, the selector 519 and the BOP_{—}2 latch 520 are provided in correspondence to the logical registers R0 to R3 respectively.

The output pointer update circuit 518 updates the output pointer values. In other words, the output pointer update circuit 518 updates each output pointer value in response to the value of the RBC_{—}1 latch 511, the unupdated pointer values held in the BOP_{—}1 latch 517 and output pointer update information output from the instruction decoding unit 213 (more precisely, the first decoder 214 or the second decoder 215) when the corresponding ring buffer is in an enabled state (the value of the RM_{—}1 latch 501 is “1”). The data processor sets the values o the BOP_{—}1 and BOP_{—}2 latches 517 and 520 on the basis of the output value of the selector 519 every output pointer to be updated.

The output pointer update information includes reference information for the corresponding register value, repetition block last instruction information, branch instruction information, ring buffer-on instruction information, output pointer update instruction information etc. According to this embodiment, the incremental quantity for each output pointer is only “1”, whereby the data processor requires no incremental information included in the input pointer update information.

In a case other than ring buffer-on instruction execution, the data processor refers to necessary information on the basis of a set value of the RBC_{—}1 latch 511 and increments an output pointer corresponding to any register operating in the ring buffer mode. According to this embodiment, the update size is only +1 as described above. The maximum pointer value and “0” are circular. The data processor forcibly clears all output pointer values to zero when executing the ring buffer-on instruction.

When the corresponding logical register corresponds to the register operating in the ring buffer mode to be referred to in this structure, the output pointer update circuit 518 can perform an output pointer update operation by updating an output pointer acquired from the BOP_{—}1 latch 517 by incrementing the same by one and writing the updated output pointer in the BOP_{—}2 latch 520 through the selector 519 on the basis of the output pointer update information and the value of the RBC_{—}1 latch 511.

In a case of reading the values of the control registers CR0 (PSW), CR4 (RBC) and CR5 (RBP) in response to a transfer instruction or saving the value of the control register CR0 (PSW) following starting of EIT processing, the data processor outputs the values of the RM_{—}1, RBC_{—}1, BIP_{—}1 and BOP_{—}1 latches 501, 511, 513 and 517 etc. to the D1 bus 261 through the selector 533.

The data processor updates the aforementioned pointer values and refers to the pointer values following instruction execution or EIT processing in the E stage 403.

A register mapping circuit 531 receives the value of the RBC latch 511 and the outputs of the selector 502, the input pointer update circuit 514 and the output pointer update circuit 518 as control information, and converts the numbers of the logical registers R0 to R3 functionable as ring buffers in the ring buffer mode to register numbers (referred to as physical register numbers) managed in the data processor including the buffer registers among register numbers R0 to R15 (referred to as logical register numbers) specified by an instruction. FIG. 26 illustrates the register mapping circuit 531, which may also be grasped as a block independent of the instruction decoding unit 213, as a part of the instruction decoding unit 213. The first and second decoders 214 and 215 (not shown in FIG. 26) share the register mapping circuit 531.

Logical register specifying means consisting of the aforementioned PSW unit 260, the ring buffer control unit 250 and the register mapping circuit 531 can sequentially specify variable physical registers BR0 to BR7 etc. in a specified physical register group corresponding to the specific logical registers R0 and R1 (R2 and R3) on a first-in, first-out (FIFO) basis.

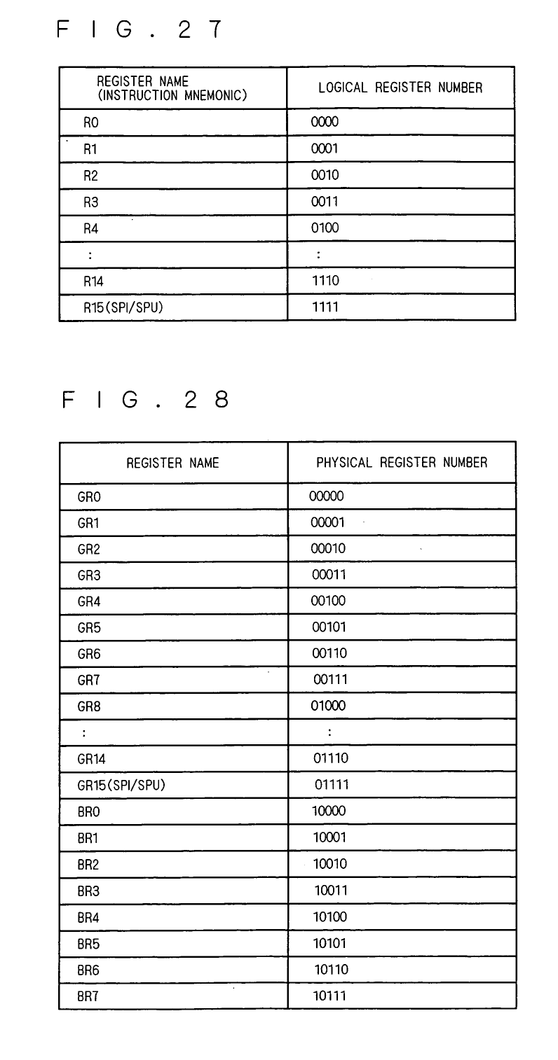

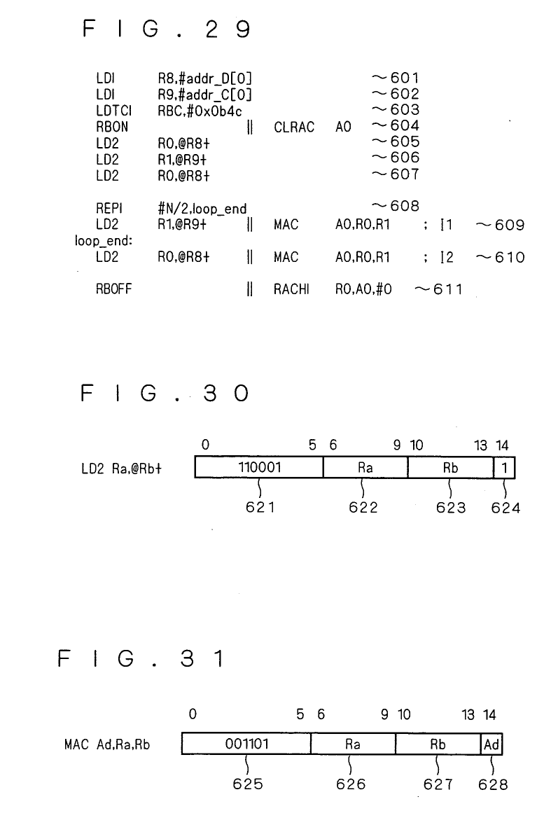

FIG. 27 is an explanatory diagram showing the association between register names specified by instruction mnemonics and 4-bit logical register numbers specified by operation codes in the form of a table. FIG. 28 is an explanatory diagram showing the association between register names as register sets and 5-bit physical register numbers in the form of a table.

The register mapping circuit 531 operates in the D stage 402. Reflecting the values of input/output pointers, updated values of the RM bits and the value of the control register CR4 (RBC) following precedent instruction execution currently processed in the E stage 403, the register mapping circuit 531 converts the logical register numbers of the subsequent instruction currently decoded in the D stage 402 to physical register numbers. The control unit 211 generates a read/update control signal for the register file 221 to any bus and controls hardware such as load operand interference check (not shown) for determining whether or not a register value referred to or updated in the E stage 403 has been completely loaded on the basis of the converted physical register numbers.

(Basic Operation)

(Ring Buffer Operation Dedicated Instruction)

The data processor processes all of the following ring buffer operation instructions on the basis of the output of the first decoder 214 in the instruction decoding unit 213:
ring buffer-on (RBON) instruction
ring buffer-off (RBOFF) instruction
output pointer update (UPDBOP) instruction
instruction for transfer from general-purpose registers to control registers (RBC and RBP)
instruction for transfer from control registers (RBC and RBP) to general-purpose registers
dedicated loading instruction (LD2, LD2W2 etc.) to register operating in ring buffer rode

When the first decoder 214 decodes the ring buffer-on instruction (RBON), the data processor sets the RM bits 501 and 503 in the PSW unit 260 to “1” on the basis of the output of the first decoder 214, while the input pointer update circuit 514 and the output pointer update circuit 518 clear the control register CR5 (RBP) (the values of the latches 513, 516, 517 an 519 corresponding to the logical registers R0 to R3 respectively) to zero under control of the first decoder 214, for initializing all input/output pointers to “0”.

When decoding the ring buffer-off instruction (RBOFF) on the basis of the output of the firs decoder 214, the data processor clears the RM bits 501 and 503 of the PSW unit 260 to “0” on the basis of the output of the first decoder 214.

(Input Pointer Update Control)

The following information is input in the input pointer update circuit 514 and referred to for updating the input pointers:
value of the RM bit 501 of the PSW unit 260 (enabled when “1”)
values of the RBC latch 511 (values of the RBE0 to RBE3 bits (enabled when “1”) and RBCNF (upper limit of a pointer for any register operating in the ring buffer mode)
value of unupdated input pointer held in the BIP latch 513
input pointer update information (instruction decoding result) from the instruction decoding unit 213 (first decoder 214)

Specific examples of the input pointer update information output from the first decoder 214 are as follows:
load register number (pointer-updated logical register number and update necessariness/unnecessariness, four at the maximum)
pointer update value (+1 or +2) for each number of register
ring buffer-on instruction information (RBON instruction)

More specifically, the input pointer update circuit 514 updates any input pointer as follows:

(1). In Execution of Ring Buffer-On (RBON) Instruction

The input pointer update circuit 514 forcibly clears the values of all input pointers to zero.

(2). In Execution of Loading Instruction

The input pointer update circuit 514 updates each updated register satisfying the following conditions 11 to 13 by specifying +1 or +2 as the pointer update value depending on the loading instruction:
Condition 11: The RM bit 501 of the PSW unit 26 is “1” (enabled). [common]
Condition 12: RBEi of the RBC latch 511 is “1” (enabled). [object register]
Condition 13: The structure of a register operating in the ring buffer mode is set by the value of RBCNF of the RBC latch 511. [object register]

(Output Pointer Update Control)

The following information is input in the output pointer update circuit 518 and referred to for updating the value of any output pointer. The update size for each output pointer is only +1.
value of the RM bit 501 of the PSW unit 260 (enabled when “1”)
values of the RBC latch 511 (values of the RBE0 to RBE3 bits (enabled when “1”), RBCNF (upper limit of a pointer for any register operating in the ring buffer mode), STM (information as to whether or not to perform pointer updating related to register value reference of stored data) and OPM0 to OPM3 (information as to under which condition to perform pointer updating))
value of unupdated input pointer held in the BOP latch 517
output pointer update information (instruction decoding result) from the instruction decoding unit 213 (first decoder 214 or second decoder 215)

Specific examples of the output pointer update information output from the first decoder 214 or the second decoder 215 are as follows:
reference register number (pointer-updated logical register number and update necessariness/unnecessariness, four at the maximum)
store information (appendix information of reference register number)
repetition block last instruction information (value fetched from instruction queue and not a pure instruction decoding result in practice)
branch instruction information
ring buffer-on instruction (RBON instruction) information
output pointer update instruction (UPDBOP instruction) information (update-controllable by +1 in unit of register due to specification with this instruction)

In the aforementioned output pointer update information, the first decoder 214 or the second decoder 215 outputs the reference register number, while only the first decoder 214 outputs the store information, the repetition block last instruction information, the branch instruction information, the ring buffer-on instruction information and the output pointer update instruction information.

More specifically, the output pointer update circuit 518 updates any output pointer as follows:

(1). In Execution of RBON Instruction

The output pointer update circuit 518 forcibly clears the values of all output pointers to zero.

(2). In Execution of UPDBOP Instruction

The output pointer update circuit 518 updates only the output pointer for a register specified by an instruction (on the assumption that the pointer-updated register satisfies conditions 21 to 23 described below).

(3). In Execution of Register Value Reference Instruction (Other than Stored Register Specified by Store Instruction)

If OPMi corresponding to a reference register is “01”, the output pointer update circuit 518 updates the output pointer for this reference register (reference register satisfying the conditions 21 to 23 described below).

(4) In Execution of Register Value Reference Instruction (Stored Register Specified by the Store Information)

When the value of STM is “0” and OPMi corresponding to the reference register is “01”, the output pointer update circuit 518 updates the output pointer for this reference register. When STM is “0”, further, the output pointer update circuit 518 reads stored data from the corresponding ring buffer (reference register satisfying the conditions 21 to 23 described below).

(5). In Execution of Repetition Block Last Instruction (Final Execution Cycle)

The output pointer update circuit 518 updates the output pointer for any register satisfying the conditions 21 to 23 described below with corresponding OPMi set to “10”.

(6). In Execution of Branch Instruction

The output pointer update circuit 518 updates the output pointer for any register satisfying the conditions 21 to 23 described below with corresponding OPMi set to “11”.

The aforementioned conditions 21 to 23 are as follows:
Condition 21: The RM bit 501 of the PSW unit 26 is “1” (enabled). [common]
Condition 22: RBEi of the RBC latch 511 is “1” (enabled). [object register]
Condition 23: The structure of a register operating in the ring buffer mode is set by the value of RBCNF of the RBC latch 511. [object register]

(Other Updating)

Under control of the first decoder 214, the selectors 515 and 519 select the output of the CNTIF latch 321 so that the contents of the CNTIF latch 321 are set in the latches 513, 515, 517 and 519 corresponding to the logical registers R0 to R3 respectively.

<Exemplary Programs 1 to 10>

Specific operations of the data processor according to this embodiment are now described in detail with reference to some exemplary programs.

<Exemplary Program 1: Single Precision Product-Sum Operation 1>

Exemplary product-sum operation is described with reference to a case of performing the following processing in C language notation:
for (i=0, sum=0; i<N; ++i) sum+=C[i]*D[i];

The data processor repeats product-sum operation of 16-bit fixed points C and D N times. It is assumed that N represents a multiple of the number 2. It is also assumed that C[i] and D[i] are sequentially arranged on the built-in data memory in order of i in an address incremental direction, and C[0] and D[0] are leveled 32 bits (4 bytes). It is further assumed that the product-sum operation result (sum) is rounded to 16 bits and held at r0.

FIG. 29 is an explanatory diagram showing an exemplary program 1 in an assembler performing the product-sum operation. Semicolons “;” are followed by comments. Marks “∥” denote parallel execution of pairs of short instructions. For the purpose of convenience, it is assumed that “a” and “b” are appended to the ends of instructions on the left and right sides of “∥” respectively for reference when the data processor parallelly executes the pairs of instructions. For example, it is assumed that the data processor refers to an LD2 instruction as 609a or I1a while referring to a MAC instruction as 709b or I1b in I1 of a command row 609. This also applies to the subsequent examples.

Command rows 601 to 607 are preprocessing for performing block repetition processing, a command row 608 is a block repetition instruction, command rows 609 and 610 are repetition blocks for performing product-sum operation, and a command row 611 is a part for postprocessing after the block repetition processing.

Each LDI instruction is a long instruction for transferring a 16-bit immediate value to the corresponding register. The data processor sets addresses D[0] and C[0] in the logical registers R8 and R9 with LDI instructions 601 and 602 respectively. Each LDTCI instruction is a long instruction for transferring a 16-bit immediate value to the corresponding control register. The data processor employs an LDTCI instruction 603 for initializing the control register CR4 (RBC). According to this instruction, the data processor sets the RBCNF bit 80 to “00”, the STM bit 81 to “0”, the WM bit 82 to “0”, the RBE0 and RBE1 bits 83 and 85 to “1” and the OPM0 and OPM1 bits 84 and 86 to “01” respectively. In other words, each of the logical registers R0 and R1 enters the ring buffer structure (see FIG. 9) consisting of four entries, for updating the corresponding output pointer with reference to the corresponding register value.

With an RBON instruction 604a which is a ring buffer-on instruction, the data processor sets the RM bit 68 of the control register CR0 (PSW) to “1”, while clearing the control register CR5 (RBP) to zero and initializing the corresponding input/output pointer to “0”. The data processor employs a CLRAC instruction 604b for clearing 21 accumulators A0 to zero.

A “LD2 Ra, Rb+” instruction (update point size +2) which is a multiple data updating instruction dedicated to the ring buffer mode is a 2-word loading instruction of the post-incremental register indirect mode for loading 2-word data from an Rb value address area of the corresponding memory, writing the same in Ra operating in the ring buffer mode and post-incrementing the value of Rb by four corresponding to an operand size.

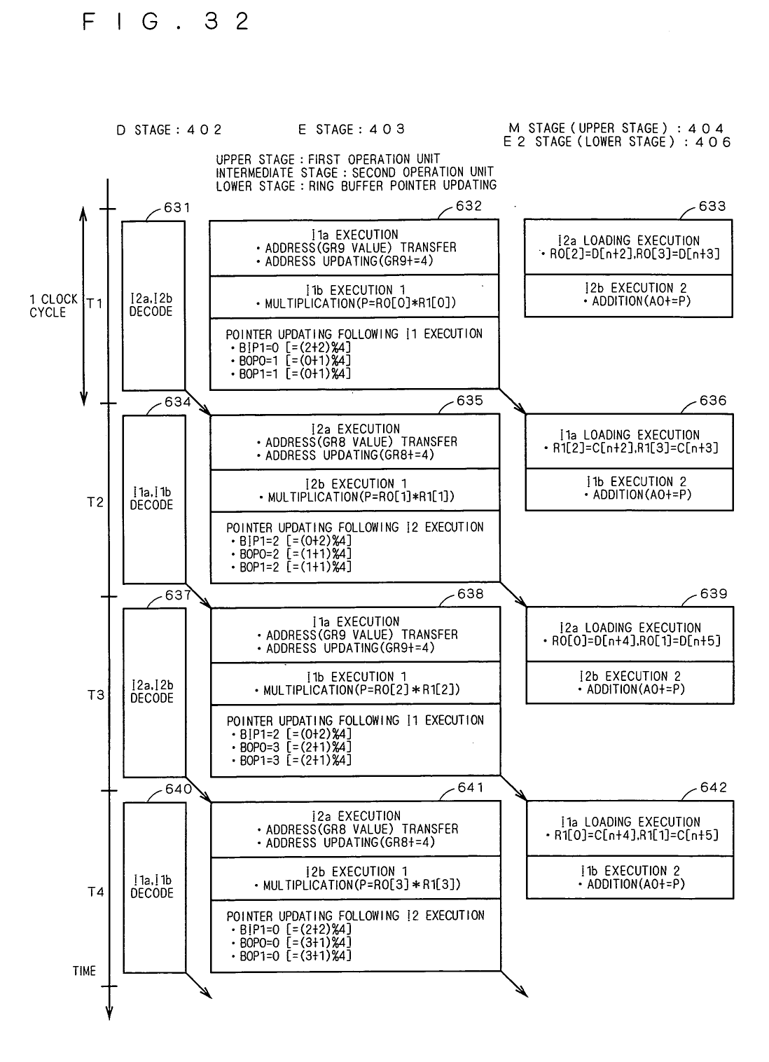

FIG. 30 is an explanatory diagram showing allocation of instruction codes of the loading instruction LD2. The loading instruction LD2 has the instruction format shown in FIG. 14, and both of Ra and Rb fields 622 and 623 specify 4-bit logical register numbers. The data processor preloads data preceding loop processing with LD2 instructions 605 to 607.

This data processor must read array data allocated to two different areas with different loading instructions. Due to loading performed in the M stage 404, the data processor must load operand data referred to for a product-sum instruction with an instruction executed in advance of at least two cycles also when the same is in the built-in data memory, in order to execute the product-sum operation with no pipeline stall. The data processor uses the four registers of the logical register R0 and the four registers of the logical register R1 as buffers of D[i] and C[i] respectively.

An REPI instruction 608 is a block repetition instruction specifying a repetition cycle with an immediate value, for repeating two instructions of the command rows 609 and 610 N/2 times. The data processor loads unnecessary data by six words since no redundant loading is inhibited in loop epilog processing in order to simplify the program. The data processor implements the product-sum operation processing with a single throughput in one clock cycle by repetitively executing the LD2 instructions and MAC instructions of the command rows 609 and 610. Detailed description of repetition instruction processing is omitted since the details of block repetition processing are not directly related to the present invention.

A “MAC Ad, Ra, Rb” instruction which is a register value reference instruction other than a store instruction is a product-sum operation instruction for multiplying the Ra and Rb values together and adding the multiplication result to an Ad value. FIG. 31 is an explanatory diagram showing allocation of instruction codes of the product-sum operation instruction MAC. The product-sum operation instruction MAC has the instruction format shown in FIG. 14, and both Ra and Rb fields 626 and 627 specify 4-bit logical register numbers, while an Ad field 628 specifies a destination accumulator number.

An instruction 611 is a part for postprocessing after the block repetition processing. An RBOFF instruction 611a is a ring buffer-off instruction for clearing the RM bit 68 of the control register CR0 (PSW) to “0”. The data processor employs an RACHI instruction 611b for rounding the values of the 21 accumulators A0 in a 16-bit fixed point format and writing the rounded values in the logical register R0 (GR0) with saturation to 16 bits.

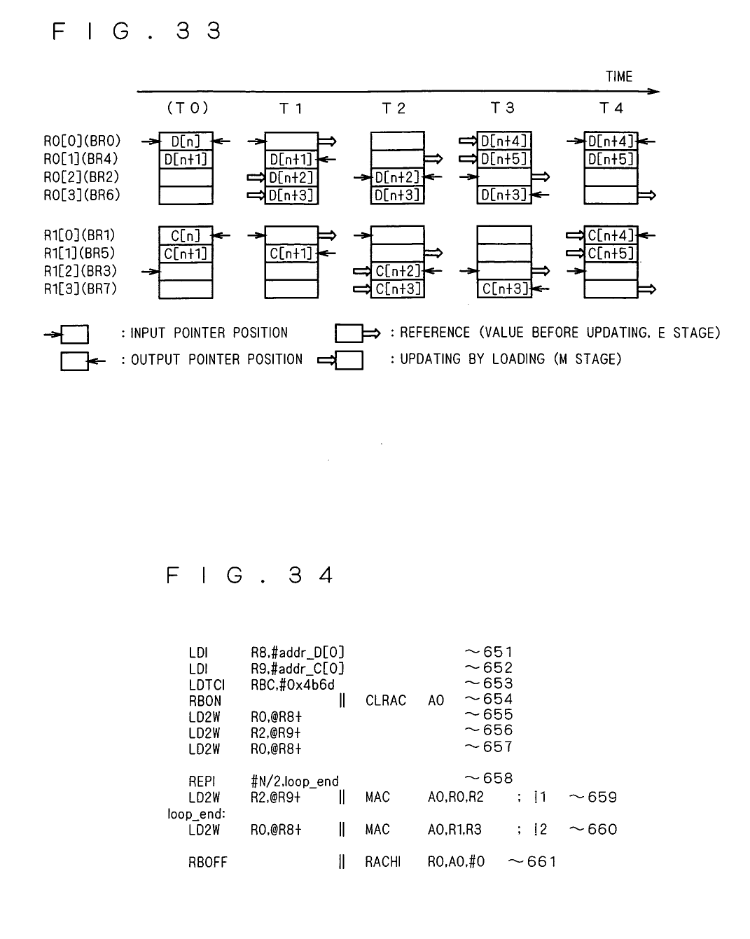

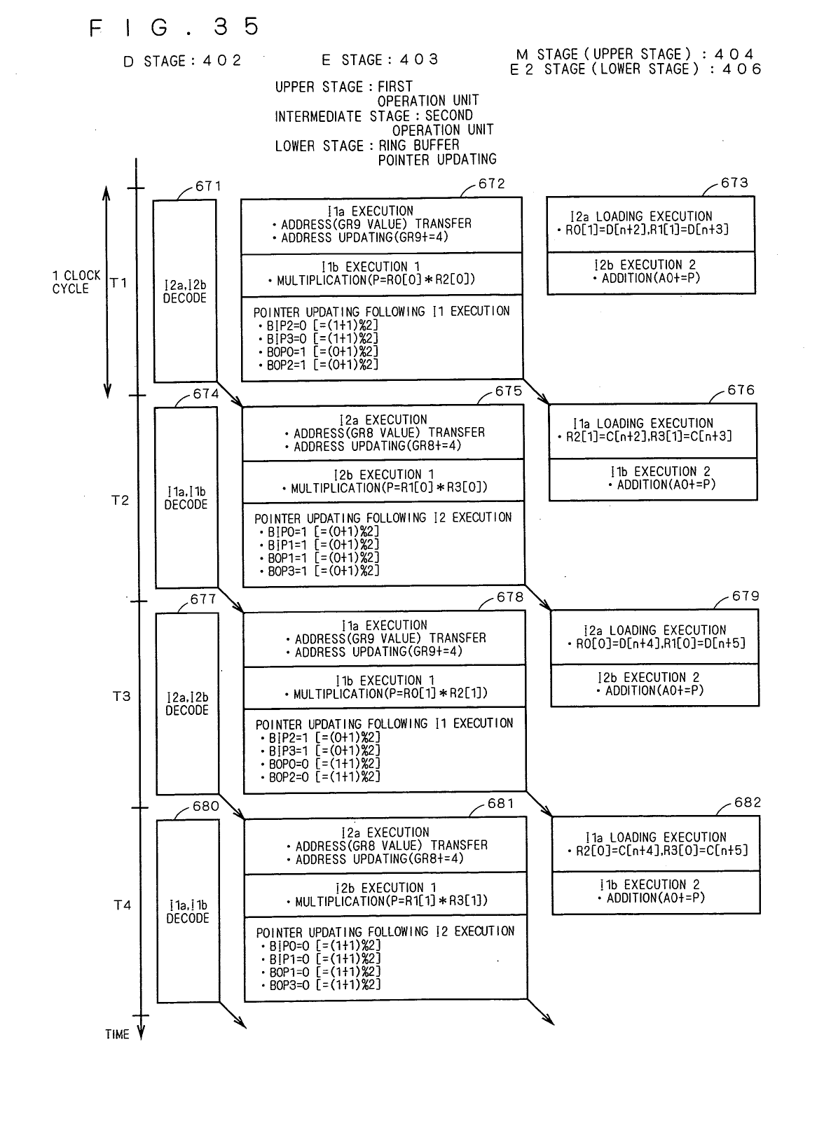

FIG. 32 is an explanatory diagram showing pipeline processing in block repetition processing in the exemplary program 1 in detail. FIG. 33 is an explanatory diagram showing states of the ring buffers in the pipeline processing shown in FIG. 32.

FIGS. 32 and 33 show states of processing in a case of executing the I1 instruction 609 in the E stage 403 of a certain period T1 in the block repetition processing for multiplying D[n] and C[n] together. The data processor repeats the processing every two clock cycles as the instruction processing. Input/output pointers return to the same states every four clock cycles as the ring buffer operations.

FIG. 33 shows the states of the ring buffers at the points of completion of the respective clock cycles. The data processor updates the pointers of the ring buffers in the E stage 403, and writes load data other than byte data in the registers in the M stage 404. FIG. 33 shows the states of the ring buffers with reference to time, and hence the data processor completes updating each input pointer in advance of writing of actually loaded data by one clock cycle. In other words, it seems to change in displacement by one instruction with reference to the instruction, due to the pipeline processing. Symbol T0 denotes a state preceding T1 by one clock cycle (initial state in T1 execution starting).

While FIG. 33 shows variable names, the data processor refers to unupdated register values when referring to and updating the register values in the same clock cycle in relation to register values blanking those out of lifetimes (thereafter not referred to as effective data).

The data processor performs processing 632 (execution of the I1 instruction 609) in the E stage 403 of the period T1. The first operation unit 222 outputs and updates the address of the LD2 instruction 609a. The value of the general-purpose register GR9 is output to the operand access unit 204 as the address, post-incremented and rewritten in the general-purpose register GR9.

The second operation unit 223 performs multiplication of the MAC instruction 609b. The data processor reads the values of already loaded D[n] and C[n] values from the buffer registers BR0 and BR1 allocated as R0[0] and R1[0] respectively, so that the multiplier 376 of the second operation unit 223 multiplies the values together and rewrites the multiplication result in the P latch 379.

The logical register R1 loads 2-word data following execution of the LD2 instruction 609a, whereby the value of an input pointer BIP1 for the logical register R1 is incremented by two, circulated and updated to “0”. In other words, the input pointer update circuit 514 sets “0” for the BIP_{—}1 and BIP_{—}2 latches 513 and 516 corresponding to the logical register R1 through the selector 515.

Further, the logical registers R0 and R1 are referred to following execution of the MAC instruction 609b, whereby the output pointers BOP0 and BOP1 for the logical registers R0 and R1 are incremented by one respectively and updated to “1”. In other words, the output pointer update circuit 518 sets “1” for the BOP_{—}1 and BOP_{—}2 latches 517 and 520 corresponding to the logical registers R0 and R1 through the BOP_{—}2 latch 520.

The data processor performs processing 636 (processing of the I1 instruction 609) in the M stage 404 and the E2 stage 406 of a period T2. In the M stage 404, the data processor writes values C[n+2] and C[n+3] in the buffer registers BR3 and BR7 allocated as R1[2] and R1[3] respectively. In the M stage 404 of the period T2, the input pointer is “2” corresponding to the logical register R1 in decoding in the period T0.

In the E2 stage 406 for the processing 636, the data processor adds the value of the P latch 379 indicating the multiplication result in the E stage 403 to the value of the accumulator A0, and rewrites the result in the accumulator A0.

In the D stage 402 of the period T1, the data processor performs processing 631 (decoding of the I2 instruction 610). The register mapping circuit 531 maps a register operating as a ring buffer to a physical register number on the basis of updated states of input/output pointers of the ring buffer following execution of the I1 instruction of the processing 632.

In the E stage 403 of the period T2, the data processor performs processing 635 (execution of the I2 instruction 610). The first operation unit 222 outputs and updates the address of the LD2 instruction 610a. The value of the general-purpose register GR8 is output to the operand access unit 204 as the address, post-incremented and rewritten in the general-purpose register GR8.

The second operation unit 223 performs multiplication of the MAC instruction 610b. The data processor reads the values of already loaded D[n+1] and C[n+1] from BR4 and BR5 allocated as R0[1] and R1[1] respectively, so that the multiplier 376 multiplies the same together and rewrites the multiplication result in the P latch 379. An output pointer in the E stage 403 of the period T2 is “1” corresponding to the logical registers R0 and R1 in decoding of the processing 631 in the period T1.

The logical register R0 loads 2-word data following execution of the LD2 instruction 610a in the processing 635, whereby the value of the input pointer BIP0 of the logical register R0 is incremented by two by the input pointer update circuit 514 or the like and updated to “2”. Further, the logical registers R0 and R1 are referred to following execution of the MAC instruction 610b, whereby the output pointers BOP0 and BOP1 of the logical registers R0 and R1 are incremented by one by the output pointer update circuit 518 or the like and updated to “2”.

In the M stage 404 and the E2 stage 406 of a period T3, the data processor performs processing 639 (processing of the I2 instruction 610). In the M stage 404, the data processor writes values D[n+4] and D[n+5] in the buffer registers BR0 and BR1 allocated as R0[0] and R0[1] respectively. In the E2 stage 406, the data processor adds the value of the P latch 379 indicating the multiplication result in the E stage 403 to the value of the accumulator A0, and rewrites the result in A0.

In the D stage 402 of the period T2, the data processor performs processing 634 (decoding of the I1 instruction 609). The register mapping circuit 531 maps a register operating as a ring buffer to a physical register number on the basis of updated states of input/output pointers of the ring buffer following execution of the I2 instruction of the processing 635.

The data processor can execute the product-sum operation with one throughput in each clock cycle with neither overhead nor stall related to the corresponding load operand by repeating the aforementioned processing. In order to execute such product-sum operation processing with no overhead, the data processor essentially requires eight registers as buffers for load data. However, the ring buffers are so used that the data processor can implement processing with the two logical registers R0 and R1 while freely using the logical registers R2 to R7 for other purposes, although the same physically uses eight registers.

According to this exemplary program 1, the data processor holds the original values of the logical registers R2 to R7 in a non-destructive manner, to require no processing for saving and returning the values of the logical registers R2 and R7 before and after the processing shown in FIG. 29 also when the values of the logical registers R2 to R7 must be held. Therefore, the code size and the processing cycle number can be reduced for obtaining a high-performance data processor at a low cost (reduction of ROM capacitance).

The data processor can physically handle a large number of registers without increasing the number of fields for specifying register numbers, whereby a large number of instructions can be allocated to the same basic instruction length without increasing the basic instruction length. Therefore, coding efficiency can be improved while a large number of instructions can be allocated to short ones, whereby a high-performance data processor can be obtained at a low cost.

While four instructions are necessary at the minimum for constituting a loop since the numbers of registers used as data buffers are different from each other if no ring buffers are employed, the loop can be constituted of two instructions in the aforementioned exemplary program 1. While the repetition cycle is statically decided in the aforementioned exemplary program 1, a loop is constituted of four-element processing at the minimum if no ring buffers are employed and the repetition cycle dynamically changes in a case of calling the same subroutine or the like. Thus, the data processor determines cases of repetition cycles “4×M”, “4×(M+1)”, “4×(M+2)” and “4×(M+3)” (M: integer) for executing individual programs respectively, or requires fraction processing for repeating single processing by the remaining count.

According to this embodiment, on the other hand, the data processor may simply execute a “MAC A0, R0, R1” instruction in postprocessing of the loop if the repetition cycle N is odd. Therefore, the loop can be constituted with a smaller unit and the same register numbers can be used due to the employment of the ring buffers, whereby the code size for fraction processing and overhead of the processing cycle number can be so remarkably reduced that a high-performance data processor can be obtained at a low cost.

Further, the output pointers are implicitly updated on the basis of reference to the register values following instruction execution without explicit specification with instructions, whereby a high-speed data processor can be implemented at a low cost with no overhead following updating of the output pointers.

In addition, the processing cycle number is so effectively reduced that power consumption for the same processing can be reduced.

Further, the program is so effectively simplified that software development efficiency can be improved and a possibility of bug contamination can be reduced.

<Exemplary Program 2: Single Precision Product-Sum Operation 2>

FIG. 34 is an explanatory diagram showing an exemplary program 2 in the assembler performing product-sum operation. The exemplary program 2 shown in FIG. 34 implements processing absolutely identical to that of the exemplary program 1 shown in FIG. 29 in a different manner. While the basic processing flow remains identical, the exemplary program 2 is different from the exemplary program 1 shown in FIG. 29 in a point using four logical register numbers for data buffers. The exemplary program 2 is now described noting the point different from the exemplary program 1 shown in FIG. 29 in particular.

Command rows 651 to 657 are preprocessing for block repetition processing, a command row 658 is a block repetition instruction, command rows 659 and 660 are repetition blocks for performing product-sum operation, and a command row 661 is a part for postprocessing after the block repetition processing.

According to an LDTCI instruction 653, the data processor sets the RBCNF bit 80 to “01”, the STM bit 81 to “0”, the WM bit 82- to “0”, the RBE0, RBE1, RBE2 and RBE3 bits 83, 85, 87 and 89 to “1” and the OPM0, OPM1, OPM2 and OPM4 bits 84, 86, 88 and 90 to “01” respectively. In other words, each of the logical registers R0 to R3 enters the ring buffer structure (see FIG. 10) consisting of two entries, for updating the corresponding output pointer with reference to the corresponding register value.

In the exemplary program 2, the data processor uses an LD2W instruction in place of the LD2 instruction in the exemplary program 1 shown in FIG. 29. An “LD2W Ra, Rb+” instruction (update point size +1) which is a data updating instruction common to the general-purpose register mode and the ring buffer mode is a 2-word loading instruction of the post-incremental register indirect mode for loading 2-word data from an Rb value address area of the memory and writing the same in a register R(a+1) having the register number obtained by adding 1 to the register numbers Ra and Ra (this notation also applies to the following) while post-incrementing the Rb value by four corresponding to the operand size. This instruction has the instruction format shown in FIG. 13 similarly to the loading instruction LD2, with operation codes different from those of the loading instruction LD2.

In the exemplary program 2, the data processor uses four registers for the logical registers R0 and R1 as buffers of D[i] and four registers for the logical registers R2 and R3 as buffers of C[i] respectively.

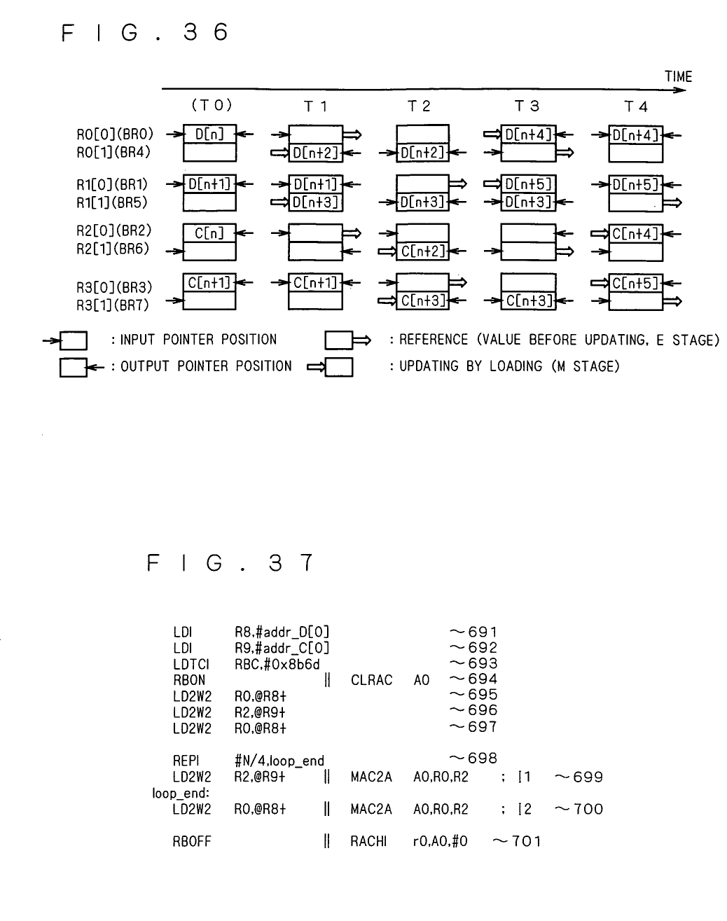

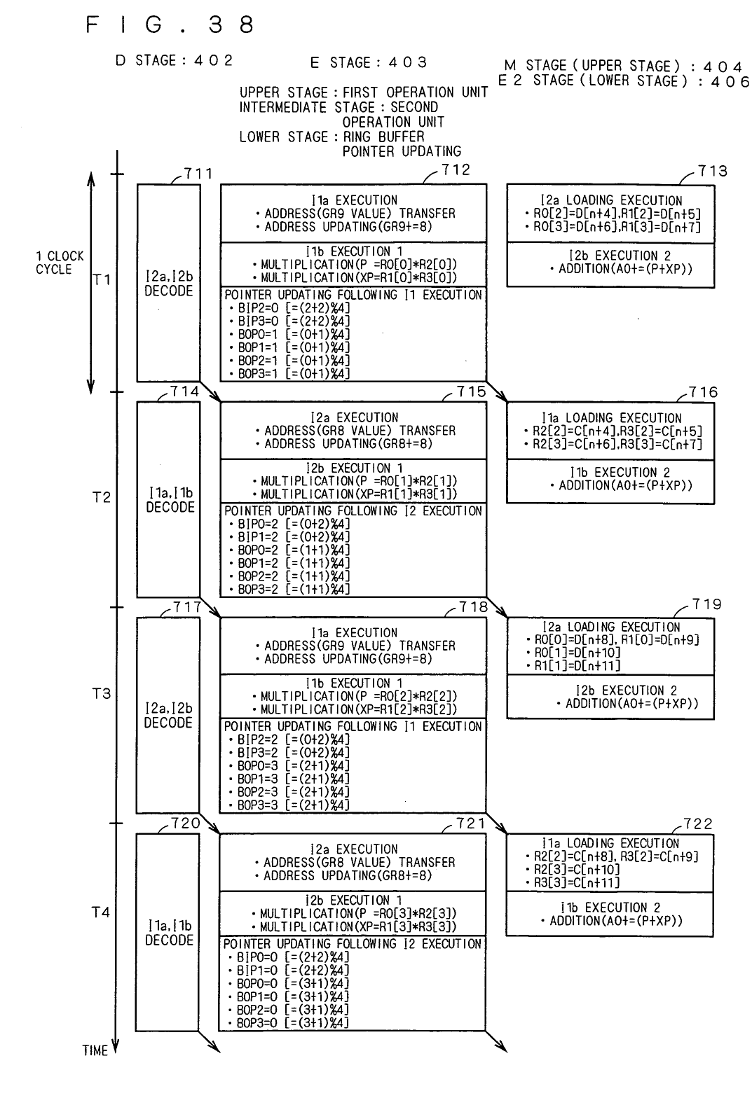

FIG. 35 is an explanatory diagram showing pipeline processing in block repetition processing in the exemplary program 2 in detail. FIG. 36 is an explanatory diagram showing states of the ring buffers in the pipeline processing shown in FIG. 35.

In other words, FIG. 35 shows the details of pipeline processing in block repetition processing of instructions of the command rows 659 and 660, and FIG. 36 shows the current states of the ring buffers. The data processor executes an I1 instruction 659 in the E stage 403 of a certain period T1 in the block repetition processing, for multiplying D[n] and C[n] together. The data processor repeats the processing every two clock cycles as instruction processing. Input/output pointers return to the same states every four clock cycles as the ring buffer operations.

The data processor performs processing 672 (execution of the I1 instruction 659) in the E stage 403 of the period T1. The first operation unit 222 outputs and updates the address of an LD2W instruction 659a. The value of the general-purpose register GR9 is output to the operand access unit 204 as the address, post-incremented and rewritten in the general-purpose register GR9.

The second operation unit 223 performs multiplication of a MAC instruction 659b. The second operation unit 223 reads the values of already loaded D[n] and C[n] from BR0 and BR2 allocated as R0[0] and R2[0] respectively so that the multiplier 376 multiplies the values together and writes the multiplication result in the P latch 379.

Following execution of the LD2W instruction 659a, the logical registers R2 and R3 load 1-word data respectively, whereby the input pointer update circuit 514 or the like increments the values of the input pointers BIP2 and BIP3 of the logical registers R2 and R3 by one respectively to update the same to “0” in circulation.

Following execution of the MAC instruction 659b, further, the data processor refers to the logical registers R0 and R2 respectively, thereby incrementing the output pointers BOP0 and BOP2 of the logical registers R0 and R2 by one respectively to update the same to “1”.

In the M stage 404 and the E2 stage 406 of a period T2, the data processor performs processing 676 (processing of the I1 instruction 659). In the M stage 404, the data processor writes the values of C[n+2] and C[n+3] in the buffer registers BR6 and BR7 allocated as R2[1] and R3[1] respectively.

In the E2 stage 406, the data processor adds the value of the P latch 379 indicating the multiplication result in the E stage 403 to the value of the accumulator A0 and rewrites the result in the accumulator A0.

In the D stage 402 of the period T1, the data processor performs processing 671 (decoding of an I2 instruction 660). The register mapping circuit 531 maps a register operating as a ring buffer to a physical register number on the basis of updated states of input/output pointers of the ring buffer following execution of the I1 instruction of the processing 672.

In the E stage 403 of the period T2, the data processor performs processing 675 (execution of the I2 instruction 660). The first operation unit 222 outputs and updates the address of an LD2W instruction 660a. The first operation unit 222 outputs the value of the general-purpose register GR8 to the operand access unit 204 as the address, post-increments the same and rewrites the result in the general-purpose register GR8.

The second operation unit 223 performs multiplication of a MAC instruction 660b. The second operation unit 223 reads the values of already loaded D[n+1] and C[n+1] from BR1 and BR3 allocated as R1[0] and R3[0] respectively, so that the multiplier 376 multiplies the same together and writes the multiplication result in the P latch 379.

Following execution of the LD2W instruction 660a, the logical registers R0 and R1 load 1-word data respectively, so that the input pointer update circuit 514 or the like increments the values of the input pointers BIP0 and BIP1 of the logical registers R0 and R1 by one respectively and updates the same to “1”.

Following execution of the MAC instruction 660b, further, the data processor refers to the logical registers R1 and R3, so that the output pointer update circuit 518 or the like increments the output pointers BOP1 and BOP3 of the logical registers R1 and R3 by one respectively and updates the same to “1”.

In the M stage 404 and the E2 stage of a period T3, the data processor performs processing 679 (processing of the I2 instruction 660). The data processor writes the values of D[n+4] and D[n+5] in the buffer registers BR0 and BR1 allocated as R0[0] and R1[0] respectively in the M stage 404.

In the E2 stage 406, the data processor adds the value of the P latch 379 indicating the multiplication result in the E stage 403 to the value of the accumulator A0 and rewrites the result in the accumulator A0.

In the D stage 402 of the period T2, the data processor performs processing 674 (decoding of the I1 instruction 659). The register mapping circuit 531 maps a register operating as a ring buffer to a physical register number on the basis of updated states of input/output pointers of the ring buffer following execution of an I2 instruction of processing 675.

An LD2 instruction is packaged without a ring buffer. A similar effect can be implemented without an LD2 instruction dedicated to a ring buffer. Thus, the number of added instructions can be reduced to reduce the basic instruction length or add other instructions. However, the four logical registers R0 to R3 are used as data buffers, i.e., the number of used logical registers is increased by two as compared with the exemplary program 1 shown in FIG. 29. Conversely, it may be possible to further reduce the number of used logical registers by packaging the LD2 instruction for simultaneously loading a plurality of data on a single logical register for reducing overhead before and after repetition processing, for effectively obtaining a high-performance data processor at a lower cost. Either approach may be determined in consideration of a trade-off as a whole when deciding an instruction set in practice.

<Exemplary Program 3: Single Precision Product-Sum Operation 3 (SIMD)>

This data processor has an SIMD operation function executing two product-sum operations with a single instruction. FIG. 37 is an explanatory diagram showing an exemplary program 3 in the assembler performing product-sum operation. In other words, the data processor executes product-sum operation with two throughputs in one clock cycle by performing SIMD operation according to the exemplary program 3 shown in FIG. 37.

While the contents of processing are identical to those of the exemplary program 1 shown in FIG. 29, it is assumed that symbol N denotes a multiple of the number 4, and C[0] and D[0] are leveled 64 bits (8 bytes). The exemplary program 3 is now described noting the points different from the exemplary programs 1 and 2 shown in FIGS. 29 and 34 respectively in particular.

Command rows 691 to 697 are preprocessing for performing block repetition, a command row 698 is a block repetition instruction, command rows 699 and 700 are repetition blocks for performing product-sum operation, and a command row 701 is a part for postprocessing after the block repetition processing.

According to an LDTCI instruction 693, the data processor sets the RBCNF bit 80 to “10”, the STM bit 81 to “0”, the WM bit 82 to “0”, the RBE0, RBE1, RBE2 and RBE3 bits 83, 85, 87 and 89 to “1” and the OPM0, OPM1, OPM2 and OPM4 bits 84, 86, 88 and 90 to “01” respectively. In other words, each of the logical registers R0 to R3 enters the ring buffer structure (see FIG. 11) consisting of four entries, for updating the corresponding output pointer by referring to the corresponding register value.

In order to perform product-sum operation processing with the maximum throughput by SIMD operation without overhead, the data processor must use 16 registers as data buffers. The data processor uses eight registers of the logical registers R0 and R1 as buffers of D[i], while using eight registers of the logical registers R2 and R3 as buffers of C[i]. The data processor repeats two instructions of processing 699 and processing 700 N/4 times in response to an REPI instruction 698. The data processor loads unnecessary data by 12 words since no redundant loading is inhibited in loop epilog processing in order to simplify the program.

An “LD2W2 Ra, Rb+” instruction (update point size +1) which is a multiple data updating instruction dedicated to the ring buffer mode is a 4-word loading instruction of the post-incremental register indirect mode for loading 4-word data from the Rb value address area of the memory, writing pairs of sets of data in Ra and R(a+1) respectively and post-incrementing the value of Rb by eight corresponding to the operand size. This instruction has the instruction format shown in FIG. 14 similarly to the LD2 instruction, with operation codes different from those of the LD2 instruction.

A “MAC2A Ad, Ra, Rb” instruction which is also a register value reference instruction for referring to data stored in the corresponding logical register is a product-sum operation instruction for multiplying the Ra and Rb values as well as R(a+1) and R(b+1) values together respectively and adding the two multiplication results to the Ad value. This instruction has the instruction format shown in FIG. 14 similarly to the MAC instruction, with operation codes different from those of the MAC instruction.

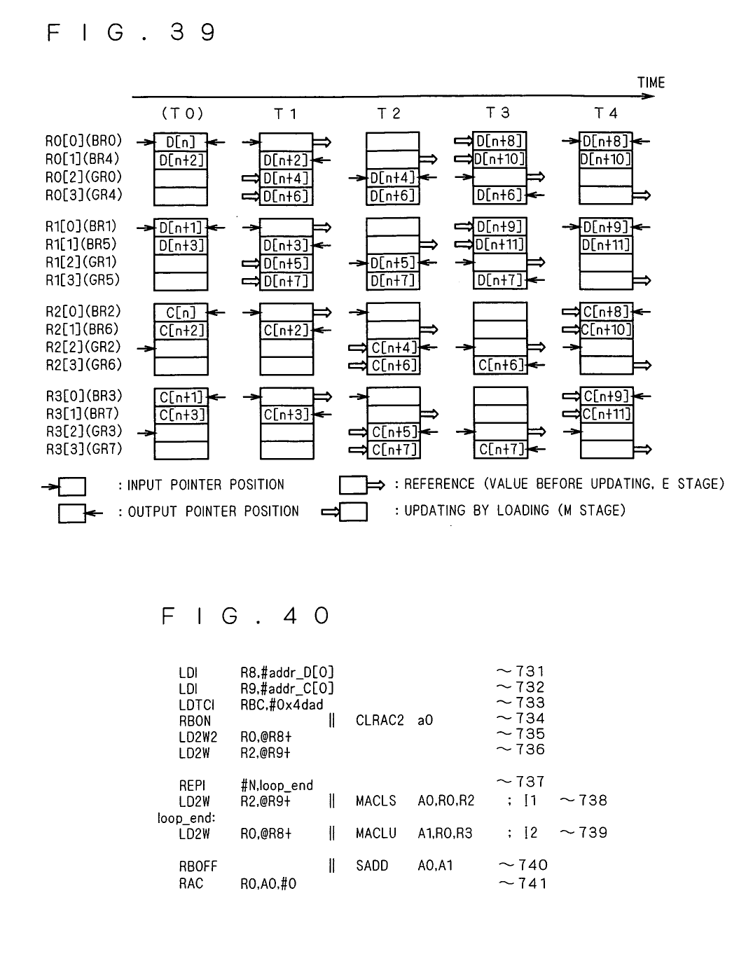

FIG. 38 is an explanatory diagram showing pipeline processing in block repetition processing in the exemplary program 3 in detail. FIG. 38 shows the details of pipeline processing in block repetition processing of instructions of the command rows 699 and 700. FIG. 39 is an explanatory diagram showing states of the ring buffers in the pipeline processing shown in FIG. 38. Operations of the pipeline processing in the exemplary program 3 are now described with reference to FIGS. 38 and 39.

FIGS. 38 and 39 show states of executing an I1 instruction 699 in the E stage 403 of a certain period T1 in the block repetition processing for multiplying D[n] and C[n] as well as D[n+1] and C[n+1] together respectively. The data processor repeats the processing every two clock cycles as instruction processing. Input/output pointers return to the same states every four clock cycles as the ring buffer operations.

In the E stage 403 of the period T1, the data processor performs processing 712 (execution of the I1 instruction 699). The first operation unit 222 outputs and updates the address of an LD2W2 instruction 699a. The first operation unit 222 outputs the value of the general-purpose register GR9 to the operand access unit 204 as the address, post-increments the same and rewrites the result in GR9. The second operation unit 223 performs multiplication of a MAC2A instruction 699b. The second operation unit 222 reads the values of D[n], C[n], D[n+1] and C[n+1] from the buffer registers BR0, BR2, BR1 and BR3 allocated as R0[0], R2[0], R1[0] and R3[0] respectively, so that the multipliers 376 and 391 perform two multiplications and write the multiplication results in the P latch 379 and the PX larch 394 respectively.

Following execution of the LD2W2 instruction 699a, the logical registers R2 and R3 load 2-word data respectively, whereby the input pointer update circuit 514 or the like increments the values of the input pointers BIP2 and BIP3 of the logical registers R2 and R3 by two respectively and updates the same to “0” in circulation.

Following execution of the MAC2A instruction 699b, further, the data processor refers to the values of the logical registers R0, R1, R2 and R3, whereby the output pointer update circuit 518 or the like increments the output pointers BOP0 to BOP3 of the logical registers R0 to R3 by one respectively and updates the same to “1”.

In the M stage 404 and the E2 stage 406 of a period T2, the data processor performs processing 716 (processing of the I1 instruction 699). In the M stage 404, the data processor writes values C[n+4], C[n+5], C[n+6] and C[n+7] in GR2, GR3, GR6 and GF7 allocated as R2[2], R3[2], R2[3] and R3[3] respectively. In the E2 stage 406, the adder 362 ternary-adds the value of the P latch 379 indicating the multiplication result in the E stage 403, the value of the PX latch 394 and the value of the accumulator A0 and rewrites the result in the accumulator A0.

In the D stage 402 of the period T1, the data processor performs processing 711 (decoding of an I2 instruction 700).

Similarly, the data processor performs processing 715 (execution of the I2 instruction 700) in the E stage 403 of the period T2, while performing processing 719 (processing of the I2 instruction 700) in the M stage 404 and the E2 stage 406 of a period T3. In the D stage 402 of the period T2, the data processor performs processing 714 (decoding of the I1 instruction 699).

In order to execute product-sum operation processing with no overhead, the data processor essentially requires 16 registers as buffers for load data. However, the ring buffers are so used that the data processor can implement processing with the four logical registers R0 to R3 used for instructions although the same physically uses 16 registers. While the data processor requires at least 18 registers including those holding addresses with 5-bit register number fields at the minimum if the same employs no ring buffers, the bit number of register number specifying fields can be reduced by employing the ring buffers, for reducing the basic instruction length.

The data processor uses eight general-purpose registers as the components of the ring buffers, whereby 16 buffer registers can be constituted by simply adding eight general-purpose registers. However, the values of the general-purpose registers GR0 to GR7 are destroyed and hence the values of GR0 to GR7 must be saved and returned before and after processing.

While eight buffer registers are added in order to reduce additional hardware according to this embodiment, the general-purpose registers GR0 to GR7 may not be used as ring buffers when 16 buffer registers are additionally packaged so that the general-purpose registers GR0 to GR7 can be used for another purpose similarly to a case where RBCNF bit is “00” or “01”. When the general-purpose registers GR0 to GR7 are not updated, the values of GR0 to GR7 may not be saved or returned before and after processing.

When adding a function of bringing each of the logical registers R0 and R1 into a ring buffer structure of eight entries, the data processor may use only two logical registers as data buffers. In this case, the data processor may be additionally packaged with a function of simultaneously performing loading on four data registers of a single logical register number and incrementing input pointers by four and a function (instruction) of referring to two data of a single logical register number, executing SIMD operation and incrementing pointers by two. The number of used logical registers can be further reduced although the data processor requires addition of the functions. When a single logical register number is used for the same series of data, fraction processing or irregular processing for unleveled addresses can advantageously be more simply implemented. Packaged functions may be decided in consideration of a trade-off between demerits of addition of functions and instructions and effects of packaging.

<Exemplary Program 4: Double Precision Product-Sum Operation 1>

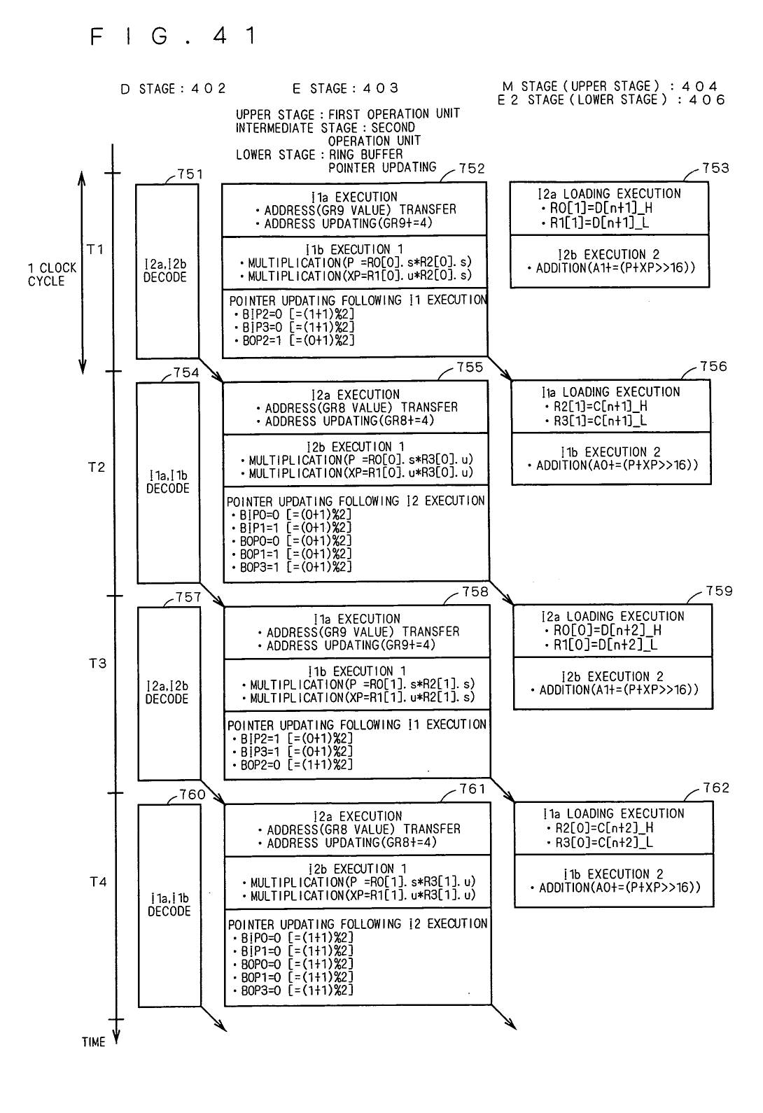

FIG. 40 is an explanatory diagram showing an exemplary program 4 for product-sum operation accompanied with multiplication of double precision. According to the exemplary program 4, the data processor performs product-sum operation accompanied with multiplication (32 by 32 bits) of double precision:
for (i=0, sum=0; i<N; ++i) sum+=C[i]*D[i];

It is assumed that C[i] and D[i] are of 32 bits (double precision) dissimilarly to the above, and C[0] and D[0] are leveled 32 bits (4 bytes). It is also assumed that the product-sum operation result (sum) is rounded to 16 bits and held at r0. According to this embodiment, the data processor is packaged with no function of processing multiplication of 32 by 32 bits with a throughput of one clock cycle but the maximum throughput of double precision product-sum operation is once/two clock cycles.

Command rows 731 to 736 are preprocessing for performing block repetition processing, a command row 737 is a block repetition instruction, command rows 738 and 739 are repetition blocks for performing product-sum operation, and command rows 740 and 741 are parts for postprocessing after the block repetition processing.

According to an LDTCI instruction 653, the data processor sets the RBCNF bit 80 to “01”, the STM bit 81 to “0”, the WM bit 82 to “0”, the RBE0, RBE1, RBE2 and RBE3 bits 83, 85, 87 and 89 to “1”, the OPM0 and OPM1 bits 84 and 86 to “10” and the OPM2 and OPM4 bits 88 and 90 to “01” respectively. In other words, each of the logical registers R0 to R3 enters the ring buffer structure (see FIG. 10) consisting of two entries, so that the logical registers R0 and R1 update the corresponding output pointers with last instructions of the repetition blocks and the logical registers R2 and R3 update the corresponding output pointers by referring to the corresponding register values. In other words, the data processor can set execution of last instructions of the repetition blocks as output pointer update conditions.

According to this embodiment, the data processor performs multiplication of 32 by 32 bits through two multiplications of 32 by 16 bits in a divided manner. In this case, the data processor refers to 32-bit side data twice. In the exemplary program 4 shown in FIG. 40, the data processor performs single 32-bit product-sum operation in the repetition blocks of the command rows 738 and 739, while referring to the D[i] side twice. Therefore, the data processor sets the OPM0 and OPM1 bits 84 and 86 to “10” for updating the output pointers of the logical registers R0 and R1 holding D[i] in the last instructions of the repetition blocks.

A CLRAC2 instruction 694b is an instruction for clearing both of the accumulators A0 and A1 to zero.

A “MACLS Ad, Ra, Rb” instruction which is also a register value reference instruction is an instruction for multiplying a 32-bit signed number holding upper 16 bits and lower 16 bits at Ra and R(a+1) respectively by a 16-bit signed number held at Rb and adding the multiplication result to the accumulator Ad. A “MACLU Ad, Ra, Rb” instruction is an instruction for multiplying a 32-bit signed number holding upper 16 bits and lower 16 bits at Ra and R(a+1) respectively by a 16-bit unsigned number held at Rb and adding the multiplication result to the accumulator Ad.

According to the exemplary program 4 shown in FIG. 40, the data processor accumulates product-sum operation results of upper 16 bits of D[i] and C[i] in the accumulator A0 while accumulating product-sum operation results of lower 16 bits of D[i] and C[i] in the accumulator A1.

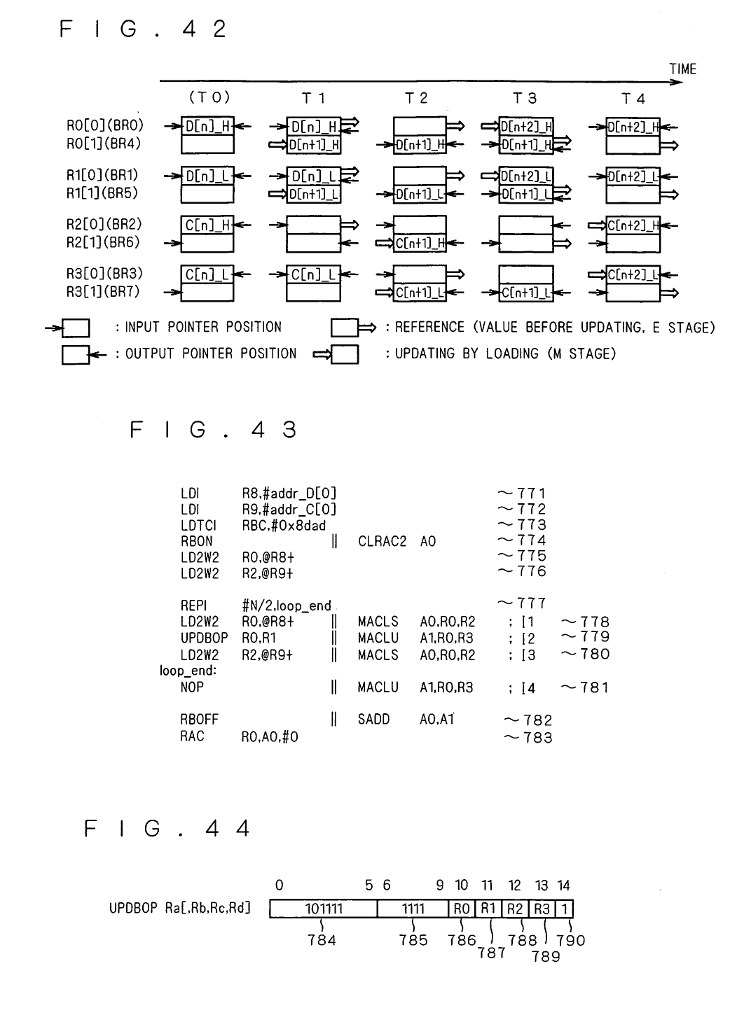

FIG. 41 is an explanatory diagram showing pipeline processing in block repetition processing of the instructions of the command rows 738 and 739. FIG. 42 is an explanatory diagram showing states of the ring buffers in the pipeline processing shown in FIG. 41. Operations of the pipeline processing in the exemplary program 4 are now described with reference to FIGS. 41 and 42.

FIGS. 41 and 42 show states of executing an I1 instruction 738 in the E stage 403 of a certain period T1 in the block repetition processing for multiplying upper 16 bits of D[n] and C[n] together. The data processor repeats the processing every two clock cycles as instruction processing. Input/output pointers return to the same states every four clock cycles as the ring buffer operations.

It is assumed that “_H” denotes upper 16 bits of 32-bit data and “_L” denotes lower 16 bits of the 32-bit data in FIGS. 41 and 42. Further, “.s” indicates handling as a signed number in multiplication, and “.u” indicates handling as an unsigned number in multiplication.

In the E stage of the period T1, the data processor performs processing 752 (execution of the I1 instruction 738). The first operation unit 222 outputs and updates the address of an LD2W instruction 738a. The second operation unit 223 performs multiplication of a MACLS instruction 738b. The data processor reads upper 16 bits of D[n] and C[n] from the buffer registers BR0 and BR2 allocated as R0[0] and R2[0] respectively, so that the multiplier 376 multiplies the same as signed numbers together and writes the multiplication result in the P latch 379.

The data processor further reads lower 16 bits of D[n] and upper 16 bits of C[n] from the buffer registers BR1 and BR2 allocated as R1[0] and R2[0] respectively, so that the multiplier 391 multiplies the values of R1[0] and R2[0] together as unsigned and signed numbers respectively and writes the multiplication result in the PX latch 394. Following execution of the LD2W instruction 738a, the logical registers R2 and R3 load 1-word data respectively, so that the input pointer update circuit 514 or the like increments the values of the input pointers BIP2 and BIP3 of the logical registers R2 and R3 by one respectively and updates the same to “0” in circulation.

Following execution of the MACLS instruction 738b, the data processor refers to the logical register R2, thereby incrementing the output pointer BOP2 of the logical register R2 by one and updating the same to “1”.

On the other hand, the data processor updates the output pointers BOP0 and BOP1 with last instructions of the repetition blocks. While the data processor also refers to the logical registers R0 and R1 following execution of the MACLS instruction 738b, BOP0 and BOP1 are not updated since the I1 instruction 738 is not a last instruction of a repetition block.

In the M stage 404 and the E2 stage 406 of a period T2, the data processor performs processing 756 (processing of the I1 instruction 738). In the M stage 404, the data processor writes the values of the upper 16 bits and the lower 16 bits of C[n+1] in the buffer registers BR6 and BR7 allocated as R2[1] and R3[1] respectively. In the E2 stage 406, the data processor adds the value of the P latch 379 indicating the multiplication result in the E stage 403 and a value obtained by shifting the value of the PX latch 394 right 16 bit positions to the value of the accumulator A0 and rewrites the result in the accumulator A0.

In the D stage 402 of the period T1, the data processor performs processing 751 (decoding of an I2 instruction 739). At this time, the data processor recognizes input/output pointers of logical registers to be decoded among the logical registers R0 to R3 updated through the processing 752.

In the E stage 403 of a period T2, the data processor performs processing 755 (execution of the I2 instruction 739). The first operation unit 222 outputs and updates the address of an LD2W instruction 739a.

The second operation unit 223 performs multiplication of a MACLU instruction 739b. The second operation unit 223 reads the upper 16 bits of D[n] and the lower 16 bits of C[n] from the buffer registers BR0 and BR3 allocated as R0[0] and R3[0] respectively, so that the multiplier 376 multiplies the values of R0[0] and R3[0] together as signed and unsigned numbers respectively and writes the multiplication result in the P latch 379. The second operation unit 223 further reads the lower 16 bits of D[n] and the lower 16 bits of C[n] from the buffer registers BR1 and BR3 allocated as R1[0] and R3[0] respectively, so that the multiplier 391 multiplies the same together as unsigned numbers respectively and writes the multiplication result in the PX latch 394. Following execution of the LD2W instruction 739a, the logical registers R0 and R1 load 1-word data respectively, so that the input pointer update circuit 514 or the like increments the values of the input pointers BIP0 and BIP1 of the logical registers R0 and R1 by one respectively and updates the same to “1”.

Following execution of the MACLU instruction 739b, further, the data processor refers to the logical register R3, whereby the output pointer update circuit 518 or the like increments the output pointer BOP3 of the logical register R3 by one and updates the same to “1”.

The data processor updates the output pointers BOP0 and BOP1 with last instructions of repetition blocks. The output pointer update circuit 518 or the like increments BOP0 and BOP1 by one respectively and updates the same to “1” since the I2 instruction 739 is a last instruction of the repetition block.

In the M stage 404 and the E2 stage 406 of a period T3, the data processor performs processing 759 (processing of the I2 instruction 739). In the M stage 404, the data processor writes the values of the upper 16 bits and the lower 16 bits of D[n+2] in the buffer registers BR0 and BR1 allocated as R0[0] and R1[0] respectively. In the E2 stage 406, the adder 362 adds the value of the P latch 379 indicating the multiplication result in the E stage 403 and a value obtained by shifting the value of the PX latch 394 right 16 bit positions to the value of the accumulator A1 and rewrites the result in the accumulator A1.

In the D stage 402 of the period T2, the data processor performs processing 754 (decoding of the I1 instruction 738). At this time, the data processor recognizes input/output pointers of logical registers to be decoded among the logical registers R0 to R3 updated through the processing 755.

Command rows 740 and 741 are parts for postprocessing after the block repetition processing. An SADD instruction 740 is an instruction for adding the value of the accumulator A0 an a value obtained by shifting the value of the accumulator A1 right 16 bit positions together and rewriting the result in the accumulator A0. An RAC instruction 741 is an instruction for rounding the value of the accumulator A0 in a 32-bit fixed point format, saturating the same to 32 bits and writing the upper 16 bits and the lower 16 bits in the logical registers R0 (GR0) and R1 (GR1) respectively.

While the data processor updates the output pointers of the logical registers R2 and R3 by referring to the register values according to the aforementioned exemplary program 4, the output pointers may alternatively be updated with last instructions of repetition blocks since only the update timing for BOP2 changes in this case and the processing contents remain unchanged. The data processor may employ either setting.

According to the aforementioned exemplary program 4, the data processor updates the output pointers with last instructions of repetition blocks, so that the ring buffers effectively act also on data referred to a plurality of times in the loop. The data processor can also execute loading for next loop processing during multiple reference to the same data. The data processor frequently refers to the same data a plurality of times in a case of IIR filter processing or FFT complex operation other than double precision operation depending on the processing contents of the program, and such control is effective. The data processor automatically updating the output pointers with last instructions of repetition blocks may not separately have instructions for updating and not updating output pointers but can reduce the number of packaged instructions. The data processor may not explicitly update the output pointers with an output pointer update instruction either, to cause no overhead of the code size or the cycle number.

In order to form a loop with a condition branch instruction, generally employed is a structure of performing updating and end condition determination of a counter value in the loop and branching to the head of the loop in loop processing continuation according to the condition branch instruction at the final stage of a repetition block constituting the loop. While the data processor updates the pointers with the last instructions of the repetition blocks according to the exemplary program 4, the OPMi bits 84, 86, 88 and 90 may be set to “11” for automatically updating the output pointers of registers operating as ring buffers in branch instruction execution when implementing the loop with the branch instruction. In other words, execution of the branch instruction can be set as the condition for output pointer updating.

Also in this case, the data processor implicitly updates the output pointers without explicitly specifying pointer updating with executed instructions, for attaining a similar effect without causing overhead of the code size or the cycle number. However, it may be unadaptive if the data processor performs calls a condition branch instruction or a subroutine in the repetition processing. While the data processor is packaged with the block repetition instruction according to this embodiment, it is extremely effective when the same is packaged with no block repetition instruction.

When the data processor is packaged with only a single-level block repetition function and performing multiple loop processing for implementing a loop with a condition branch instruction in a loop higher by one by employing the block repetition instruction for the innermost loop, updating of the output pointers can be controlled in the outer loop and pointer updating responsive to usage is effectively enabled every variable. When packaged with a loop primitive instruction (high-functional condition branch instruction for decrementing a counter, determining a count or performing condition branch), the data processor may update the pointers following execution of the loop primitive instruction.

Further, the output pointer update mode can be arbitrarily set every logical register number, whereby optimum setting can be performed in response to the usage of the variable allocated to each logical register and overhead of the code size or the cycle number can be reduced. While the data processor according to this embodiment separately allocates the functions of “10” and “11” in the OPMi bits 84, 86, 88 and 90, the mode may alternatively be allocated to update the output pointers when either one of the both takes place at the same set value, in order to reduce the number of set fields.

While the data processor according to this embodiment is packaged with the function of implicitly updating the output pointers in execution of the last instructions of the repetition blocks and the branch instruction, a function of setting the address of an instruction for pointer updating and comparing a PC value of an executed instruction and a set address with each other may alternatively be set for updating the output pointers when executing an instruction coinciding with the set address. While the hardware quantity is slightly increased and addressed overhead takes place as the program in this case, the data processor performs implicit updating in the repetition processing without explicitly specifying output pointer updating during the repetition processing, to cause no overhead in the repetition processing. While a case of updating the output pointers upon termination of the processing unit of the repetition processing has the highest frequency, the loop may alternatively be formed in a plurality of basic processing units. The data processor can also cope with this case.

Setting of the OPMi bits 84,86, 88 and 90 to “10” is effective not only in the case of block repetition but also in single set repetition processing. An effect may be attained when the data processor requires a plurality of cycles for executing a single instruction or the like, depending on a packaged instruction set. Single instruction repetition of sequentially executed two instructions is also possible as in this embodiment, and the upper limit of the levels to which the data processor is directed may be decided in consideration of various trade-offs.

<Exemplary Program 5: Double Precision Product-Sum Operation 2 (64-Bit Loading)>

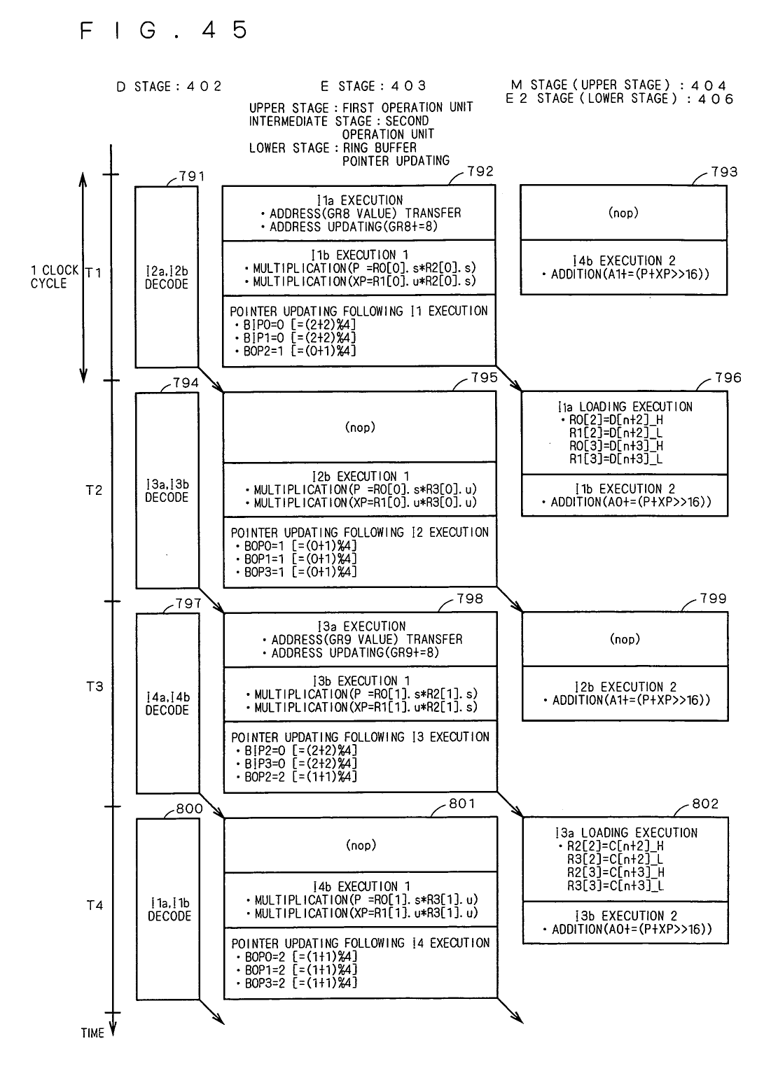

FIG. 43 is an explanatory diagram showing an exemplary program 5 for performing product-sum operation accompanied with multiplication of double precision. It may generally be possible to reduce power consumption by making the best use of a bus width and reducing a memory access number, depending on the function and the structure of the corresponding memory. FIG. 43 shows an example of performing programming with a 64-bit loading instruction. Object processing contents are identical to those of the exemplary program 4 shown in FIG. 40. However, it is assumed that C[0] and D[0] are leveled 64 bits. It is also assumed that N denotes an even number.

Command rows 771 to 776 are preprocessing for performing block repetition processing, a command row 777 is a block repetition instruction, command rows 778 to 781 are repetition blocks for performing product-sum operation, and command rows 782 and 783 are parts for postprocessing after the block repetition processing.

According to an LDTCI instruction 773, the data processor sets the RBCNF bit 80 to “10”, the STM bit 81 to “0”, the WM bit 82 to “0”, the RBE0, RBE1, RBE2 and RBE3 bits 83, 85, 87 and 89 to “1”, the OPM0 and OPM1 bits 84 and 86 to “10” and the OPM2 and OPM4 bits 88 and 90 to “01” respectively. In other words, each of the logical registers R0 to R3 enters the ring buffer structure consisting of four entries, while the logical registers R0 and R1 update the corresponding output pointers with last instructions of repetition blocks and the logical registers R2 and R3 update the corresponding output pointers with reference to the corresponding register values. Every output pointer can be explicitly updated with an output pointer update instruction. While the throughput of operation remains unchanged, the number of simultaneously loaded data is so increased that the number of necessary registers is increased as compared with the exemplary program 4 shown in FIG. 40.

FIG. 44 is an explanatory diagram showing bit allocation of an output pointer update instruction (UPDBOP) for the corresponding ring buffer. Fields 784, 785 and 790 are operation code fields, and fields 786 to 789 are bits indicating pointer updating of the logical registers R0 to R3 respectively, for incrementing the corresponding pointers by one when the same are “1”.

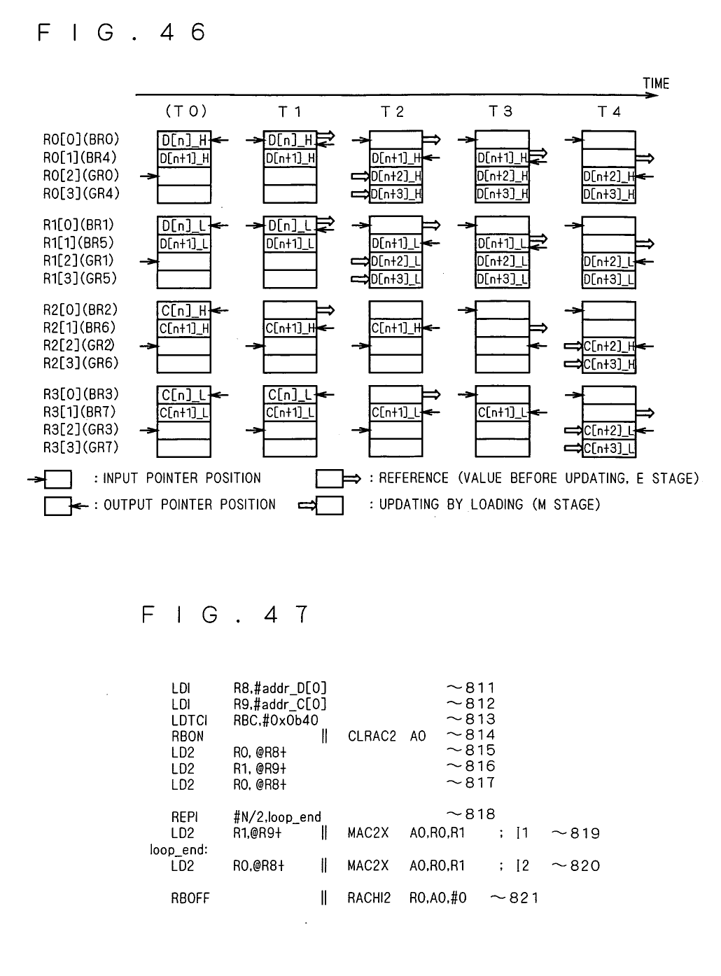

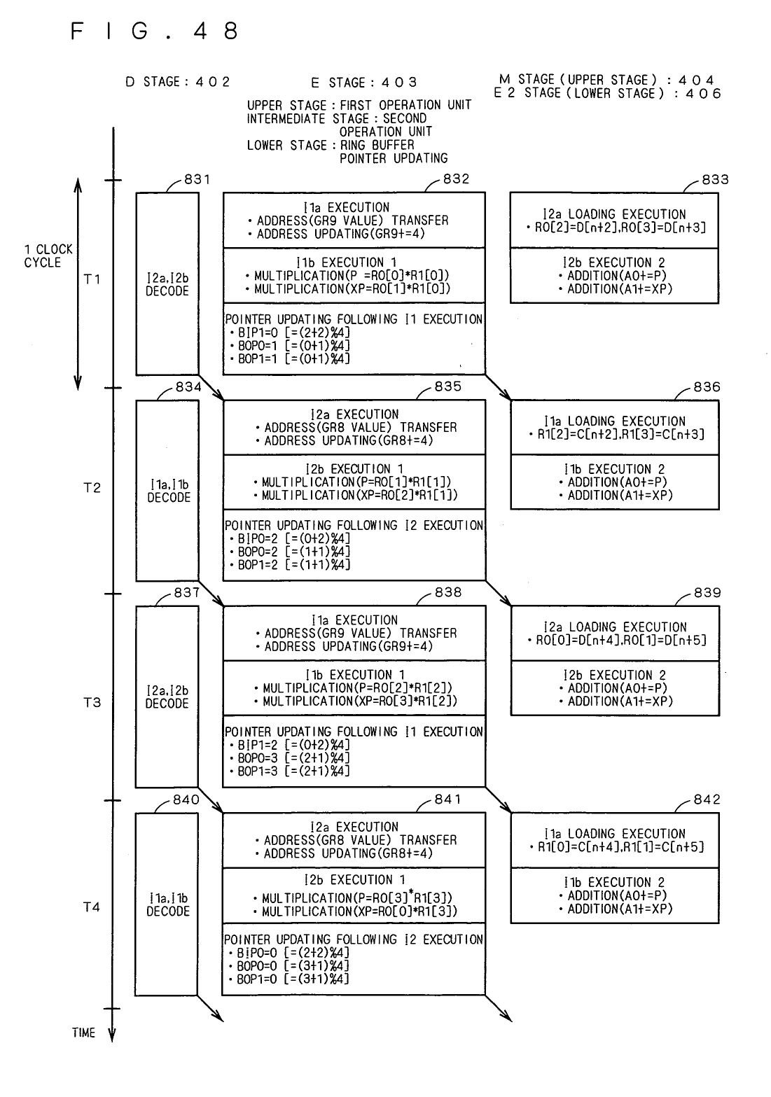

FIG. 45 is a block diagram showing pipeline processing in block repetition processing of the instructions of the command rows 778 to 781. FIG. 46 is an explanatory diagrams showing states of the ring buffers in the pipeline processing shown in FIG. 45. Pipeline operations in the exemplary program 5 are now described with reference to FIGS. 45 and 46.

FIGS. 45 and 46 show states of processing in a case of executing an I1 instruction 778 in the E stage 403 of a certain period T1 in the block repetition processing for multiplying upper 16 bits of D[n] and C[n] together. The data processor repeats the processing every four clock cycles as the instruction processing. Input/output pointers return to the same states every eight clock cycles as the ring buffer operations.

In the E stage 403 of the period T1, the data processor performs processing 792 (execution of the I1 instruction 778). The first operation unit 222 outputs and updates the address of an LD2W2 instruction 778a.

The second operation unit 223 performs multiplication of a MACLS instruction 778b. The second operation unit 223 reads upper 16 bits of D[n] and upper 16 bits of C[n] from the buffer registers BR0 and BR2 allocated as R0[0] and R2[0] respectively, so that the multiplier 376 performs multiplication and writes the multiplication result in the P latch 379. The second operation unit 223 further reads lower 16 bits of D[n] and upper 16 bits of C[n] from the buffer registers BR1 and BR2 allocated as R1[0] and R2[0] respectively, so that the multiplier 391 performs multiplication and writes the multiplication result in the PX latch 394.

Following execution of the LD2W2 instruction 778a, the logical registers R0 and R1 load 2-word data respectively, so that the input pointer update circuit 514 or the like increments the values of the input pointers BIP0 and BIP1 of the logical registers R0 and R1 by two respectively and updates the same to “0” in circulation.

Following execution of the MACLS instruction 778b, the data processor refers to the logical register R2, so that the output pointer update circuit 518 or the like increments the output pointer BOP2 of the logical register R2 by one and updates the same to “1”.

While the data processor updates the output pointers BOP0 and BOP1 with last instructions of the repetition blocks, on the other hand, the output pointers BOP0 and BOP1 are not updated since the I1 instruction 778 is not a last instruction of a repetition block.

In the M stage 404 and the E2 stage 406 of a period T2, the data processor performs processing 796 (processing of the I1 instruction 778). In the M stage 404, the data processor writes the values of upper 16 bits of D[n+2], lower 16 bits of D[n+2], upper 16 bits of D[n+3] and lower 16 bits of D[n+3] in GR0, GR1, GR4 and GR5 allocated as R0[2], R1[2], R0[3] and R1[3] respectively. In the E2 stage 406, the adder 62 adds the value of the P latch 379 indicating the multiplication result in the E stage 403 and a value obtained by shifting the value of the PX latch 394 right 16 bit positions to the value of the accumulator A0 and rewrites the result in the accumulator A0.

In the D stage 402 of the period T1, the data processor performs processing 791 (decoding of an I2 instruction 779). At this time, the data processor recognizes the input/output registers of logical registers to be decoded among the logical registers R0 to R3 updated through the processing 792.

In the E stage 403 of the period T2, the data processor performs processing 795 (execution of the I2 instruction 779). The data processor performs only pointer updating with no operation processing or the like in response to an UPDOBP instruction, and hence the first operation unit 222 performs no valid operation. The second operation unit 223 performs multiplication of a MACLU instruction 779b. The second operation unit 223 reds upper 16 bits of D[n] and lower 16 bits of C[n] from the buffer registers BR0 and BR3 allocated as R0[0] and R3[0] respectively, so that the multiplier 376 performs multiplication and writes the multiplication result in the P latch 379. The second operation unit 223 further reads lower 16 bits of D[n] and lower 16 bits of C[n] from the buffer registers BR1 and BR3 allocated as R1[0] and R3[0] respectively, so that the multiplier 391 performs multiplication and writes the multiplication result in the PX latch 394.

Following execution of the MACLU instruction 779b, the data processor refers to the logical register R3, so that the output pointer update circuit 518 or the like increments the output pointer BOP3 of R3 by one and updates the same to “1”. The data processor updates the output pointers BOP0 and BOP1 with last instructions of repetition blocks. While the I2 instruction 779 is not a last instruction of a repetition block, the data processor updates the output pointers of the logical registers R0 and R1 by executing an UPDBOP instruction 779a. Therefore, the output pointer update circuit 518 or the like increments the output pointers BOP0 and BOP1 by one respectively and updates the same to “1”.

In the E stage 406 of a period T3, the data processor performs processing 799 (processing of the I2 instruction 779). In the E2 stage 406, the adder 362 adds the value of the P latch 379 indicating the multiplication result in the E stage 403 and a value obtained by shifting the value of the PX latch 394 right 16 bit positions to the value of the accumulator A1 and rewrites the result in A1. In the M stage 404, the data processor performs no valid operation.

In the D stage 402 of the period T2, the data processor performs processing 794 (decoding of the I1 instruction 778). At this time, the data processor recognizes the input/output pointers of logical registers to be decoded among the logical registers R0 to R3 updated through the processing 795.

In the E stage 403 of the period T3, the data processor performs processing 798 (execution of an I3 instruction 780). The first operation unit 222 outputs and updates the address of an LD2W2 instruction 780a. The second operation unit 223 performs two multiplications similarly to the processing 792. Following execution of the LD2W2 instruction 780a, the logical registers R2 and R3 load 2-word data respectively, so that the input pointer update circuit 514 or the like increments the values of the input pointers BIP2 and BIP3 of the logical registers R2 and R3 by two respectively and updates the same to “0” in circulation. Following execution of a MACLS instruction 780b, further, the data processor refers to the logical register R2, so that the output pointer update circuit 518 or the like increments the output pointer BOP2 of the logical register R2 by one and updates the same to “1”.

While the data processor updates the output pointers BOP0 and BOP1 with last instructions of the repetition blocks, on the other hand, the output pointers BOP0 and BOP1 are not updated since the I3 instruction 780 is not a last instruction of a repetition block.

In the M stage 404 and the E2 stage 406 of a period T4, the data processor performs processing 802 (processing of the I1 instruction 780). In the M stage 404, the data processor writes the values of upper 16 bits of C[n+2], lower 16 bits of C[n+2], upper 16 bits of C[n+3] and lower 16 bits of C[n+3] in the general-purpose registers GR2, GR3, GR6 and GR7 allocated as R2[2], R3[2], R2[3] and R3[3] respectively.

In the E stage 403 of the period T4, the data processor performs processing 801 (execution of an I4 instruction 781). A NOP instruction is a no operation instruction, and the first operation unit 222 performs no valid operation. The second operation unit 223 performs two multiplications similarly to the processing 795. Following execution of a MACLU instruction 781b, the data processor refers to the logical register R3, so that the output pointer update circuit 518 or the like increments the output pointer BOP3 of the logical register R3 by one and updates the same to “1”.

On the other hand, the data processor updates the output pointers BOP0 and BOP1 with last instructions of repetition blocks. Since the I4 instruction 781 is a last instruction of a repetition block, the output pointer update circuit 518 or the like increments the output pointers BOP0 and BOP1 by one respectively and updates the same to “1”.

While the data processor updates the output pointers of the logical registers R2 and R2 with reference to the register values in the aforementioned exemplary program 5, only the update timing for the output pointer BOP2 changes and the processing contents as well as the processing cycle number remain unchanged when alternatively updating the output pointers with last instructions of repetition blocks. However, the data processor must update the output pointers of the logical registers R2 and R3 with the UPDBOP instruction 779a.

The data processor performs no valid processing through the NOP instruction 781a, whereby the processing contents as well as the processing cycle number remain unchanged when the data processor executes an output pointer update instruction UPDBOP as the processing 781a in a mode of updating pointers only through instructions (OPMi bit=“00”).

When the data processor is packaged with a function of explicitly switching output pointers with the output pointer update instruction UPDBOP as in the aforementioned exemplary program 5, it is possible to update an output pointer on an arbitrary position in a repetition block depending on the advantage of program processing with respect to a register holding a value referred to a plurality of times in the corresponding repetition block. It is effective in a case of integrating a plurality of repetition units for reducing the number of processing cycles or reducing power consumption. However, the processing cycle/code size may cause overhead for pointer updating depending on the program.

Since the data processor can perform pointer updating without executing the UPDBOP instruction in a last instruction of a repetition block by validating updating through the UPDBOP instruction in setting of updating any pointer through the last instruction of the repetition block, whereby it may be possible to reduce overhead by executing the UPDBOP instruction.

According to this exemplary processing, it is effective so far as the data processor has a function of collectively updating all pointers without employing a function of updating the output pointer in unit of register. In other words, it is generally effective to package only an instruction function of collectively updating all pointers. However, it may be more effective to render the pointers individually updatable depending on the usage of variables allocated to registers operating in the ring buffer mode.

According to this embodiment, it is not necessary to specify a pointer update size since pointer updating is limited to only +1. When the data processor may update any pointer by at least two by simultaneously reading a plurality of data from a single logical register in a case of packaging an SIMD operation function or the like, however, the pointer update size may also be rendered specifiable through an output pointer update instruction.

<Exemplary Program 6: Single Precision Product-Sum Operation 4 (2-Sample Simultaneous Processing)>

FIG. 47 is an explanatory diagram showing an exemplary program 6 for simultaneously processing two samples in single precision product-sum operation. According to the exemplary program 6, the data processor performs the following processing:
for (i=0, sum1=0, sum2=0; i<N; ++i){
sum1+=C[i]*D[i];
sum2+=C[i]*D[I+1];

It is assumed that N represents a multiple of the number 2. It is also assumed that C[i] and D[i] are sequentially arranged on the built-in data memory in order of i in an address incremental direction, and C[O] and D[O] are leveled 32 bits (4 bytes). It is further assumed that the product-sum operation results (sum1 and sum2) are rounded to 16 bits and held at r0 and r1 respectively.

When taking autocorrelation or performing FIR filter processing of a single sample, a data access number can be halved for reducing power consumption by simultaneously processing two samples. While processing must be optimized in consideration of leveling of memory data in order to improve the processing throughput in single sample processing, leveling may not be taken into consideration by simultaneously processing two samples. According to this exemplary program 6, no case of non-leveling of 32 bits may be taken into consideration.

Command rows 811 to 817 are preprocessing for performing block repetition processing, a command row 818 is a block repetition instruction, command rows 819 and 820 are repetition blocks for performing product-sum operation, and a command row 821 is a part for postprocessing after the block repetition processing.

The data processor initializes the control register CR4 (RBC) through an LDTCI instruction 813. According to this instruction, the data processor sets the RBCNF bit 80 to “00”, the STM bit 81 to “0”, the WM bit 82 to “0”, the RBE0 and RBE1 bits 83 and 85 to “1” and the OPM0 and OPM1 bits 84 and 86 to “01” respectively. In other words, each of the logical registers R0 and R1 enters the ring buffer structure (see FIG. 9) consisting of four entries, for updating the corresponding output pointer with reference to the corresponding register value.

The data processor uses four registers of the logical register R0 and four registers of the logical register R1 as buffers of D[i] and C[i] respectively. The data processor repeats two instructions of the command rows 819 and 820 N/2 times through an REPI instruction 818. The data processor loads unnecessary data by five words since no redundant loading is inhibited in loop epilog processing in order to simplify the program.

A “MAC2X Ad, Ra, Rb” instruction is a specific SIMD product-sum operation instruction for simultaneously processing two samples. The data processor multiplies the Ra and Rb values together and adds the multiplication result to the Ad value. The data processor further multiplies a value of an entry indicated by “(output pointer value +1)%4” of Ra and the Rb value together and adds the multiplication result to an A(d+1) value. While referring to two data as to Ra, the data processor updates the corresponding output pointer by “+1”.

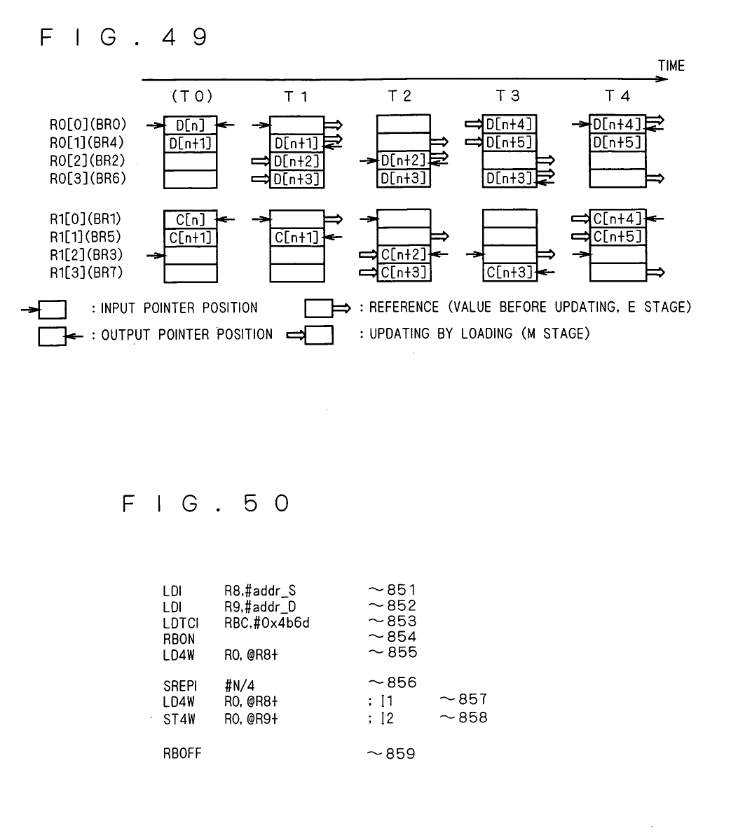

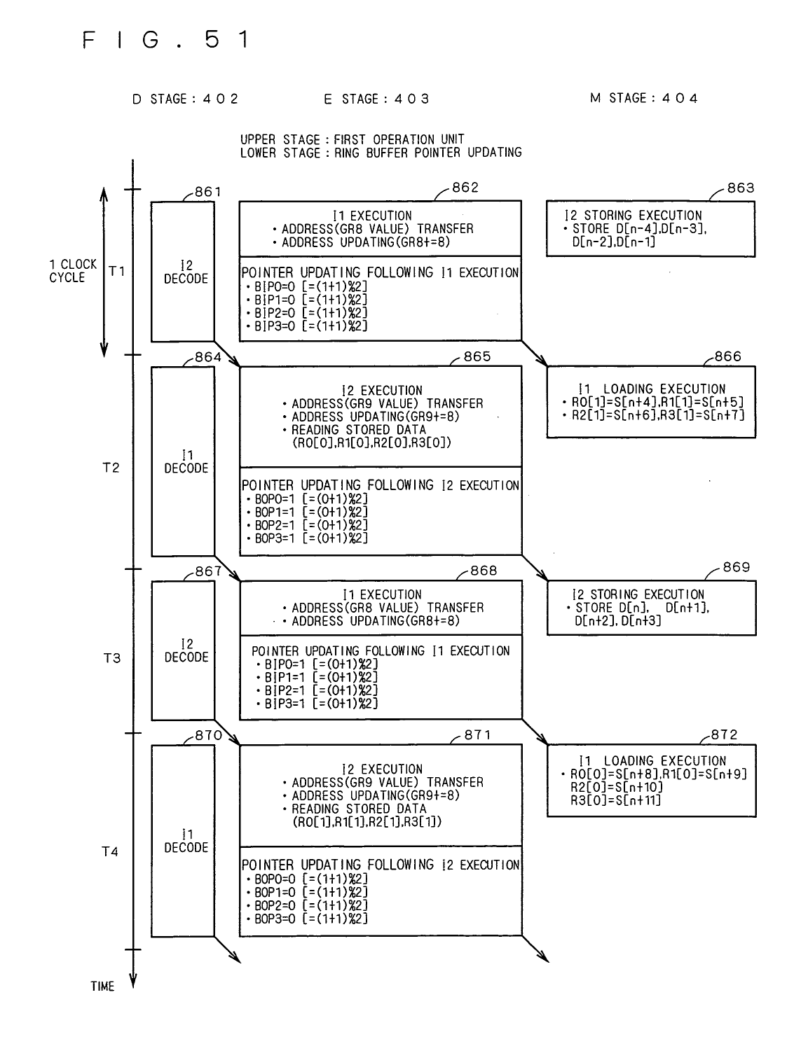

FIG. 48 is an explanatory diagram showing pipeline processing in block repetition processing of the instructions of the command rows 819 and 820 in detail. FIG. 49 is an explanatory diagram showing states of the ring buffers in the pipeline processing shown in FIG. 48. Pipeline operations in the exemplary program 6 are now described with reference to FIGS. 48 and 49.

FIGS. 48 and 49 show states of executing an I1 instruction 819 in the E stage 403 of a certain period T1 in the block repetition processing for multiplying D[n] and C[n] as well as D[n+1] and C[n] together respectively. The data processor repeats the processing every two clock cycles as instruction processing. Input/output pointers return to the same states every four clock cycles as the ring buffer operations.

In the E stage 403 of the period T1, the data processor performs processing 832 (execution of the I1 instruction 819). The first operation unit 222 outputs and updates the address of an LD2 instruction 819a. The second operation unit 223 performs multiplication of a MAC2X instruction 819b. The second operation unit 223 reads the values of D[n], D[n+1] and C[n] from the buffer registers BR0, BR4 and BR1 allocated as R0[0], R0[1] and R1[0] respectively, so that the multipliers 376 and 391 perform two multiplications of “D[n]*C[n]” and “D[n+1]*C[n]” respectively and write the multiplication results in the P latch 379 and the PX latch 394 respectively. While the output pointer value of the logical register R0 is “0”, the data processor refers to the logical register R0[(BOP0+1)%4] thereby referring to D[n+1].

Following execution of the LD2 instruction 819a, the logical register R1 loads 2-word data, so that the input pointer update circuit 514 or the like increments the value of the input pointer BIP1 of the logical register R1 by two and updates the same to “0” in circulation.

Following execution of a MAC2X instruction 819b, the data processor refers to the values of the logical registers R0 and R1, so that the output pointer update circuit 518 or the like increments the output pointers BOP0 and BOP1 of the logical registers R0 and R1 by one respectively and updates the same to “1”. While the data processor refers to the two values R0[0] and R0[1] in relation to the logical register R0, the output pointers are updated by only “+1”.

In the M stage 404 and the E2 stage 406 of a period T2, the data processor performs processing 833 (processing of the I1 instruction 819). In the M stage 404, the data processor writes values C[n+2] and C[n+3] in the buffer registers BR3 and BR7 allocated as R1[2] and R1[3] respectively. In the E2 stage 406, the data processor performs addition processing of the multiplication result in the E stage 403. The adder 362 adds the values of the P latch 379 and the accumulator A0 together, and rewrites the result in the accumulator A0. The adder 395 adds the values of the PX latch 394 and the accumulator A1 together, and rewrites the result in A1.

In the D stage 402 of the period T1, the data processor performs processing 831 (decoding of an I2 instruction 820). At this time, the data processor recognizes the input/output pointers of logical registers R0 to R3 updated through the processing 832.

In the E stage 403 of the period T2, the data processor performs processing 835 (execution of an I2 instruction 820), and in the M stage 404 and the E2 stage 406 of a period T3, the data processor performs processing 839 (processing of the I2 instruction 820). In the D stage 402 of the period T2, the data processor performs processing 834 (decoding of the I1 instruction 819).

Thus, a function for performing slightly irregular data reference and pointer updating is so added that the data processor can easily implement two-sample simultaneous processing related to single sample processing employing ring buffers. The data processor processes two samples with a set of data loading, whereby the memory access number can be reduced. The data processor refers to the same coefficient (C[i]) twice in the same cycle, while referring to the same data (D[i+1]) twice along with the next cycle. Further, the data processor may perform processing as to data in a state leveled 32 bits also when performing processing corresponding to a single sample, whereby programming can be performed without taking a 32-bit unleveled state into consideration but the program can be simplified. When performing processing sample by sample, the data processor must perform processing varied with a case of 32-bit leveling and a case of 32-bit unleveling in relation to data.

Also when processing a plurality of data of at least two samples, a similar technique is applicable although hardware control is complicated.

<Exemplary Program 7: Memory-to-Memory Transfer>

FIG. 50 is an explanatory diagram showing an exemplary program 7 for performing memory-to-memory transfer. According to the exemplary program 7, the data processor performs the following processing in C language notation:
for (i=0; i<N; ++i) D[i]=S[i];

According to the exemplary program 7, the data processor transfers S[i] to D[i] by N words. It is assumed that i represents 0 to (N−1), S[i] and D[i] denote 16-bit data, addresses of S[0] and D[0] are leveled 64 bits, and N represents a multiple of the number 4.

This data processor can read/write 64-bit data of the built-in data memory in one clock cycle. Therefore, the data processor can implement memory-to-memory transfer with a throughput of 32 bits in one clock cycle.

Command rows 851 to 855 are preprocessing for performing repetition processing, a command row 856 is a single step repetition instruction, command rows 857 and 858 are repetition object instructions, and a command row 859 is a part for postprocessing after the repetition processing. When an instruction subsequent to an instruction SREPI is a short instruction, two continuous short instructions are to be repeated. Referring to FIG. 50, both instructions of the command rows 857 and 858 are short instructions, which are to be repeated.

According to an LDTCI instruction 853, the data processor sets the RBCNF bit 80 to “01”, the STM bit 81 to “0”, the WM bit 82 to “0”, the RBE0, RBE1, RBE2 and RBE3 bits 83, 85, 87 and 89 to “1” and the OPM0, OPM1, OPM2 and OPM3 bits 84, 86, 88 and 90 to “01” respectively. In other words, each of the logical registers R0 to R3 enters the ring buffer structure (see FIG. 10) consisting of two entries, for updating the corresponding output pointer with reference to the corresponding register value.

An “LD4W Ra, Rb+” instruction (update pointer size +1) is a 4-word loading instruction of the post-incremental register indirect mode for loading 4-word data from a memory area specified by the address of the Rb value, writing the data in Ra, R(a+1), R(a+2) and R(a+3) and post-incrementing the Rb value by eight corresponding to the operand size.

An “ST4W Ra, Rb+” instruction which is a storing instruction (memory storing instruction) is a 4-word store instruction of the post-incremental register indirect mode for storing the values Ra, R(a+1), R(a+2) and R(a+3) in the memory area specified by the address of the Rb value and post-incrementing the Rb value by eight corresponding to the operand size.

Both of the 4-word loading instruction and the 4-word store instruction of the register indirect mode are instructions of a short format, and form a single 32-bit instruction as two sequentially executed subinstructions. The data processor repetitively executes the 4-word loading instruction and the 4-word store instruction by single step repetition.

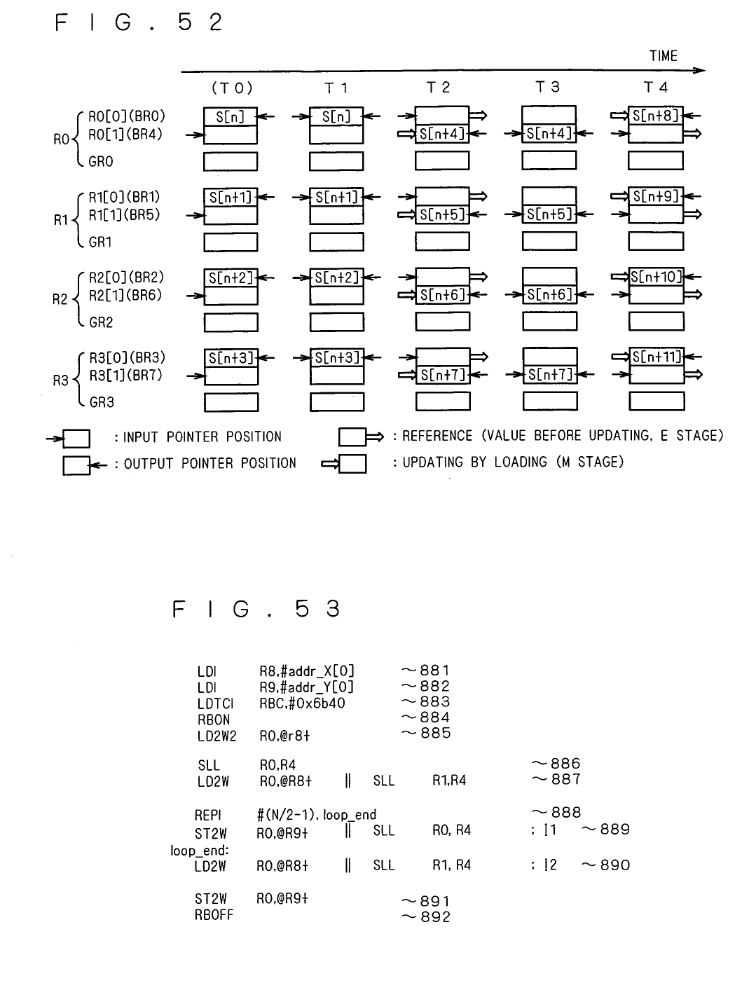

FIG. 51 is an explanatory diagram showing pipeline processing in repetition processing of instructions of the command rows 857 and 858. FIG. 52 is an explanatory diagram showing current states of the ring buffers. Pipeline operations in the exemplary program 7 are now described with reference to FIGS. 51 and 52.

FIGS. 51 and 52 show states of executing an I1 instruction 857 in the E stage 403 of a certain period T1 in the block repetition processing for processing loading instructions of S[n+4] to S[n+7]. The data processor repeats the processing every two clock cycles as instruction processing. Input/output pointers return to the same states every four clock cycles as the ring buffer operations.

In the E stage 403 of the period T1, the data processor performs processing 862 (execution of the I1 instruction 857). The first operation unit 222 outputs and updates the address of an LD4W instruction 857. The first operation unit 222 outputs the value of the general-purpose register GR8 to the operand access unit 204 as the address, post-increments the same and rewrites the result in the general-purpose register GR8. The second operation unit 223 performs no valid processing. Following execution of the LD4W instruction 857, the logical registers R0 to R3 load 1-word data respectively, so that the input update circuit 514 or the like increments the values of the four input pointers BIP0 to BIP3 by one respectively and updates the same to “0” in circulation.

In the M stage 404 of a period T2, the data processor performs processing 866 (processing of the I1 instruction 857). In the M stage 404, the data processor reads values S[n+4], S[n+5], S[n+6] and S[n+7] from the memory and writes the same in the buffer registers BR4, BR5, BR6 and BR7 allocated as R0[1], R1[1], R2[1] and R3[1] respectively.

In the D stage 402 of the period T1, the data processor performs processing 861 (decoding of an I2 instruction 858). At this time, the data processor recognizes the input pointers of the logical registers R0 to R3 updated through the processing 862.

In the E stage 403 of the period T2, the data processor performs processing 865 (execution of the I2 instruction 858). The first operation unit 222 outputs and updates the address of an ST4W instruction 858, and read stored data. The data processor outputs the value of the general-purpose register GR9 to the operand access unit 204 as the address, post-increments the same and rewrites the result in the general-purpose register GR9. The data processor reads the values S[n], S[n+1], S[n+2] and S[n+3] held in the buffer registers BR0, BR1, BR2 and BR3 allocated as R0[0], R1[0], R2[0] and R3[0] respectively as stored data. The second operation unit 223 performs no valid processing. Following execution of the ST4W instruction 858, the data processor refers to the values of the logical registers R0 to R3 as stored data, so that the output pointer update circuit 518 or the like increments the values of the four output pointers BOP0 to BOP3 by one respectively and updates the same to “1”.

In the M stage 404 of a period T3, the data processor performs processing 869 (processing of the I2 instruction 858). In the M stage 404, the data processor outputs the values S[n], S[n+1], S[n+2] and S[n+3] read from R0[0], R1[0], R2[0] and R3[0] in the E stage 403 to the operand access unit 204, and stores the same in the memory.

In the D stage 402 of the period T2, the data processor performs processing 864 (decoding of the I1 instruction 857). At this time, the data processor recognizes the output pointers of the logical registers R0 to R3 updated through the processing 865.

Thus, the data processor implements efficient memory-to-memory transfer with a small number of logical registers by referring to the values of the ring buffers as stored data.

While the data processor uses four logical register numbers in this exemplary program 7, it is possible to reduce the number of used logical registers when comprising a function of loading a plurality of data in a plurality of registers having a single logical register number, referring to and storing the plurality of data of the single logical register number and updating output pointers by the number of the data as referred to. When eight physical registers are packaged to a single logical register number as ring buffers, for example, the data processor can use only one logical register number for data buffers. It is possible to further reduce the number of used logical registers by adding this function, although control is slightly complicated. There is also a selection of two logical registers, as a matter of course.

<Exemplary Program 8: Block Floating of Array Data>

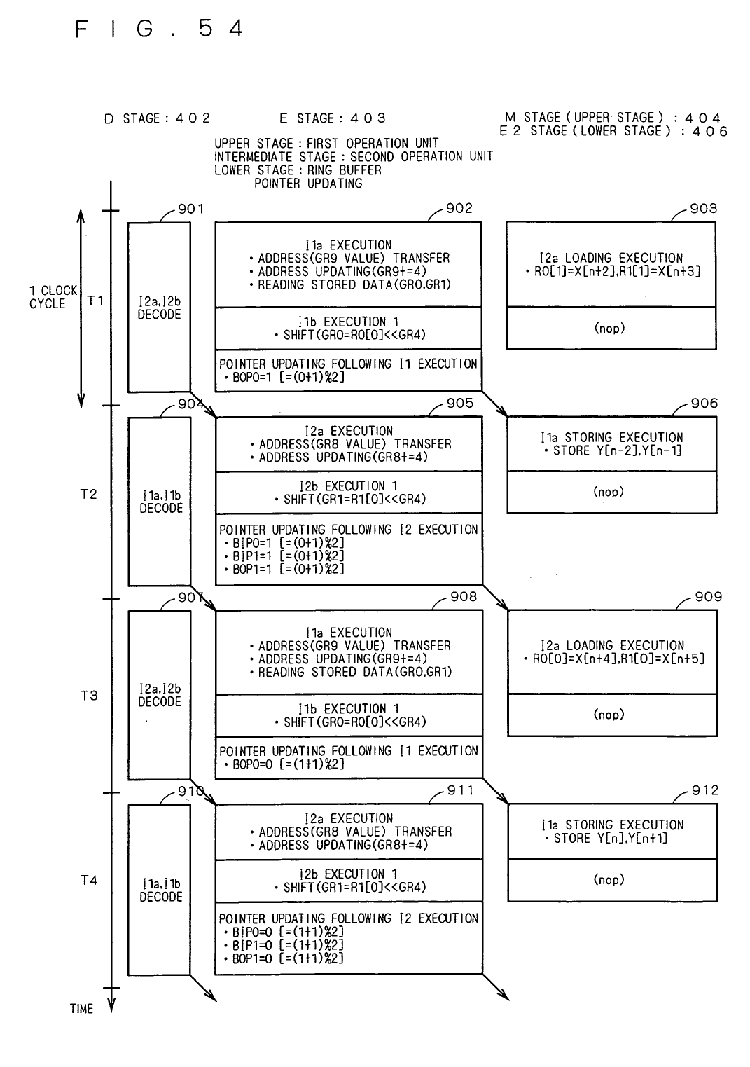

FIG. 53 is an explanatory diagram showing an exemplary program 8 for shifting array data. According to the exemplary program 8, the data processor performs the following processing in C language notation:
for (i=0; i<N; ++i) Y[i]=X[i]<<shit_count;

The data processor performs processing of shifting X[i] left the number of bits specified by the logical register R4 and rewriting the result as Y[i]. It is assumed that i represents 0 to (N−1), X[i] denotes 16-bit data, the addresses of X[0] and Y[0] are leveled 32 bits, and N represents a multiple of the number 2. Before running the program shown in FIG. 53, the data processor sets a shift count (shift_count) in the logical register R4.

This data processor packaged with only one shifter shifts single data with one throughput in one clock in repetition processing.

Command rows 881 to 887 are preprocessing for performing repetition processing, a command row 888 is a block repetition instruction, command rows 889 and 890 are block repetition object instructions, and command rows 891 and 892 are parts for postprocessing after the repetition processing.

According to an LDTCI instruction 883, the data processor sets the RBCNF bit 80 to “01”, the STM bit 81 to “1”, the WM bit 82 to “0”, the RBE0 and RBE1 bits 83 and 85 to “1” and the OPM0 and OPM1 bits 84 and 86 to “01” respectively. In other words, each of the logical registers R0 and R1 enters the ring buffer structure consisting of two entries, for updating the corresponding output pointer with reference to the corresponding register value. The data processor updates the register values of the general-purpose registers by executing instructions other than a loading instruction. In storing the values of the logical registers R0 and R1 according to a store instruction, the data processor reads stored data not from the buffer registers but from the general-purpose registers. The logical registers R2 and R3 operate in a normal general-purpose register mode due to the RBE2 and RB3 bits 87 and 89 of “0”.

An “SLL Ra, Rb” instruction is a shift instruction for shifting the Ra value left the quantity specified by Rb and rewriting the shift result in Ra. An “ST2W Ra, Rb+” instruction which is a storing instruction (memory storing instruction) is a 2-word store instruction of the post-incremental register indirect mode for storing the values Ra and R(a+1) in the memory area specified by the address of the Rb value and post-incrementing the Rb value by four corresponding to the operand size.

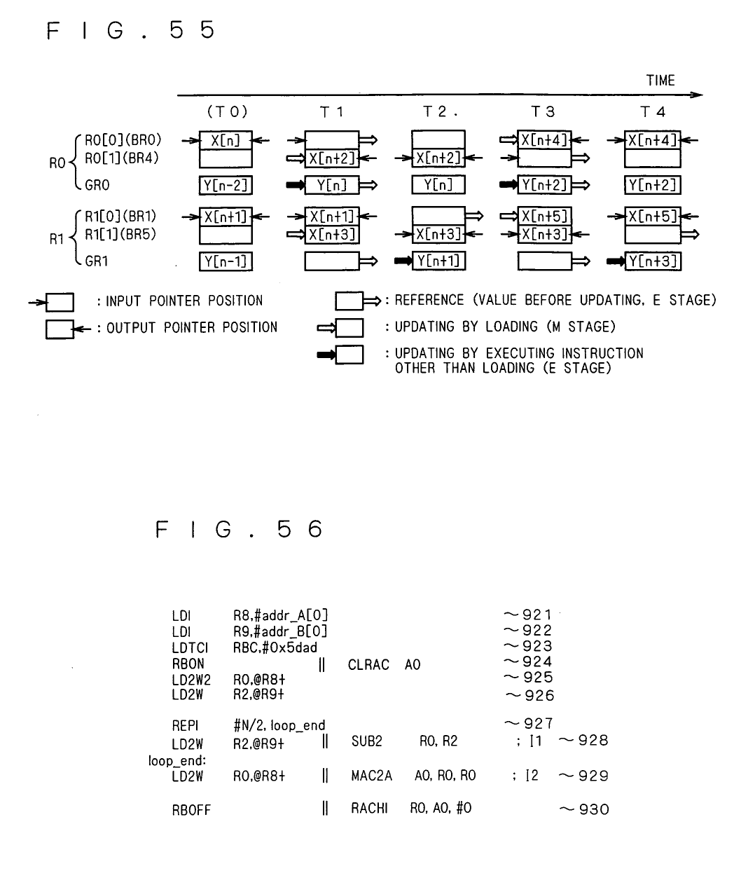

FIG. 54 is an explanatory diagram showing pipeline processing in repetition processing of instructions of the command rows 889 and 890 in detail. FIG. 55 is an explanatory diagram showing the current states of the ring buffers. Pipeline operations in the exemplary program 8 are now described with reference to FIGS. 54 and 55.

FIGS. 54 and 55 show states of executing an I1 instruction 889 in the E stage 403 of a certain period T1 in the repetition processing for shifting X[n]. The data processor repeats the processing every two clock cycles as instruction processing. Input/output pointers return to the same states every four clock cycles as the ring buffer operations.

In the E stage 403 of the period T1, the data processor performs processing 902 (execution of the I1 instruction 889). The first operation unit 222 outputs and updates the address of an ST2W instruction 889a and reads stored data. The first operation unit 222 outputs the value of the general-purpose register GR9 to the operand access unit 204 as the address, post-increments the same by four and rewrites the result in the general-purpose register GR9. The first operation unit 222 reads the stored data from the corresponding general-purpose register.

The data processor reads the values of Y[n−2] and Y[n−1] held in the general-purpose registers GR0 and GR1 allocated as the logical registers R0 and R1 in storing respectively. The second operation unit 223 performs shifting according to an SLL instruction 889b. The general-purpose registers GR0 and GR1 function as memory storing instruction physical registers.

The data processor reads the value of the buffer register BR0 allocated as R0[0] to be read in shifting, and the shifter 371 shifts the same left the shift quantity held in the general-purpose register GR4 and writes the result in the general-purpose register GR0 to be subjected to writing in shifting. Thus, the data processor reads data to be operated from the corresponding ring buffer, and writes the shift result, i.e., the operation result in the corresponding general-purpose register.

Following execution of the SLL instruction 889b, the data processor refers to the value of the logical register R0, so that the output pointer update circuit 518 or the like increments the output pointer BOP0 of the logical register R0 by one and updates the same to “1”. In relation to reference to stored data in execution of the ST2W instruction 889a, on the other hand, the data processor does not update the output pointer of the corresponding ring buffer since the same refers to the general-purpose register value.

In the M stage 404 of a period T2, the data processor performs processing 906 (processing of an I1a instruction 889a). In the M stage 404, the data processor outputs the values Y[n−2] and Y[n−1] read from the general-purpose registers GR0 and GR1 in the E stage 403 to the operand access unit 204, for storing the same in the memory.

In the D stage 402 of the period T1, the data processor performs processing 901 (decoding of an I2 instruction 890). At this time, the data processor recognizes the output pointer of the logical register R0 updated through the processing 902.

In the E stage 403 of the period T2, the data processor performs processing 905 (execution of an I2a instruction 890a). The first operation unit 222 outputs and updates the address of an LD2W instruction 890a. The first operation unit 222 outputs the value of the general-purpose register GR8 to the operand access unit 204 as the address, post-increments the same by four and rewrites the result in the general-purpose register GR8. The second operation unit 223 performs shifting according to an SLL instruction 890b. The second operation unit 223 reads the value of the buffer register BR1 allocated as R1[0], so that the shifter 371 shifts the same left the shift quantity held in the general-purpose register GR4 and writes the result in the general-purpose register GR1.

Thus, the data processor reads data to be operated from the corresponding ring buffer, and writes the shifting result, i.e., the operation result in the corresponding general-purpose register. Following execution of the LD2W instruction 890a, the logical registers R0 and R1 load 1-word data respectively, so that the input pointer update circuit 514 or the like increments the values of the two input pointers BIP0 and BIP1 by one respectively and updates the same to “1”. Following execution of the SLL instruction 890b, further, the data processor refers to the value of the logical register R1, so that the output pointer update circuit 518 or the like increments the output pointer BOP1 of the logical register R1 by one and updates the same to “1”.

In the M stage 404 of a period T3, the data processor performs processing 909 (processing of the I2a instruction 890a). In the M stage 404, the data processor reads values X[n+4] and X[n+5] from the memory and writes the same in the buffer registers BR0 and BR1 allocated as R0[0] and R1[0] respectively.

In the D stage 402 of the period T2, the data processor performs processing 904 (decoding of the I1 instruction 889). At this time, the data processor recognizes the input pointers of the logical registers R0 and R1 and the output pointer of the logical register R1 updated through the processing 905.

Thus, the data processor implements repetition processing of efficient read-modify-write operation with a small number of logical registers by writing each operation result in the corresponding general-purpose register and referring to the value of the general-purpose register as stored data. The ring buffers and the general-purpose registers function as load data buffers and stored data buffers respectively, while the data processor uncontradictably specifies a plurality of load data buffers and a plurality of stored data buffers with the same register numbers.

According to this exemplary processing, the data processor specifies three registers, i.e., two load data buffer registers and one store buffer register with the same number. Thus, also when performing read-modify-write operation, the number of logical registers used for instructions can be reduced and the data processor can implement efficient processing while keeping high code efficiency. In this case, the data processor can implement processing with two logical registers R0 and R1 while freely using the remaining logical registers R2 to R7 for other purposes. According to this exemplary processing, further, the data processor does not destroy but holds the original values of the logical registers R2 to R7, to require no processing for saving and returning the values of the logical registers R2 to R7 also when not using the same.

In addition, the data processor can easily implement an efficient program in consideration of pipeline processing while minimizing the basic processing unit (repetition block size) of repetition processing with excellent program development efficiency and a possibility of reducing the degree of bug contamination.

Further, the data processor processes a two-operand instruction substantially similarly to a three-operand instruction by making the best use of the ring buffers and the general-purpose registers.

According to this embodiment, the data processor uses the general-purpose registers as registers for store buffers. Thus, the data processor effectively makes the best use of an existing hardware resource, suppresses the amount of additional hardware and implements efficient programming at a low cost.

A similar effect can be attained also by packaging registers for store buffers independently of the general-purpose registers and providing a function of writing a value in the corresponding store buffer register when updating the register value by executing an instruction and referring to the value of the store buffer register when executing a store instruction, although the hardware amount must be increased. In this case, the data processor holds the values of the general-purpose registers before and after repetition processing, whereby it may be possible to further reduce the degree of saving and return processing.

<Exemplary Program 9: Differential Square-Sum Operation>

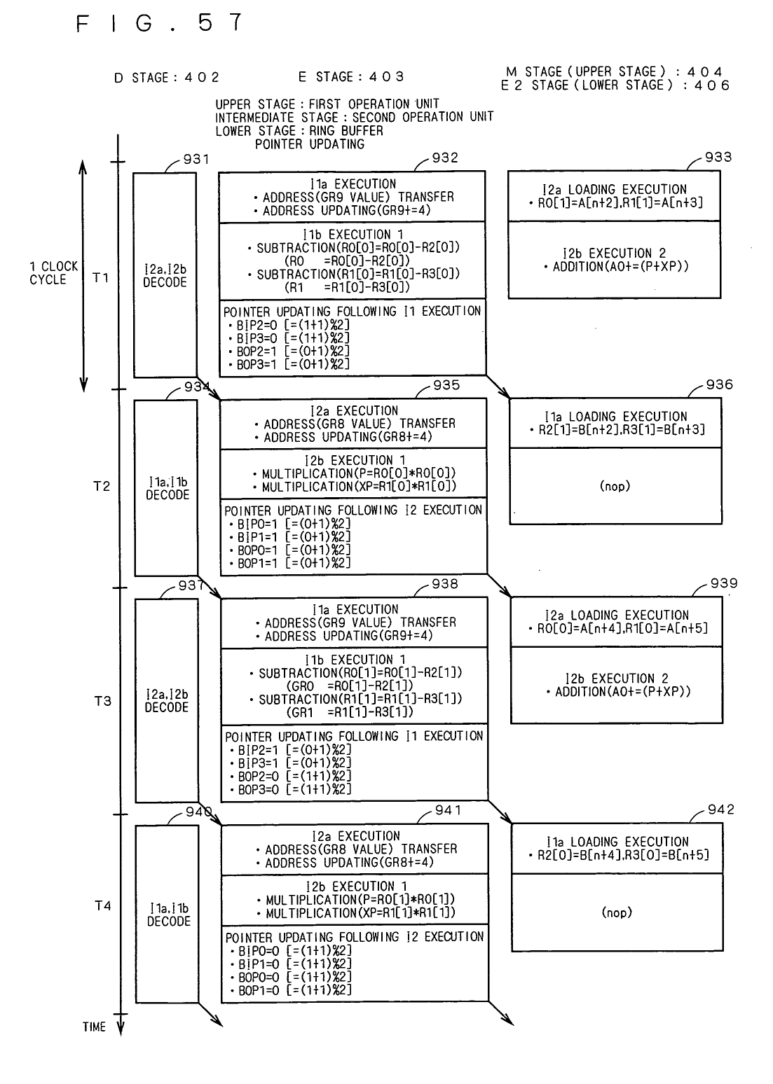

FIG. 56 is an explanatory diagram showing an exemplary program 9 for performing differential square-sum operation. According to the exemplary program 9, the data processor performs the following processing in C-language notation:
for (i=0, sum=0; i<N; ++i) sum +=(A[i]−B[i])*(A[i]−B[i]);

The data processor repeats differential square-sum operation of 16-bit fixed points A and B N times. It is assumed that N represents a multiple of the number 2. It is also assumed that A[i] and B[i] are sequentially arranged on the built-in data memory in order of i in the address incremental direction, and A[0] and B[0] are leveled 32 bits (4 bytes). It is further assumed that the square-sum operation result (sum) is rounded to 16 bits and held at r0.

This data processor comprises no instruction dedicated to differential square-sum operation. According to this exemplary program 9, the data processor repetitively executes subtraction and product-sum operation instructions. However, the data processor performs differential square-sum operation processing with a throughput in one clock cycle according to SIMD operation.

Command rows 921 to 926 are preprocessing for performing repetition processing, a command row 927 is a block repetition instruction, command rows 928 and 929 are block repetition object instructions, and a command row 930 is a part for postprocessing after the repetition processing.

According to an LDTCI instruction 923, the data processor sets the RBCNF bit 80 to “01”, the STM bit 81 to “0”, the WM bit 82 to “1” the RBE0, RBE1, RBE2 and RBE3 bits 83, 85, 87 and 89 to “1”, the OPM0 and OPM1 bits 84 and 86 to “10” and the OPM2 and OPM4 bits 88 and 90 to “01” respectively. In other words, each of the logical registers R0 to R3 enters the ring buffer structure (see FIG. 10) consisting of two entries, so that the data processor updates the output pointers of the logical registers R0 and R1 with a last instruction of a repetition block while updating the output pointers of the logical registers R2 and R3 by referring to the register values. The data processor updates values of buffer registers indicated by both of the general-purpose registers and the output pointers by executing instructions other than loading instructions. According to this setting, the data processor can use buffer registers of entries selected through the output pointers as working registers in the corresponding repetition blocks in relation to the logical registers R0 and R1. In other words, the data processor can temporarily hold operation results.

A “SUB2 Ra, Rb” instruction is an SIMD operation instruction for performing two subtractions for subtracting the Rb value from the Ra value, rewriting the subtraction result in Ra, subtracting a value R(b+1) from a value R(a+1) and rewriting the subtraction result in R(a+1).

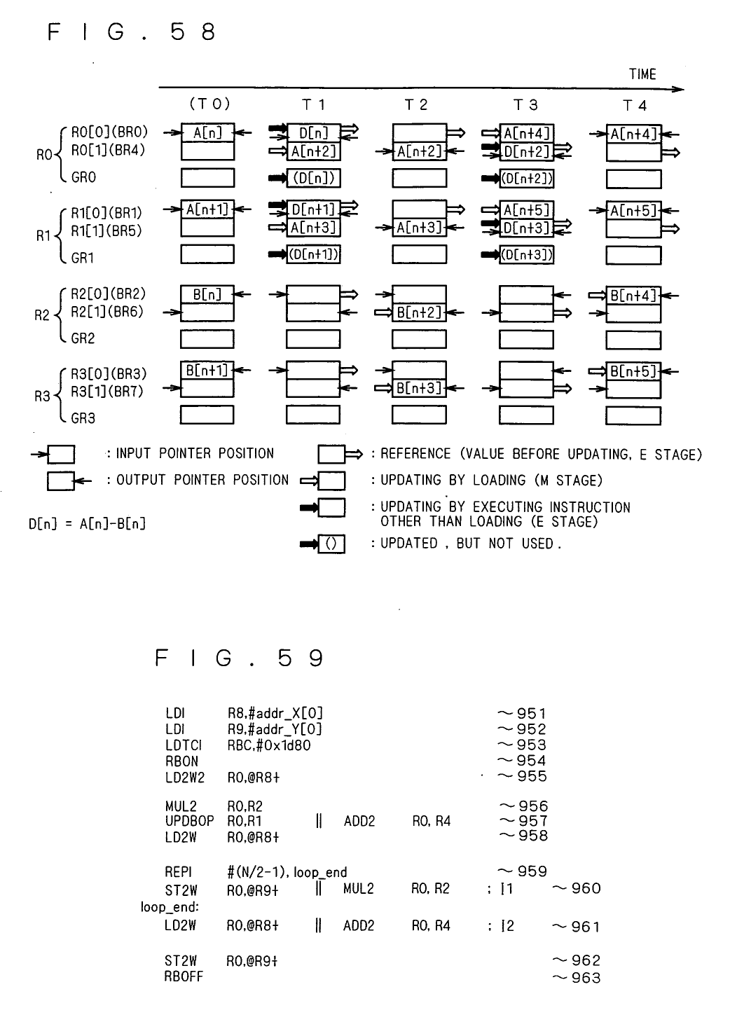

FIG. 57 is an explanatory diagram showing pipeline processing in repetition processing of instructions of the command rows 928 and 929 in detail. FIG. 58 is an explanatory diagram showing the current stages of the ring buffers. Pipeline operations in the exemplary program 9 are now described with reference to FIGS. 57 and 58.

FIGS. 57 and 58 show states of processing in a case of executing an I1 instruction 928 in the E stage 403 of a certain period T1 in the repetition processing for performing subtraction of “A[n]−B[n]” and “A[n+1]−B[n+1]”. The data processor repeats the processing every two clock cycles as the instruction processing. Input/output pointers return to the same states every four clock cycles as the ring buffer operations.

In the E stage 403 of the period T1, the data processor performs processing 932 (execution of the I1 instruction 928). The first operation unit 222 outputs and updates the address of an LD2W instruction 928a. The first operation unit 222 outputs the value of the general-purpose register GR9 to the operand access unit 204 as the address, post-increments the same by four and rewrites the result in the general-purpose register GR9. The second operation unit 223 performs subtraction of a SUB2 instruction 928b. The second operation unit 223 reads the values of the buffer registers BR0 and BR2 allocated as R0[0] and R2[0] respectively so that the ALU 380 performs subtraction and rewrites the subtraction result in the buffer register BR0 allocated as R0[0] (indicated by the output pointer BOP0) and the general-purpose register GR0. Further, the second operation unit 223 reads the values of the buffer registers BR1 and BR3 allocated as R1[0] and R3[0] respectively, so that the adders 395 performs subtraction and rewrites the subtraction result in the buffer register BR1 allocated as R1[0] (indicated by the output pointer BOP1) and the general-purpose register GR1.

Thus, the data processor reads data to be operated from the corresponding ring buffer, and writes the subtraction result, i.e. the operation result in both of the entry indicated by the output pointer of the ring buffer and the corresponding general-purpose register. Following execution of the LD2W instruction 928a, the logical registers R2 and R3 load 1-word data respectively, so that the input pointer update circuit 514 or the like increments the two input pointer values BIP2 and BIP3 by one respectively and updates the same to “0” in circulation. Following execution of the SUB2 instruction 928b, further, the data processor refers to the values of the logical registers R2 and R2, so that the output pointer update circuit 518 or the like increments the output pointers BOP2 and BOP3 of the logical registers R2 an R3 by one respectively and updates the same to “1”. The data processor also refers to the values of the logical registers R0 and R1 according to the SUB2 instruction 928b without updating the output pointers thereof, which in turn are updated with last instructions of repetition blocks.

In the M stage 404 of a period T2, the data processor performs processing 936 (processing of an I1a instruction 928a). In the M stage 404, the data processor writes values B[n+2] and B[n+3] in the buffer registers BR6 and BR7 allocated as R2[1] and R3[1] respectively. The data processor performs no valid processing in the E stage 406 of the period T2.

In the D stage 402 of the period T1, the data processor performs processing 931 (decoding of an I2 instruction 929). At this time, the data processor recognizes the input/output pointers of logical registers to be decoded among the logical registers R0 to R3 subjected to the pointer updating through the processing 932.

In the E stage 403 of the period T2, the data processor performs processing 935 (execution of the I2 instruction 929). The first operation unit 222 outputs and updates the address of an LD2W instruction 929a. The first operation unit 222 outputs the value of the general-purpose register GR8 to the operand access unit 204 as the address, post-increments the same by four and rewrites the result in the general-purpose register GR8.

The second operation unit 223 performs multiplication of a MAC2A instruction 929b. The second operation unit 223 reads the values “A[n]−B[n]” and “A[n+1]−B[n+1]” from the buffer registers BR0 and BR1 allocated as R0[0] and R1[0] respectively, so that the multipliers 376 and 391 perform two square operations and write the operation results in the P latch 379 and the PX latch 394 respectively.

Following execution of the LD2W instruction 929a, the logical registers R0 and R1 load 1-word data respectively, so that the input pointer update circuit 514 or the like increments the values of the input pointers BIP0 and BIP1 of the logical registers R0 and R1 by one respectively and updates the same to “1”. Since the I2 instruction 929 is a last instruction of a repetition block, whereby the output pointer update circuit 518 or the like increments the output pointers BOP0 and BOP1 of the logical registers R0 and R1 by one respectively and updates the same to “1”.

In the M stage 404 and the E2 stage 406 of a period T3, the data processor performs processing 939 (processing of the I2 instruction 929). In the M stage 404, the data processor writes values A[n+4] and A[n+5] in the buffer registers BR0 and BR1 allocated as R0[0] and R1[0] respectively. In the E2 stage, the adder 362 ternary-adds the value of the P latch 379 indicating the operation result in the E stage 403, the value of the PX latch 394 and the value of the accumulator A0, and rewrites the result in the accumulator A0.

In the D stage 402 of the period T2, the data processor performs processing 934 (decoding of the I1 instruction 928). At this time, the data processor recognizes the input/output pointers of logical registers to be decoded among the logical registers R0 to R3 subjected to the pointer updating through the processing 935.

The data processor, updating the pointers of the logical registers R2 and R3 by referring to the register values upon execution of instructions according to the exemplary program 9, may alternatively also update the output pointers of the logical registers R2 and R3 with last instructions of repetition blocks.

Thus, the data processor can use buffer registers of entries selected through the output pointers as working registers in the corresponding repetition blocks by updating the output pointers with the last instructions of the repetition blocks while updating the register values by executing instructions other than loading instructions also with respect to buffer registers indicated by the output pointers. According to this control, it is possible not only to use the buffer registers simply as load operand buffers but also to hold intermediate operation results as working registers similarly to normal general-purpose registers, for referring to the operation results through subsequent instructions.

In other words, it is possible to reduce the number of used registers by using the same register as a read/modify/write operand. Further, the data processor can specify any ring buffer as a destination operand of a two-operand instruction, whereby it follows that operation can be specified with a short instruction length for enabling parallel execution of a larger number of instructions and improving performance. While a similar function can be implemented without this control if a three-operand instruction can be packaged as a short instruction since a read load operand value can be written in another general-purpose register, it is practically impossible to allocate a three-operand instruction having three register operands to a short-format instruction in the case of the data processor according to this embodiment, for example, since 12-bit instruction codes are required in three register operand specifying fields.

While it is also conceivable to comprise an instruction for writing an operation result (subtraction result) in a register not explicitly indicated as an instruction code, this is inferior in general-purpose property, an instruction dedicated thereto must be added, and the number of instructions allocated to short instructions is strictly limited. Further, it is necessary to provide another instruction for referring to a register different from a ring buffer also as to an instruction referred to, and the number of instructions allocated to short instructions is strictly limited.

In other words, it is possible to refer to an operation result for a subsequent instruction by using a normally used instruction as such without adding a new dedicated instruction by packaging a function of updating a register value with respect to a buffer register indicated by an output pointer through execution of an instruction other than a loading instruction, whereby the data processor can perform efficient instruction allocation as to short-format instructions while improving the code efficiency.

Thus, it is possible to implement a high-performance low-cost data processor by making it possible to rewrite operation results also in buffer registers.

According to this exemplary program 9, the data processor writes operation results also in the general-purpose registers without referring to the values thereof. In other words, it is of no use to write the operation results in the general-purpose registers. While the data processor allocates the WM bit 82 to one bit to be capable of mode-setting whether to write the same in the general-purpose registers or in the general-purpose registers and the buffer registers, two mode specifying bits may alternatively be employed with addition of a mode for writing the same in only the buffer registers. In this case, the data processor performs no useless writing in the general-purpose registers, not to destroy the values of the general-purpose registers GR0 and GR1 in this exemplary program 9. In other words, it follows that the data processor can not only merely suppress useless writing but also further reduce overhead of saving/return.

Further, the data processor can select a proper operation in response to processing contents in the exemplary program 8 shown in FIG. 53 or the exemplary program 9 shown in FIG. 56 due to the structure capable of mode setting as to whether to rewrite operation results in the general-purpose registers or also in the buffer registers, whereby it is possible to implement a high-performance low-cost data processor by adding a small hardware cost.

While the data processor performs control with one mode specifying bit (WM bit 82) with respect to the overall ring buffers according to this embodiment, mode setting may alternatively be enabled in unit of register. In this case, the data processor can perform finer control, whereby it may be possible to further reduce the degree of overhead of saving/return.

<Exemplary Program 10: Linear Function>

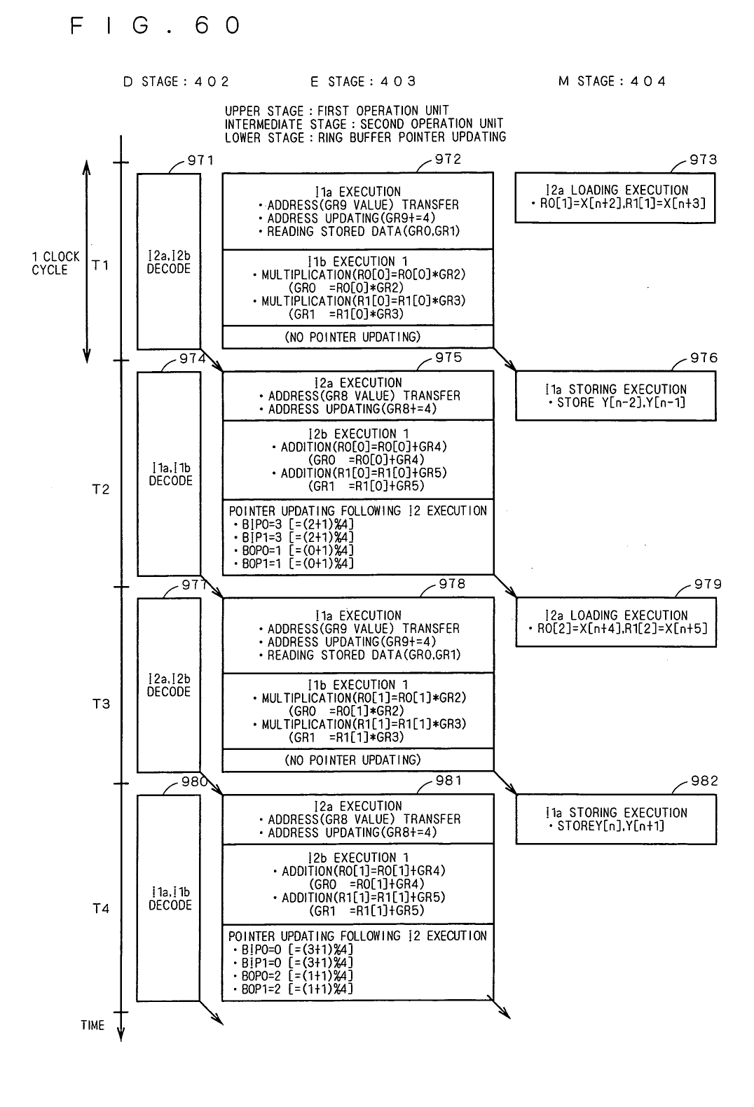

FIG. 59 is an explanatory diagram showing an exemplary program 10 for repeating linear function processing on 16-bit integral array data. It follows that the data processor performs the following processing in C-language notation according to the exemplary program 10:
for (i=0; i<N; ++i) Y[i]=A*X[i]+B;

The data processor repeats processing of rewriting a result obtained by multiplying X[i] by A and adding B thereto as Y[i]. It is assumed that i represents 0 to (N−1), X[i] denotes 16-bit data, addresses of X[0] and Y[0] are leveled 32 bits, and N represents a multiple of the number 2. In the following description, it is assumed that T[i]=A*X[i]. Before running the program shown in FIG. 49, the data processor sets the value of A in the logical registers R2 (GR2) and R3 (GR3), while setting the value of B in the logical registers R4 (GR4) and R5 (GR5).

The data processor performs linear function processing with one throughput in one clock cycle through SIMD operation.

Command rows 951 to 958 are preprocessing for performing repetition processing, a command row 959 is a block repletion instruction, command rows 960 and 961 are block repetition object instructions, and command rows 962 and 963 are parts for postprocessing after the repetition processing.

According to an LDTCI instruction 953, the data processor sets the RBCNF bit 80 to “00”, the STM bit 81 to “0”, the WM bit 82 to “1”, the RBE0 an RBE1 bits 83 and 85 to “1” and the OPM0 and OPM1 bits 84 and 86 to “10” respectively. In other words, each of the logical registers R0 and R1 enters the ring buffer structure (see FIG. 9) consisting of four entries, and the data processor updates the output pointers of the logical registers R0 and R1 with last instructions of repetition blocks. The data processor updates values of buffer registers indicated by both of general-purpose registers and output pointers by executing instructions other than loading instructions. According to this setting, the data processor can use buffer registers of entries selected through the output pointers as working registers in the corresponding repetition blocks in relation to the logical registers R0 and R1. In other words, the data processor can temporarily hold operation results.

An “MUL2 Ra, Rb” instruction which is also a data updating instruction indicating data updating with respect to a specific logical register is an SIMD operation instruction for multiplying two integers together, for multiplying the Ra and Rb values together, rewriting the multiplication result in Ra, multiplying values R(a+1) and R(b+1) together and rewriting the multiplication result in R(a+1). An “ADD2 Ra, Rb” instruction which is also the aforementioned data updating instruction is an SIMD operation instruction for performing two additions, for adding the Ra and Rb values together, rewriting the addition result in Ra, adding the values R(a+1) and R(b+1) together and rewriting the addition result in R(a+1).

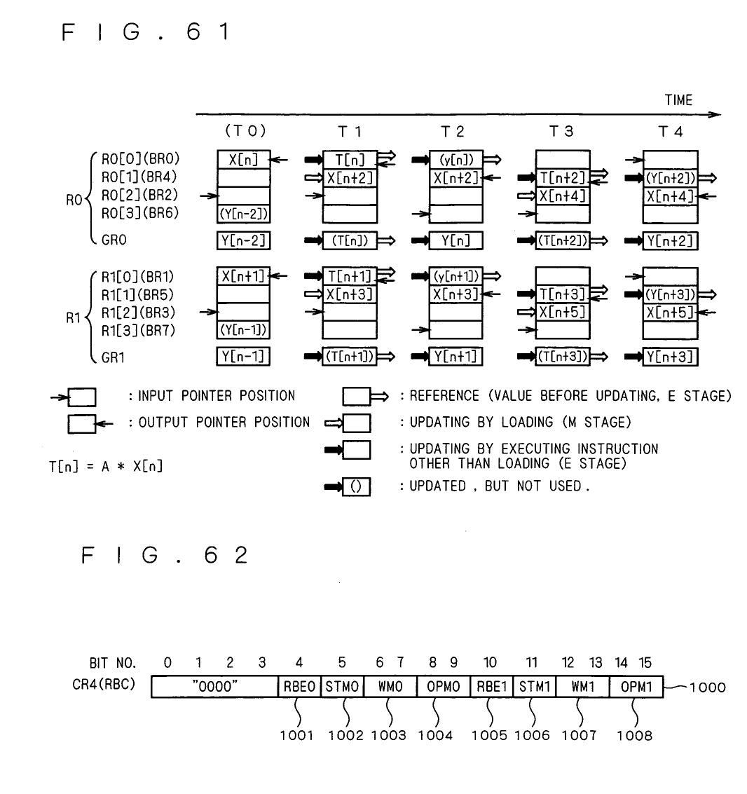

FIG. 60 is an explanatory diagram showing pipeline processing in repetition processing of instructions of the command rows 960 and 961 in detail. FIG. 61 is an explanatory diagram showing the current states of the ring buffers. Pipeline operations in the exemplary program 10 are now described with reference to FIGS. 60 and 61.

FIGS. 60 and 61 show states of processing in a case of executing an I1 instruction 960 in the E stage 403 of a certain period T1 in the repetition processing for performing multiplications “A*X[n]” and “A*X[n+1]”. The data processor repeats the processing every two clock cycles as the instruction processing. Input/output pointers return to the same states every eight clock cycles as the ring buffer operations.

In the E stage 403 of the period T1, the data processor performs processing 972 (execution of the I1 instruction 960). The first operation unit 222 outputs and updates the address of an ST2W instruction 960a and reads stored data. The first operation unit 222 reads the value of the general-purpose register GR9 to the operand access unit 204 as the address, post-increments the same by four and rewrites the result in the general-purpose register GR9. The first operation unit 222 reads the stored data from the general-purpose registers. The first operation unit 222 reads values Y[n−2] and Y[n−1] held in the general-purpose registers GR0 and GR1 allocated as the logical registers R0 and R1 respectively.

The second operation unit 223 performs multiplication of a MUL2 instruction 960b. The second operation unit 223 reads the value of the buffer register BR0 allocated as R0[0] and the value of the general-purpose register GR2, so that the multiplier 376 multiplies the values together and rewrites the multiplication result T[n] in the buffer register BR0 allocated as R0[0] (indicated by the output pointer BOP0) and the general-purpose register GR0. Further, the second operation unit 223 reads the value of the buffer register BR1 allocated as R1[0] and the value of GR3, so that the multiplier 391 multiplies these values together and rewrites the multiplication result T[n+1] in BR1 allocated as R0[0] (indicated by the output pointer BOP1) and the general-purpose register GR1. Thus, the data processor reads data to be operated from the corresponding ring buffer, and writes the subtraction result, i.e., the operation result in both of the entry indicated by the output pointer of the ring buffer and the corresponding general-purpose register.

In relation to reference to stored data in execution of the ST2W instruction 960a, the data processor refers to the corresponding general-purpose register value without updating the output pointer of the corresponding ring buffer. The data processor, referring to the values of the logical registers R0 and R1 following execution of the MUL2 instruction 960b, does not update the output pointers of the logical registers R0 and R1 since the former sets the latter with last instructions of repetition blocks.

In the M stage 404 of a period T2, the data processor performs processing 976 (processing of an I1a instruction 960a). In the M stage 404, the data processor outputs the values Y[n−2] and Y[n−1] read from GR0 and GR1 in the E stage 403 to the operand access unit 204 for storing the same in the memory. The data processor performs no valid processing in the E2 stage 406 of the period T2.

In the D stage 402 of the period T1, the data processor performs processing 971 (decoding of an I2 instruction 961). At this time, the data processor recognizes the input/output pointers of logical registers to be decoded among the logical registers R0 to R3 subjected to pointer updating through the processing 972.

In the E stage 403 of the period T2, the data processor performs processing 975 (execution of the I2 instruction 961). The first operation unit 222 outputs and updates the address of an LW2W instruction 961a. The first operation unit 222 outputs the value of the general-purpose register GR8 to the operand access unit 204 as the address, post-increments the same by four and rewrites the result in the general-purpose register GR8. The second operation unit 223 performs addition of an ADD2 instruction 961b. The second operation unit 223 reads the value T[n] of the buffer register BR0 allocated as R0[0] and the value of the general-purpose register GR4, so that the ALU 380 adds the values together and rewrites the addition result in BR0 allocated as R0[0] (indicated by the output pointer BOP0) and the general-purpose register GR0. Further, the second operation unit 223 reads the value T[n+1] of the buffer register BR1 allocated as R1[0] and the value of the general-purpose register GR5, so that the adder 359 adds these values together and rewrites the addition result in the buffer register BR1 allocated as R1[0] (indicated by the output pointer BOP1) and the general-purpose register GR1.

Thus, the data processor reads data to be operated from the corresponding ring buffer, and writes the subtraction result, i.e., the operation result in both of the entry indicated by the output pointer of the ring buffer and the general-purpose register. Following execution of the LD2W instruction 961a, the logical registers R0 and R1 load 1-word data respectively, so that the input pointer update circuit 514 or the like increments the values of the input pointers BIP0 and BIP1 of the logical registers R0 and R1 by one respectively and updates the same to “3”. Further, the I2 instruction 961 is a last instruction of a repetition block, whereby the output pointer update circuit 518 or the like increments the output pointers BOP0 and BOP1 of the logical registers R0 and R1 by one respectively and updates the same to “1”.

In the M stage 404 of a period T3, the data processor performs processing 979 (processing of an I2a instruction 961a). In the M stage 404, the data processor writes values X[n+4] and X[n+5] in the buffer registers BR2 and BR3 allocated as R0[2] and R1[2] respectively. The data processor performs no valid processing in the E2 stage 406 of the period T3.

In the D stage 402 of the period T2, the data processor performs processing 974 (decoding of the I1 instruction 960). At this time, the data processor recognizes input/output pointers of logical registers to be decoded among the logical registers R0 to R3 updated through the processing 975.

According to the exemplary program 10, the data processor can use buffer registers of entries selected through the output pointers as working registers in the corresponding repetition blocks by updating the output pointers with last instructions of the repetition blocks and performing updating of register values following execution of instructions other than loading instructions also on the buffer registers indicated by the output pointers, similarly to the exemplary program 9 for differential square-sum operation shown in FIG. 56.

According to this control, it is possible not only to use the buffer registers merely as load operand buffers but also to refer to operation results with subsequent instructions as working registers similarly to normal general-purpose registers. In relation to stored data, further, the data processor uses the general-purpose registers also as store buffers by referring to the general-purpose register values. Thus, the data processor can use the registers both as working registers and store registers by rewriting the operation results in both of the general-purpose registers and the buffer registers. It is extremely effective in a case of holding data under operation and stored data in the same registers such as the logical registers R0 and R1 in the exemplary program 10. In other words, the data processor can use a plurality of registers having a single logical register number as load operand buffers, working registers and store buffers, whereby the number of used logical registers can be remarkably reduced. Further, the data processor writing data in both of the general-purpose registers and the buffer registers may not distinguish instructions rewritten in the general-purpose registers and the buffer registers from each other, whereby instructions can be efficiently allocated to short instruction codes and it is possible to improve the performance and reduce the cost following improvement of the code efficiency.

According to this exemplary program 10, the data processor not storing operation results in an initial stage of repetition processing performs first operation in preprocessing of the loop. The data processor updating the output pointers with last instructions of repetition blocks explicitly performs the first operation processing with an UPDBOP instruction 957a outside the repetition blocks. Thus, the UPDBOP instruction 957a may effectively act on pointer updating in a case of no ideal repetition processing, despite slight overhead.

The data processor, running the exemplary program 10 with four ring buffers as to each of the logical registers R0 and R1, is also operable when using two ring buffers for each logical register.

According to the exemplary program 10, the data processor writes data in both of the buffer registers and the general-purpose registers according to the last instructions of the repetition blocks. However, it is obvious that the values written in the buffer registers according to the last instructions of the repetition blocks are not thereafter referred to, and hence the data processor may suppress writing in the buffer registers with the last instructions of the repetition processing, not to perform useless writing.

<Operation in EIT Processing>

Operations in EIT (exception, interruption and trap) processing are now briefly described. When detecting EIT and satisfying starting conditions, the data processor starts EIT processing. When an external terminal asserts an interruption request and the IE bit 62 of the control register CR0 (PSW) is “1”, for example, the data processor starts interruption processing in a break of a 32-bit instruction. The data processor controls starting of EIT in a hardware manner. The data processor saves the value of PSW upon EIT detection in the BPSW register 322 through the D1 bus 261, and initializes PSW. The data processor initializes the SM bit 61 to “0” in a case of EIT related to interruption, while otherwise holding the value. The data processor initializes the remaining bits including the RM bit 68 to “0”. The data processor further saves a value serving as a return address from the EPC register 334 to the BPC register 336 through the latch 335. The control unit generates an EIT vector address as a jump destination address in response to the started EIT and outputs the same as an immediate value to the first operation unit 222, which in turn outputs the same to the JA bus 274 through the AB latch 103 and the ALU 301 to be subjected to processing identical to that in execution of a jump instruction. Thereafter the data processor performs the EIT processing according to an instruction of the EIT vector address of the jump destination. The control registers CR4 (RBC) and CR5 (RBP) hold states upon EIT detection.

When there is a possibility of accepting another EIT in an EIT processing handler, the data processor saves the values of the control registers CR1 (BPSW) and CR3 (BPC). When using a ring buffer function in the handler, the data processor saves the values of the control registers CR4 (RBC) and CR5 (RBP) and the buffer registers BR0 to BR7. When using no ring buffer function in the handler, the data processor may not save register values related to ring buffers.

When returning from the EIT processing to the original program, the data processor runs an RTE instruction which is a return instruction from the EIT processing. The data processor returns the value of the BPSW register 322 to PSW through the CNTIF latch 321 by running the RTE instruction. Further, the data processor outputs the value of the BPC register 336 holding the return address to the JA bus 274 through the S3 bus 253, the AB latch 303 and the ALU 301, to be subjected to processing identical to that in execution of the jump instruction. The data processor also returns the RM bit 68 to the state upon EIT detection. Thus, the data processor returns to the original processing.

As to ring buffer control, the data processor performs two-stage enable control with the RM bit 68 of the control register CR0 (PSW) and the RBEi bits 83, 85, 87 and 89 of the control register CR4 (RBC). While the data processor performing such two-stage control requires specific processing for only the RM bit 68 of the control register CR0 (PSW) in starting and return of EIT, the RBEi bits 83, 85, 87 and 89 of the control register CR0 (PSW) require no hardware saving and returning so that the hardware is simplified to improve hardware development efficiency.

When using no ring buffer function in the handler, the data processor may not save the register values related to the ring buffers, whereby the volume of context information essentially requiring saving/return in a case of accepting another EIT during EIT processing can be reduced, interruption responsibility can be improved and the code size can be reduced.

### Effects of the Embodiment

As hereinabove described, it is possible to remarkably reduce the number of used logical registers and allocate a large number of operations to instructions of a small basic instruction length by allocating FIFO-controlled buffers to parts of registers. Further, it is possible to remarkably reduce the number of processing cycles of repetition processing, fraction processing and before and after repetition processing as well as the code size. Thus, it is possible to obtain a high-performance data processor at a low cost. In addition, power consumption can also be reduced by reducing the number of processing cycles. Further, the program is so simplified that the software development efficiency can be improved and the possibility of bug contamination can be reduced.

The data processor can switch the general-purpose register mode for executing the physical register fixed operation and the ring buffer mode for executing the physical register varying operation due to the RM bit 68, whereby it is possible to select the mode in response to the processing contents of the program or the software development policy to compatibly improve the performance and the software development efficiency. For example, the data processor may use the ring buffer mode for a part preferentially reducing the number of cycles in digital signal processing or the like for sufficiently optimizing loop processing in consideration of load latency. Further, the data processor may use the simple general-purpose register mode for a part using a tool such as a compiler or performing no loop optimization with preference over the software development efficiency despite coding in the assembler.

The data processor can switch the general-purpose register mode and the ring buffer mode in unit of register through the RBEi bits 83, 85, 87 and 89, whereby optimum setting can be selected in response to the usage of a variable allocated to each register in the program to be run, so that it is possible to write an efficient program.

The data processor performs mode setting in two stages in unit of register with the RM bit 68 of the control register CR0 (PSW) and the RBEi bits 83, 85, 87 and 89 of the control register CR4 (RBC), whereby hardware control for EIT processing is simplified and the hardware development efficiency is improved. Further, context information essentially requiring saving/return can be so reduced that interruption responsibility is improved and the cost can be reduced by reducing the code size.

The ring buffers are constituted of only registers added as buffer registers in the ring buffer mode, whereby no register values may be saved or returned before and after repetition processing in the ring buffer mode, and overhead can be reduced.

On the contrary, it is possible to reduce the volume of added hardware by partially using existing general-purpose registers as registers of the ring buffer mode. Either preference may be determined in consideration of a trade-off between the cost and the performance.

The data processor can set the contents of the register structure of any ring buffer with the RBCNF bit 80, whereby the optimum buffer structure can be selected in response to the processing contents of the program, and it is possible to write an efficient program.

A plurality of registers in the specified physical register group constitute a FIFO buffer as logically annularly coupled circulation buffers and the data processor performs input/output control with the input/output pointers, whereby the input/output control of the FIFO buffer is simplified and the hardware development efficiency is improved. Further, useless data transfer can be reduced as compared with a case of implementing a FIFO buffer by transferring data, whereby power consumption can be reduced. In addition, such an effect can also be attained that various functions such as irregular pointer updating and employment as working registers are easily addable.

The data processor is packaged with the ring buffers having 2ⁿ entries, whereby pointer updating can be implemented by a simple n-bit counter and the hardware development efficiency is improved.

The data processor has the multiple data updating instruction for simultaneously loading a plurality of (k≧2) data in one register, whereby the number of used logical registers can be further reduced.

The data processor implicitly updates the output pointers of the ring buffers following execution of a register value reference instruction, whereby the number of processing cycles as well as the code size can be reduced.

The data processor performs output pointer updating corresponding to a specific logical register implicitly set when a prescribed condition holds in a case of executing a repetition block last instruction or a branch instruction in response to the usage or the manner of use of a variable allocated to each ring buffer, whereby the number of processing cycles as well as the code size can be reduced.

The data processor comprises the function of explicitly updating the output pointers according to an output pointer update instruction, whereby it is possible to flexibly cope with a case of forming a loop with a plurality of processing units or requiring irregular processing.

Further, the data processor can specify output pointer updating in unit of register with an output pointer update instruction, whereby it is possible to write an efficient program in response to the processing contents of the program.

The data processor can set a method of changing the output pointers with the program according to multiple output pointer update mode information, whereby it is possible to write an efficient program in response to the usage of the variable allocated to each register as also shown in the aforementioned exemplary programs.

The data processor can perform fine setting every variable by setting the method of changing the output pointer in unit of register, whereby it is possible to write an efficient program.

The data processor comprises the multiple data reference instruction of simultaneously referring to two data in ring buffers of a single register number and updating only one output pointer, whereby two-sample simultaneous processing of single sample FIR processing can be efficiently performed in SIMD operation.

The data processor referring to the value of a register (memory storing instruction physical register) different from a ring buffer in storing (memory storage) can use this register as a store buffer.

Further, the data processor using a general-purpose register as this register can reduce the hardware cost. The data processor referring to the value of the ring buffer in storing can efficiently perform memory-to-memory transfer.

The data processor referring to the value of the register constituting the ring buffer in storing can attain such an effect that it is possible to write an effective program in a case of performing memory-to-memory transfer.

The data processor comprising the function of selecting a register constituting a ring buffer or a register different from the ring buffer as the register referred to in storing can perform efficient programming in response to the contents of the processed program.

Further, the data processor can arbitrarily set the register value referred to in storing in unit of register constituting a ring buffer in response to the usage of the variable allocated to each register according to the program, whereby it is possible to write an efficient program in response to the processing contents of the program.

The data processor updating the value of a register (data updating physical register) different from a ring buffer in execution of a data updating instruction such as an operation instruction can use this register as a store buffer.

The data processor writing data in an entry indicated by an output pointer of the corresponding ring buffer in execution of a data updating instruction such as an operation instruction can use the entry indicated by the output pointer of the ring buffer as a working register.

The data processor writing data in both of a register (data updating physical register) different from a ring buffer and the entry indicated by the output pointer of the ring buffer can simultaneously handle the working register and the store buffer with a single logical register number. Thus, the number of handled logical registers can be so reduced that it is possible to write an efficient program.

The data processor can arbitrarily set an updated register in response to the usage of the variable allocated to the register according to the program, whereby it is possible to write an efficient program.

Further, the data processor uses the general-purpose register as the register different from the ring buffer, whereby the hardware cost can be reduced.

The data processor can reduce the number of handled logical registers without adding a new instruction, whereby the basic instruction length can be reduced while the code efficiency and the performance can be compatibly improved.

It is possible to write an efficient program with small numbers of instructions and processing cycles, whereby the performance is improved and the code size of a ROM can be reduced so that the product cost can be effectively reduced. Further, it is possible to write a simpler program so that the software development efficiency is also improved.

The exemplary structures of the data processor shown in the aforementioned embodiment simply show the embodiment, without restricting the scope of the present invention.

The present invention, applied to a VLIW processor in the aforementioned embodiment, is basically applicable to a data processor of any architecture such as an RISC processor or a CISC processor. In application to a CISC processor, however, the present invention may be partially restricted such that it is impossible to cope with memory operands other than those of loading and store instructions.

Application of this technique is not particularly limited in the pipeline structure either. However, a larger number of buffer registers are required as the number of pipeline stages is increased.

While the data processor is packaged with the ring buffers as the FIFO buffers in the aforementioned embodiment, effects similar to those of the aforementioned embodiment can be attained whatever buffers controlled on the FIFO method are packaged. For example, a FIFO buffer of a mode implementing FIFO control by actually shifting data is also employable.

While parts of the general-purpose registers have been described with reference to the ring buffers with respect to the data processor comprising the general-purpose registers in the aforementioned embodiment, this technique is also applicable to a data processor of another architecture for attaining similar effects. For example, the technique of the present invention may be applied to a data register separated from an address register or an accumulator grasped not as a general-purpose register but as an accumulator.

The data processor implementing updating of the pointers of the ring buffers by post-increment in the aforementioned embodiment may alternatively decrement the same or perform any update control. The input and output pointers may simply be capable of managing input data and output data positions respectively.

<Another Structure of Ring Buffer Control Register>

FIG. 62 is an explanatory diagram showing an exemplary structure of a ring buffer control register (RBC register) different from the control register CR4 (RBC). The overall basic structure shown in FIG. 62 is substantially identical to that of the control register CR4 (RBC register) shown in FIG. 6 employed in the data processor according to the aforementioned embodiment. For the purpose of simplification, only points different from the data processor according to the aforementioned embodiment are described.

As to a ring buffer structure, each of two logical registers R0 and R1 is constituted of four buffer registers, similarly to the case where the RBCNF bit 80 of the control register CR4 (RBC) is “00”.

RBE0 and RBE1 bits 1001 and 1004 are ring buffer enable control bits, similarly to the RBE0 and RBE1 bits 83 and 85 shown in FIG. 6. It is possible to control whether to operate as a ring buffer register or as a general-purpose register in unit of register of the logical registers R0 and R1 operable as ring buffers. The RBE0 and RBE1 bits 1001 and 1004, corresponding to registers of the logical registers R0 and R1, operate as normal registers and ring buffer registers in cases of “0” and “1” respectively.

STM0 and STM1 bits 1002 and 1006 which are two mode set information are stored data selection mode bits for selecting stored data in unit of register of the logical registers R0 and R1 operable as ring buffers in processing of a store instruction for storing the value of a register operating as a buffer register. The data processor reads the stored data from a register indicated by the output pointer of a buffer register constituting a ring buffer (second mode specification) when the STM0 and STM1 bits 1002 and 1006 are “0”, while reading the stored data from a normal general-purpose register (first mode specification) when the STM0 and STM1 bits 1002 and 1006 are “1”.

WM0 and WM1 bits 1003 and 1007 are register value write object selection bits (2-bit structure) for selecting in which register a value is written in unit of register of the logical registers R0 and R1 operable as ring buffers in writing in a register other than loading following instruction execution. The data processor writes the value in the corresponding general-purpose register (first register specification) when the WM0 and WM1 bits 1003 and 1007 are “01”, while writing the value in a register indicated by the output pointer of a buffer constituting a ring buffer (third register specification (second register specification)) when the WM0 and WM1 bits 1003 and 1007 are “10”, and writing the value in both of the general-purpose register and the register indicated by the output pointer of the buffer constituting the ring buffer (fourth register specification (second register specification)) when the WM0 and WM1 bits 1003 and 1007 are “11”.

OPM0 and OPM1 bits 1004 and 1008 are ring buffer output pointer update mode bits (2-bit structure) similarly to the OPM0 and OPM2 bits 84 and 88 shown in FIG. 6. An RBC register 1000 shown in FIG. 62 can specify four types of pointer updating methods in unit of register of the logical registers R0 and R1 operable as ring buffers.

The OPM0 and OPM1 bits 1004 and 1008 specify pointer update methods with respect to the logical registers R0 and R1 respectively. When an OPMi bit is “00”, the data processor updates an output pointer specified by an instruction by +1 only when explicitly specifying updating of the output pointer by executing a ring buffer output pointer update instruction. When the OPMi bit is “01”, the data processor automatically updates the pointer of a register referred to due to reference to a register value following execution of an instruction by +1. When the OPMi bit is “10”, the data processor automatically updates the output pointer of a register operating as a ring buffer in execution of a last instruction of a repetition block under block repetition processing by +1. When the OPMi bit is “11”, the data processor automatically updates the output pointer of a register operating as a ring buffer in execution of a branch instruction by +1. Also when the OPMi bit is “01”, “10” or “11”, the data processor updates the corresponding pointer in response to the output pointer update instruction.

In addition to the ring buffer structure, the RBC register 1000 is remarkably different from the control register CR4 (RBC) in a point that bits (STM0 and STM1) for a stored data selection mode and bits (WM0 and WM1) for register value write object selection are provided in unit of register and a point that the two register value write object selection bits (WM0 and WM1) are employed with addition of a function writing the same only in ring buffers. Basic operations based on the RBC register 1000 are substantially identical to those based on the control register CR4 (RBC) in the data processor according to the aforementioned embodiment, and hence redundant description is omitted.

Thus, the RBC register 1000 provided with the stored data selection mode bits (STM0 and STM1) and the register value write object selection bits (WM0 and WM1) in unit of register is capable of more detailed setting depending on the processing contents of the program. For example, the data processor can use a certain general-purpose register as a store buffer while using another register as a working register due to the register value write object selection bits provided in unit of register. The stored data selection mode bits are so provided in unit of register that register use efficiency can be improved when performing processing mixed with transfer of memory data and operation processing or the like. Therefore, the number of processing cycles and the code size are so reduced that it may be possible to attain high performance and a low cost.

In addition, the two register value write object selection bits (WM0 and WM1) are employed with addition of the function writing the same only in ring buffers, whereby the register use efficiency can be further improved.

Unnecessary updating of general-purpose register values can be reduced due to the addition of the function writing the bits only in ring buffers. For example, while the data processor not provided with this mode unnecessarily destroys the values of the general-purpose registers in the exemplary program 9 shown in FIG. 56, it is possible to hold the values of the general-purpose registers when the data processor comprises this mode, whereby the register values may not be saved or returned before and after repetition processing. Therefore, the number of processing cycles as well as the code size are so reduced that it may be possible to attain high performance and a low cost.

While the invention has been shown and described in detail, the foregoing description is in all aspects illustrative and not restrictive. It is therefore understood that numerous modifications and variations can be devised without departing from the scope of the invention.

1. A data processor for processing data stored in a specific logical register specified as operand storage location of an instruction, comprising:
a decoding unit analyzing said instruction;
a plurality of variable physical registers associable with said specific logical register; and
logical register specifying means capable of sequentially specifying said variable physical registers in a specified physical register group constituted of at least two registers among said plurality of variable physical registers on a first-in, first-out (FIFO) method as said specific logical register.

2. The data processor according to claim 1, wherein
said logical register specifying means receives operating mode information specifying the operating mode of said specific logical register, to execute one of a physical register fixing operation of specifying one fixed physical register as said specific logical register and a physical register varying operation of sequentially specifying said variable physical registers in said specified physical register group on the FIFO method as said specific logical register, on the basis of said operating mode information.

3. The data processor according to claim 2, wherein
said specific logical register includes a prescribed number of at least two specific logical registers,
said specified physical register group includes a prescribed number of specified physical register groups corresponding to said prescribed number of specific logical registers,
said operating mode information includes a prescribed number of specific logical register-responsive operating mode information corresponding to respective ones of said prescribed number of specific logical registers, and
said logical register specifying means executes one of said physical register fixing operation of specifying one said fixed physical register as said specific logical register and said physical register varying operation of sequentially specifying said variable physical registers in corresponding said specified physical register groups on the FIFO method as said specific logical register, in units of said prescribed number of specific logical registers on the basis of said prescribed number of specific logical register-responsive operating mode information.

4. The data processor according to claim 2, wherein
said specific logical register includes a prescribed number of at least two specific logical registers,
said specified physical register group includes a prescribed number of specified physical register groups corresponding to said prescribed number of specific logical registers,
said operating mode information includes collective operating mode information specifying a normal operating mode or a FIFO buffer mode as to overall said prescribed number of specific logical registers and a prescribed number of specific logical register-responsive operating mode information provided in correspondence to said prescribed number of specific logical registers for specifying said normal operating mode or said FIFO buffer mode as to corresponding said specific logical registers, and
said logical register specifying means executes said physical register varying operation of sequentially specifying said variable physical registers in corresponding said specified physical register group on the FIFO method as selected said specific logical register corresponding thereto when both of said collective operating mode information and said specific logical register-responsive operating mode information specify said FIFO buffer mode while otherwise executing said physical register fixing operation of specifying one said fixed physical register from among said prescribed number of specific logical registers as a specific logical register other than said selected specific logical register, on the basis of said collective operating mode information and said prescribed number of specific logical register-responsive operating mode information.

5. The data processor according to claim 2, wherein
said specified physical register group is constituted of registers independent of said fixed physical register.

6. The data processor according to claim 2, wherein
said specified physical register group at least partially includes said fixed physical register.

7. The data processor according to claim 1, wherein
said logical register specifying means decides the construction of said registers in said specified physical register group on the basis of variable physical register constitutional information.

8. The data processor according to claim 1, wherein
said logical register specifying means points a register storing input data in said specified physical register group with an input pointer, points register outputting stored data in said specified physical register group with an output pointer, and changes the values of said input pointer and said output pointer to circulate among said variable physical registers in said specified physical register group.

9. The data processor according to claim 8, wherein
said specified physical register group is constituted of 2ⁿ said variable physical registers.

10. The data processor according to claim 8, wherein
said instruction includes a multiple data updating instruction instructing said specific logical register to update k (≧2) data, and
said logical register specifying means updates said input pointer by k in response to said multiple data updating instruction.

11. The data processor according to claim 8, wherein
said instruction includes a register value reference instruction for referring to stored data in said specific logical register, and
said logical register specifying means updates said output pointer in response to said register value reference instruction.

12. The data processor according to claim 8, wherein
said logical register specifying means changes said output pointer when a prescribed condition is satisfied in said instruction processing.

13. The data processor according claim 12, wherein
said data processor has a block repetition function of repetitively executing a plurality of repetition instructions, and
said prescribed condition includes a case where said instruction is the last instruction among said plurality of repetition instructions.

14. The data processor according to claim 12, wherein
said instruction includes a branch instruction, and
said prescribed condition includes a case where said instruction is said branch instruction.

15. The data processor according to claim 8, wherein
said instruction includes an output pointer update instruction, and
said logical register specifying means changes said output pointer in response to said output pointer update instruction.

16. The data processor according to claim 15, wherein
said specific logical register includes a prescribed number of at least two specific logical registers,
said specified physical register group includes a prescribed number of specified physical register groups corresponding to said prescribed number of specific logical registers,
said output pointer includes a prescribed number of output pointers corresponding to said prescribed number of specific logical registers,
said output pointer update instruction further indicates updating/non-updating of respective ones of said prescribed number of specific logical registers, and
said logical register specifying means selectively changes, among said prescribed number of output pointers, output pointers which are indicated to be updated, in response to said output pointer update instruction.

17. The data processor according to claim 8, wherein
said logical register specifying means is capable of setting a method of changing said output pointer on the basis of output pointer update mode information.

18. The data processor according to claim 17, wherein
said specific logical register includes a prescribed number of at least two specific logical registers,
said specified physical register group includes a prescribed number of specified physical register groups corresponding to said prescribed number of specific logical registers,
said output pointer includes a prescribed number of output pointers corresponding to said prescribed number of specific logical registers,
said output pointer update mode information includes a prescribed number of output pointer update mode information corresponding to said prescribed number of specific logical registers, and
said logical register specifying means is capable of setting a method of changing said output pointers in unit of said prescribed number of output pointers on the basis of said prescribed number of output pointer update mode information.

19. The data processor according to claim 8, wherein
said instruction includes a multiple data reference instruction instructing said specific logical register to refer to k (≧2) stored data, and
said logical register specifying means changes said output pointer by one in response to said multiple data reference instruction.

20. The data processor according to claim 1, wherein
said instruction includes a memory storing instruction for storing stored data of said specific logical register in a prescribed memory,
said data processor further comprises a memory storing instruction physical register independent of said specified physical register group, and
said logical register specifying means specifies said memory storing instruction physical register as said specific logical register in response to said memory storing instruction.

21. The data processor according to claim 1, wherein
said instruction includes a memory storing instruction for storing stored data of said specific logical register in a prescribed memory, and
said logical register specifying means specifies said variable physical registers in said specified physical register group as said specific logical register in response to said memory storing instruction.

22. The data processor according to claim 1, wherein
said instruction includes a memory storing instruction for storing stored data of said specific logical register in a prescribed memory,
said data processor further comprises a memory storing instruction physical register independent of said specified physical register group, and
said logical register specifying means selectively executes a first register specifying operation of specifying said memory storing instruction physical register as said specific logical register or a second register specifying operation of specifying said variable physical registers in said specified physical register group as said specific logical register, on the basis of mode set information in response to said memory storing instruction.

23. The data processor according to claim 22, wherein
said specific logical register includes a prescribed number of at least two specific logical registers,
said specified physical register group includes a prescribed number of specified physical register groups corresponding to said prescribed number of specific logical registers,
said mode set information includes a prescribed number of mode set information corresponding to said prescribed number of specific logical registers, and
said logical register specifying means selectively executes said first or second register specifying operation in unit of said prescribed number of specific logical registers on the basis of said prescribed number of mode set information.

24. The data processor according to claim 20, wherein
said logical register specifying means receives operating mode information specifying the operating mode of said specific logical register, to execute one of a physical register fixing operation of specifying one fixed physical register as said specific logical register,
said fixed physical register specified as said specific logical register includes a register independent of said specified physical register group, and
said memory storing instruction physical register is said fixed physical register.

25. The data processor according to claim 1, wherein
said instruction includes a data updating instruction instructing said specific logical register to update data,
said data processor further comprises a data updating physical register independent of said specified physical register group, and
said logical register specifying means specifies said data updating physical register as said specific logical register in response to said data updating instruction.

26. The data processor according to claim 8, wherein
said instruction includes a data updating instruction instructing said specific logical register to update data, and
said logical register specifying means specifies said variable physical register indicated by said output pointer in said specified physical register group as said specific logical register in response to said data updating instruction.

27. The data processor according to claim 8, wherein
said instruction includes a data updating instruction instructing said specific logical register to update data,
said data processor further comprises a data updating physical register independent of said specified physical register group, and
said logical register specifying means specifies both of said variable physical register indicated by said output pointer in said specified physical register group and said data updating physical register, as said specific logical register in response to said data updating instruction.

28. The data processor according to claim 26, further comprising a data updating physical register independent of said specified physical register group, wherein
said logical register specifying means is capable of executing a first register specifying operation of specifying said data updating physical register as said specific logical register or a second register specifying operation of at least specifying said variable physical register indicated by said output pointer in said specified physical register group as said specific logical register, on the basis of resister selection information in response to said data updating instruction.

29. The data processor according to claim 28, wherein
said specific logical register includes a prescribed number of at least two specific logical registers,
said specified physical register group includes a prescribed number of specified physical register groups corresponding to said prescribed number of specific logical registers,
said register selection information includes a prescribed number of register selection information corresponding to said prescribed number of specific logical registers, and
said logical register specifying means selectively executes said first or second register specifying operation in unit of said prescribed number of specific logical registers on the basis of said prescribed number of register selection information.

30. The data processor according to claim 29, wherein
said second register specifying operation includes:
a third register specifying operation specifying only said variable physical register pointed by said output pointer in said specified physical register group as said specific logical register, and
a fourth register specifying operation of specifying both of said variable physical register pointed by said output pointer in said specified physical register group and said data updating physical register as said specific logical register.

31. The data processor according to claim 25, wherein
said logical register specifying means receives operating mode information specifying the operating mode of said specific logical register, to execute one of a physical register fixing operation of specifying one fixed physical register as said specific logical register,
said fixed physical register specified as said specific logical register is a register independent of said specified physical register group, and
said data updating physical register includes said fixed physical register.
